(19) United States
(12) Patent Application Publication
(10) Pub. No.: US 2011/0229232 A1
(43) Pub. Date: Sep. 22, 2011

(54) LUBRICANT APPLYING DEVICE, IMAGE FORMING APPARATUS, PROCESS UNIT, AND SOLID LUBRICANT

(76) Inventors: Takeshi Kojima, Kanagawa (JP); Masanori Kawasumi, Kanagawa (JP); Shuji Tanaka, Kanagawa (JP); Shin Kayahara, Kanagawa (JP); Takuya Suganuma, Kanagawa (JP); Hiroyuki Sugiyama, Kanagawa (JP); Yuji Ishikura, Kanagawa (JP)

(21) Appl. No.: 13/046,907

(22) Filed: Mar. 14, 2011

(30) Foreign Application Priority Data
Mar. 17, 2010 (JP) 2010-061293
Mar. 17, 2010 (JP) 2010-061297
Mar. 17, 2010 (JP) 2010-061306

(51) Int. Cl. G03G 21/00

(52) U.S. Cl. 399/346

(57) ABSTRACT

A lubricant applying device includes: a solid lubricant; an applying member that applies lubricant powder scraped off from the solid lubricant to an application target; a holding member that holds the solid lubricant; a biasing unit that biases the holding member to bring the solid lubricant on the holding member into contact with the applying member; and a regulating unit that regulates, when a force of a direction orthogonal to an endless movement direction of the applying member is applied from the applying member to the solid lubricant at a frictional surface therebetween, movement of the solid lubricant and the holding member in the orthogonal direction.

### CROSS-REFERENCE TO RELATED APPLICATIONS

The present application claims priority to and incorporates by reference the entire contents of Japanese Patent Application No. 2010-061306 filed in Japan on Mar. 17, 2010, Japanese Patent Application No. 2010-061293 filed in Japan on Mar. 17, 2010, and Japanese Patent Application No. 2010-061297 filed in Japan on Mar. 17, 2010.

### BACKGROUND OF THE INVENTION

1. Field of the Invention

The present invention relates to a lubricant applying device that applies to an application target lubricant powder that is scraped off from a solid lubricant using an applying member of which the surface endlessly moves, an image forming apparatus using the lubricant applying device, and a process unit. Further, the present invention relates to a solid lubricant that is mounted in the lubricant applying device.

2. Description of the Related Art

In the related art, as this kind of lubricant applying device, there is known a lubricant applying device that applies a lubricant to a photosensitive element corresponding to an application target (for example, refer to Japanese Patent Application Laid-open No. 2007-79468). FIG. 111 shows the configuration of a relevant portion of a lubricant applying device according to the related art together with a photosensitive element 203. In FIG. 111, an applying brush roller 207 serving as a lubricant applying member has a rotation shaft member 208 that is rotatably supported and a brush roller portion 209 with plural bristles on the circumference thereof, and rotates in a clockwise direction in the drawings while contacting the photosensitive element 203. The solid lubricant is biased by a spring 219 to be pressed against the applying brush roller 207. The applying brush roller 207 applies lubricant powder scraped off from a solid lubricant 210 to the surface of the photosensitive element 203 by the rotation thereof. With a decreased physical adhesion between toner and the surface of the photosensitive element 203 on which the lubricant powder is applied, transferability of a toner image to the photosensitive element improves, to-be-cleaned capability of the toner improves, or fixation of toner to the surface of the photosensitive element is suppressed.

FIG. 112 schematically shows the internal structure of a lubricant applying device according to the related art. In FIG. 112, the solid lubricant 210 is formed in a length as long as it extends over almost the entire region of the brush roller portion 209 of the applying brush roller 207 in a rotation axis direction. The thickness of the solid lubricant decreases as the solid lubricant is scraped by the applying brush roller 207. However, since the solid lubricant is biased by the spring 219 toward the applying brush roller 207, the solid lubricant continuously contacts the applying brush roller 207, regardless of the thickness. However, if the thickness significantly decreases, the solid lubricant is likely to break or chip. For this reason, when the thickness of the solid lubricant decreases to a predetermined thickness, the solid lubricant 210 needs to be replaced with a new solid lubricant 210. In recent years, since easy maintenance and cost reduction are required, there is a trend in that the thickness of the solid lubricant increases. If the solid lubricant 210 is formed thick, the stroke of the spring 219 becomes longer until the new solid lubricant 210 is completely consumed after the new solid lubricant 210 is set.

The inventors found through experiments that lateral movement of the solid lubricant 210 is easily caused in recent years where the stroke length generally increases. Specifically, on a frictional surface of the applying brush roller 207 and the solid lubricant 210, the applying brush roller 207 applies the force of the brush rotation direction to the solid lubricant 210. However, due to inclination of the bristles of the brush, in addition to the force of the rotation direction, the force of the rotation axis direction may be applied. This force is applied in a predetermined direction, for example, from one end side to the other end side of the applying brushing roller in the rotation axis direction, or from the other end side to one end side. If this force is continuously applied to the solid lubricant 210, as shown in FIG. 113, the lateral movement of the solid lubricant 210 in the rotation axis direction of the applying brush roller 207 may be caused. However, in the related art, since the spring 219 may exhibit the sufficient reactive force against the lateral movement of the solid lubricant 210, the lateral movement is prevented due to the following reason. That is, in the related art where the recovery amount of the spring 219 is relatively small, a spring that is relatively short in free length is used as the spring 219. Meanwhile, in recent years where the recovery amount of the spring 219 is large, a spring that is relatively long in free length needs to be used as the spring 219. This spring 219 may not exhibit the sufficient drag for the solid lubricant 210 that tries to laterally move, and thus the solid lubricant 210 is easily subject to the lateral movement.

If the lateral movement of the solid lubricant 210 is caused, as shown by a dotted line in FIG. 113, a contact of the solid lubricant 210 with any one of both ends of the applying brush roller 207 in the rotation axis direction is disabled. Thereby, application failure of the lubricant may occur in one end of the photosensitive element (not shown in the drawings) in a rotation axis direction. In this state, there may be easily caused a difference in biasing directions of the biasing forces of the springs 219—one spring 219 disposed on one end side of the brush roller and the other spring 219 disposed on the other side of the brush roller in the brush roller rotation axis direction-that bias the solid lubricant 210. If the difference of the biasing directions is generated, the difference of the lubricant pressing force per unit area of the one end side and the other end side of the applying brush roller 207 with respect to the brush is generated. In addition, the difference of the lubricant scraping amounts per unit time may be generated in both ends. In a state shown in the drawings, the solid lubricant is scraped more at the right end side than at the left end side as shown in FIG. 114. Therefore, in the rotation axis direction of the photosensitive element, the large deviation is generated in the application amount of the lubricant, which results in negative influence on an image quality.

As a lubricant applying device according to the related art, there is known a lubricant applying device disclosed in Japanese Patent Application Laid-open No. 2008-241750 is known. The lubricant applying device has a solid lubricant, an applying brush roller that is an applying member, and a spring to bias the solid lubricant toward the applying brush roller. Against the applying brush roller that rotates contacting the photosensitive element serving as an application target, the solid lubricant is pressed by the spring. The applying brush roller applies to the surface of the photosensitive element the lubricant powder scraped off from the solid lubricant by the rotation. By decreasing physical adhesion between toner and the surface of a photosensitive element, on which the lubricant powder is applied, transferability of a toner image to the photosensitive element improves, to-be-cleaned capability of the toner improves, or fixation of the toner to the surface is suppressed.

The thickness of the solid lubricant decreases as the solid lubricant is scraped by the applying brush roller. However, since the solid lubricant is biased by the spring 219 toward the applying brush roller 207, the solid lubricant continuously contacts the applying brush roller 207, regardless of the thickness. However, if the thickness extraordinarily decreases, the solid lubricant is likely to break or chip. For this reason, when the thickness of the solid lubricant decreases to a predetermined thickness, the solid lubricant needs to be replaced with a new solid lubricant.

Accordingly, in the lubricant applying device disclosed in Japanese Patent Application Laid-open No. 2008-541750, the moving amount of the solid lubricant in a thickness direction is detected by a sensor disposed facing the solid lubricant with a gap between the sensor and the spring side. When the moving amount reaches a predetermined threshold value, that is, when the thickness of the solid lubricant decreases to a predetermined value, the sensor notifies a user of expiration of life duration of the solid lubricant.

However, depending on the internal layout of the device, the sensor may not be disposed at the position where the sensor faces the solid lubricant in the thickness direction. In such a case, it may be difficult to detect the moving amount of the solid lubricant in the thickness direction.

### SUMMARY OF THE INVENTION

It is an object of the present invention to at least partially solve the problems in the conventional technology.

According to an aspect of the present invention, there is provided a lubricant applying device, including: a solid lubricant; an applying member that applies lubricant powder scraped off from the solid lubricant to an application target; a holding member that holds the solid lubricant; a biasing unit that biases the holding member to bring the solid lubricant on the holding member into contact with the applying member; and a regulating unit that regulates, when a force of a direction orthogonal to an endless movement direction of the applying member is applied from the applying member to the solid lubricant at a frictional surface therebetween, movement of the solid lubricant and the holding member in the orthogonal direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram showing the schematic configuration of a printer according to an embodiment;

FIG. 2 is an enlarged view showing the configuration of a process unit for Y and a developing unit in the printer;

FIG. 3 is a perspective view showing the process unit and the developing unit;

FIG. 4 is a perspective view showing the developing unit;

FIG. 5 is an enlarged view showing the configuration of the process unit and an intermediate transfer belt;

FIG. 6 is an assembly exploded perspective view showing the process unit;

FIG. 7 is an exploded perspective view showing an inner portion of a lubricant applying device of the process unit;

FIG. 8 is an enlarged perspective view partially showing the inner portion of the lubricant applying device;

FIG. 9 is an enlarged perspective view showing the inner portion of the lubricant applying device;

FIG. 10 is a side view showing a solid lubricant of the lubricant applying device and a holding member;

FIG. 11 is an enlarged perspective view showing the solid lubricant and one end of the holding member in a longitudinal direction;

FIG. 12 is an assembly exploded perspective view showing an inner portion of a casing of the solid lubricant;

FIG. 13 is an enlarged exploded perspective view showing a set operation of an applying brush roller with respect to the lubricant applying device;

FIG. 14 is an enlarged perspective view partially showing a solid lubricant for Y in a printer according to a first modification and one end of a holding member in a longitudinal direction;

FIG. 15 is an assembly exploded perspective view showing a solid lubricant of a lubricant applying device for Y in a printer according to a second modification, a holding member, and a casing;

FIG. 16 is an assembly exploded perspective view showing a solid lubricant of a lubricant applying device for Y in a printer according to a third modification, a holding member, and a casing;

FIG. 17 is a perspective view showing the solid lubricant, the holding member, and the casing;

FIG. 18 is a cross-sectional view showing the solid lubricant and the casing;

FIGS. 19A to 19C are plan views showing an example of a sectional shape of an auxiliary rail in the lubricant applying device;

FIG. 20 is an exploded perspective view showing a solid lubricant of a lubricant applying device for Y in a printer according to a fourth modification, a holding member, and a casing;

FIG. 21 is a cross-sectional view showing the solid lubricant and the casing;

FIG. 22 is an assembly exploded perspective view showing a applying brush roller for Y in a printer according to a fifth modification, a solid lubricant, a holding member, and a casing;

FIG. 23 is a horizontal cross-sectional view showing the applying brush roller, the solid lubricant, the holding member, and the casing;

FIG. 24 is an assembly exploded perspective view showing a guide rail for Y in a printer according to a sixth modification and an electrode;

FIG. 25 is a perspective view showing the guide rail an the electrode;

FIG. 26 is a horizontal cross-sectional view showing a applying brush roller for Y in the printer an the peripheral configuration thereof (when a lubricant is in an initial state);

FIG. 27 is a horizontal cross-sectional view showing the applying brush roller and the peripheral configuration thereof (when the lubricant is consumed by about the half amount);

FIG. 28 is a horizontal cross-sectional view showing the applying brush roller and the peripheral configuration thereof (when the lubricant is completely consumed);

FIG. 29 is a perspective view showing a guide rail for Y in a printer according to a seventh embodiment and an electrode;

FIG. 30 is a horizontal cross-sectional view showing the applying brush roller for Y in the printer and the peripheral configuration thereof (when the lubricant is in an initial state);

FIG. 31 is a horizontal cross-sectional view showing the applying brush roller and the peripheral configuration thereof (when the lubricant is consumed by about the half amount);

FIG. 32 is a horizontal cross-sectional view showing the applying brush roller and the peripheral configuration thereof (when the lubricant is completely consumed);

FIG. 33 is an assembly exploded perspective view showing a applying brush roller for Y in a printer according to an eighth modification, a solid lubricant, a holding member, and a casing;

FIG. 34 is an assembly exploded perspective view showing a applying brush roller for Y in a printer according to a ninth modification, a solid lubricant, a holding member, and a casing;

FIG. 35 is an assembly exploded perspective view showing a applying brush roller for Y in a printer according to a tenth modification, a solid lubricant, a holding member, and a casing;

FIG. 36 is an assembly exploded perspective view showing a solid lubricant for Y in a printer according to an eleventh modification and a holding member;

FIG. 37 is a cross-sectional view showing the applying brush roller in the printer and the peripheral configuration thereof;

FIGS. 38A to 38D are partial perspective views showing an example of the holding member;

FIGS. 39A to 39D are an enlarged perspective view showing an example of a guide rod of a printer according to a thirteenth modification;

FIG. 40 is a cross-sectional view showing an applying brush roller in a printer according to a fourteenth modification and the peripheral configuration thereof;

FIG. 41 is an assembly exploded perspective view showing a solid lubricant for Y in a printer according to a fifteenth modification and a holding member;

FIG. 42 is a cross-sectional view showing the applying brush roller in the printer and the peripheral configuration thereof;

FIG. 43 is an assembly exploded perspective view showing a solid lubricant in a printer according to a sixteenth modification, a holding member, and a guide rod;

FIG. 44 is a cross-sectional view showing the applying brush roller of the printer and the peripheral configuration thereof;

FIG. 45 is a perspective view showing a solid lubricant for Y in a printer according to a seventeenth modification and a holding member;

FIG. 46 is a perspective view showing a solid lubricant for Y in a printer according to an eighteenth modification;

FIG. 47 is an assembly exploded perspective view showing a guide rod for Y in a printer according to a nineteenth modification and an electrode;

FIG. 48 is a perspective view showing the guide rod and the electrode;

FIG. 49 is an assembly exploded perspective view showing a guide rod for Y in a printer according to a twentieth modification and an electrode;

FIG. 50 is a perspective view showing the guide rod and the electrode;

FIG. 51 is an assembly exploded perspective view partially showing the inner configuration of a lubricant applying device 6Y for Y in a printer according to a second embodiment;

FIG. 52 is an enlarged perspective view showing an example of a convex portion having a flat shape;

FIG. 53 is an assembly exploded perspective view partially showing the inner configuration of a lubricant applying device 6Y for Y in a printer according to a first example;

FIG. 54 is a schematic view showing movement of a convex portion of a holding member in the lubricant applying device in a guide groove;

FIG. 55 is a graph showing a relationship between the consumption amount of the solid lubricant and the moving amount in a brush rotation axis direction;

FIG. 56 is a side view showing the solid lubricant in an initial state in the printer and the peripheral configuration thereof;

FIG. 57 is a side view showing the completely consumed solid lubricant in the printer and the peripheral configuration thereof;

FIG. 58 is a side view showing a solid lubricant in an initial state in a modification of the printer and the peripheral configuration thereof;

FIG. 59 is a side view showing the completely consumed solid lubricant in the printer and the peripheral configuration thereof;

FIG. 60 is a perspective view showing a bristled brush sheet that is used in a brush roller portion of the applying brush roller in the printer according to the first example;

FIG. 61 is an assembly exploded perspective view showing the applying brush roller;

FIG. 62 is a perspective view showing one end of the applying brush roller in a rotation axis direction and the solid lubricant;

FIG. 63 is a schematic view showing a relationship of the applying brush roller and various directions;

FIG. 64 is a schematic view showing movement of a convex portion of a holding member when the applying brush roller rotates;

FIG. 65 is a schematic view showing an inclination angle θ of a guide groove in a lubricant applying device of a printer according to a second example;

FIG. 66 is a schematic view showing an inclination angle θ of a guide groove in a lubricant applying device of a printer according to a third example;

FIG. 67 is a schematic view showing an inclination angle θ of a guide groove in a lubricant applying device of a printer according to a fourth example;

FIG. 68 is a schematic view showing an inclination angle θ of a guide groove GD in a lubricant applying device of a printer according to a fifth example;

FIG. 69 is an enlarged perspective view partially showing an inner portion of a lubricant applying device according to a third embodiment;

FIG. 70 is a schematic view showing movement of the solid lubricant on the guide rail of the lubricant applying device;

FIG. 71 is a graph showing an example of a relationship between the thickness decrease amount of the solid lubricant and the moving amount in a brush rotation axis direction;

FIG. 72 is a side view showing the solid lubricant in an initial state in the lubricant applying device and the peripheral configuration;

FIG. 73 is a side view showing the completely consumed solid lubricant and the peripheral configuration thereof;

FIG. 74 is a perspective view showing a bristled brush sheet that is used in a brush roller portion of the applying brush roller in the lubricant applying device;

FIG. 75 is a perspective view showing one end of the applying brush roller in a rotation axis direction and the solid lubricant;

FIG. 76 is a perspective view showing an entire region of the applying brush roller in a rotation axis direction and the solid lubricant;

FIG. 77 is a schematic view showing a relationship between the applying brush roller and various directions;

FIG. 78 is a cross-sectional view showing movement of the solid lubricant on the guide rail;

FIG. 79 is a side view showing a solid lubricant in an initial state in a printer according to a first modification and the peripheral configuration thereof;

FIG. 80 is a side view showing the completely consumed solid lubricant and the peripheral configuration thereof;

FIG. 81 is an enlarged perspective view partially showing an inner portion of a lubricant applying device for Y in a printer according to a second modification;

FIG. 82 is an enlarged perspective view partially showing an inner portion of a lubricant applying device for Y in a printer according to a third modification;

FIG. 83 is an enlarged perspective view partially showing an inner portion of a lubricant applying device for Y in a printer according to a fourth modification;

FIG. 84 is an enlarged perspective view partially showing an inner portion of a lubricant applying device for Y in a printer according to a fifth modification;

FIG. 85 is an enlarged perspective view partially showing an inner portion of a lubricant applying device for Y in a printer according to a sixth modification;

FIG. 86 is an enlarged perspective view partially showing an inner portion of a lubricant applying device for Y in a printer according to a seventh modification;

FIG. 87 is an enlarged perspective view partially showing an inner portion of a lubricant applying device for Y in a printer according to an eighth modification;

FIG. 88 is a partially enlarged perspective view showing one end of a applying brush roller for Y in a printer according to a ninth modification;

FIG. 89 is a perspective view showing a bristled brush sheet that is used in a applying brush roller for Y in a printer according to a tenth modification;

FIG. 90 is a perspective view showing a bristled brush sheet that is used in a applying brush roller for Y in a printer according to an eleventh modification;

FIG. 91 is a side view showing an applying brush roller for Y in a printer according to a twelfth modification, a solid lubricant, and a holding member;

FIG. 92 is a side view showing the completely consumed solid lubricant to and the peripheral configuration thereof;

FIG. 93 is a side view showing a solid lubricant for Y in a printer according to a thirteenth modification and the peripheral configuration thereof;

FIG. 94 is a side view showing the completely consumed solid lubricant and the peripheral configuration thereof;

FIG. 95 is a side view showing a solid lubricant 10Y for Y in a printer according to a fourteenth modification and the peripheral configuration thereof;

FIG. 96 is a side view showing the completely consumed solid lubricant and the peripheral configuration thereof;

FIG. 97 is a side view showing curvature of a coil spring according to movement of a holding member in a brush rotation axis direction;

FIG. 98 is a partially enlarged perspective view showing a holding member of a printer according to a fifteenth modification and the peripheral configuration thereof;

FIG. 99 is an enlarged view showing the configuration of a biasing mechanism for Y in a printer according to a sixteenth modification;

FIG. 100 is a side view and a front view showing a applying brush roller for Y in a printer according to a seventeenth modification and the peripheral configuration thereof;

FIG. 101 is a side view and a front view showing the completely consumed solid lubricant and the peripheral configuration thereof;

FIG. 102 is an enlarged view showing the configuration of a taper provided in a casing of a lubricant applying device for Y in a printer according to an eighteenth modification and an end of a solid lubricant;

FIG. 103 is an enlarged view showing the configuration of a taper provided in a casing of a lubricant applying device for Y in a printer according to a nineteenth modification and an end of a solid lubricant;

FIG. 104 is an enlarged view showing the configuration of an end of the completely consumed solid lubricant and the peripheral configuration thereof;

FIG. 105 is an enlarged view showing the configuration of a curved member provided in a casing of a lubricant applying device for Y in a printer according to a twentieth modification and an end of a solid lubricant;

FIG. 106 is an enlarged view showing the configuration of a curved member provided in a casing of a lubricant applying device for Y in a printer according to a twenty-first modification and an end of a solid lubricant;

FIG. 107 is a side view and a front view showing a solid lubricant in an initial state in a printer according to a twenty-second modification and the peripheral configuration thereof;

FIG. 108 is a side view and a front view showing the completely consumed solid lubricant and the peripheral configuration thereof;

FIG. 109 is a side view showing a solid lubricant in an initial state in a printer according to a twenty-third modification and the peripheral configuration thereof;

FIG. 110 is a side view showing the completely consumed solid lubricant and the peripheral configuration thereof;

FIG. 111 is a diagram showing the configuration of a relevant portion of a lubricant applying device according to the related art and a photosensitive element;

FIG. 112 is a schematic view showing the internal structure of the lubricant applying device;

FIG. 113 is a diagram showing horizontal movement of the solid lubricant; and

FIG. 114 is a diagram showing uneven wearing of the solid lubricant.

### DETAILED DESCRIPTION OF THE PREFERRED EMBODIMENTS

Hereinafter, embodiments of the present invention will be described.

### First Embodiment

An embodiment of an electrophotography printer (hereinafter, simply referred to as printer) as an image forming apparatus where the present invention is applied will be described hereinafter.

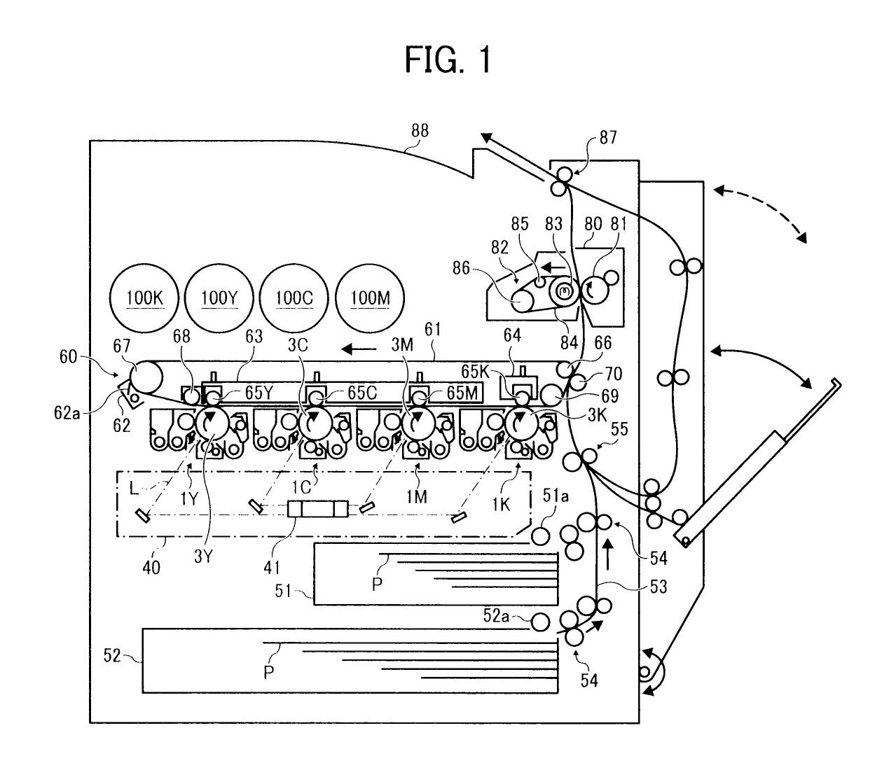

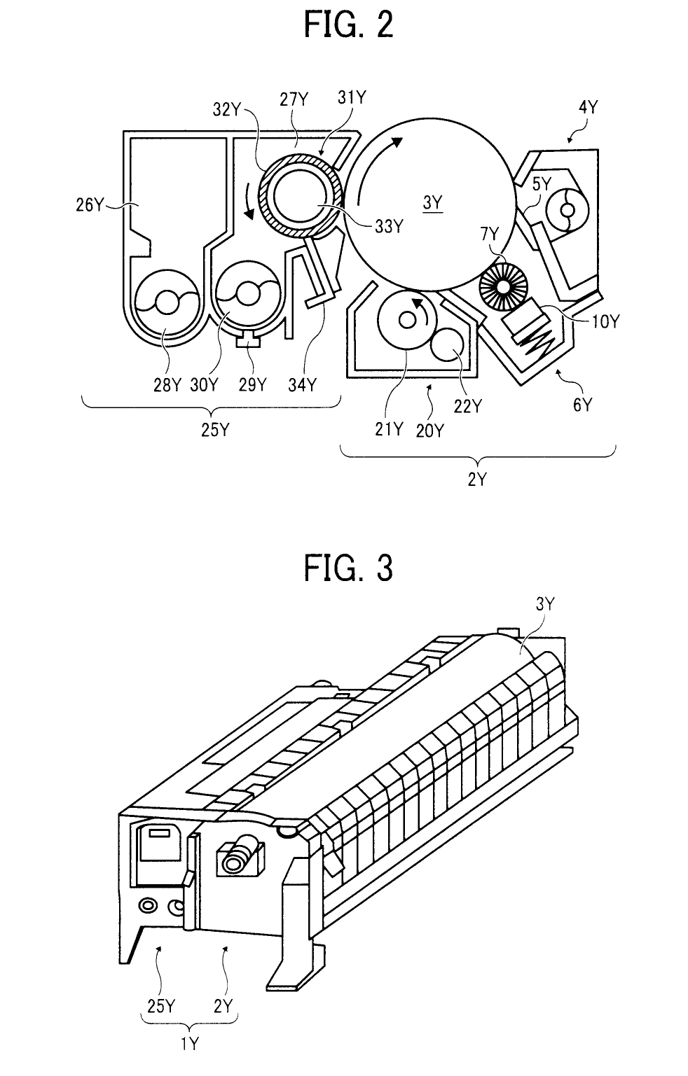

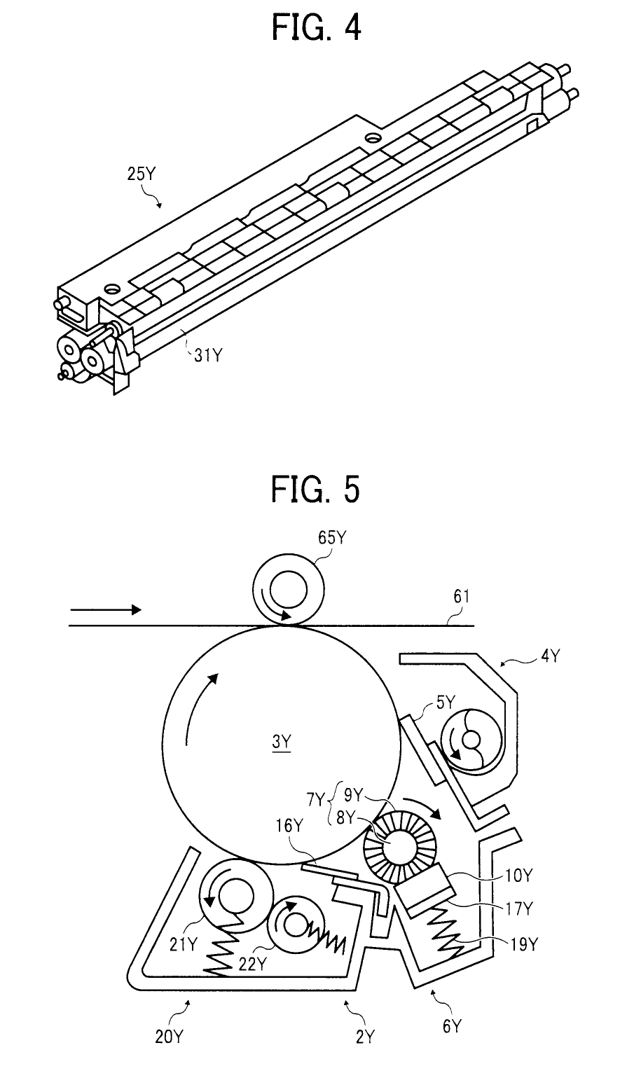

First, the basic configuration of the printer according to this embodiment will be described. FIG. 1 shows the schematic configuration of the printer according to the embodiment. The printer includes four generating units 1Y, 1C, 1M, and 1K for yellow, magenta, cyan, and black (hereinafter, referred to as Y, C, M, and K), as generating units corresponding to toner image generating units. The generating units use Y, C, M, and K toners of different colors as image forming materials to form images, respectively, but are the same in the other configuration. For example, the generating unit 1Y that generates a Y toner image will be described. As shown in FIG. 2, the generating unit 1Y has a process unit 2Y and a developing unit 25Y. These units as the generating unit 1Y are attached integrally with a printer body, as shown in FIG. 3. In a state where the units are separated from the printer body, as shown in FIG. 4, the developing unit 25Y can be attached to the process unit (2Y of FIG. 3).

In FIG. 2 described above, the process unit 2Y has a photosensitive element 3Y having a drum shape that is a latent image carrier, a drum cleaning device 4Y, a neutralization apparatus not shown in the drawings, and a charging unit 20Y.

The charging unit 20Y uniformly charges a surface of the photosensitive element 3Y that can be rotated and driven in a clockwise direction in the drawings by a driving unit not shown in the drawings. FIG. 2 shows the charging unit 20Y of a system that uniformly charges the photosensitive element 3Y by applying a charging bias by a power supply not shown in the drawings and allowing a roller charging unit 21Y rotated and driven in a counterclockwise direction in the drawings to contact or approach the photosensitive element 3Y. Instead of the roller charging unit 21Y, a portion that contacts or approaches the charging brush may be used. Like a scorotron charger or a corotron charger, a portion that uniformly charges the photosensitive element 3Y by the charger system may be used. However, since the scorotron charger system causes ozone at the time of discharging, the scorotron charger system is rarely used in recent years, from a viewpoint of environmental conformity. Further, the corotron charger system rarely causes the ozone. However, since the corotron charger system charges the photosensitive element with the positive polarity, the corotron charger system is rarely used in recent years when a reversal phenomenon method is in the mainstream. In recent years, a roller charging system is most general. Examples of the roller charging system include a contact roller charging system that brings a roller charging unit into contact with the photosensitive element and a non-contact roller charging system that allows the roller charging unit to approach the photosensitive element with a non-contact manner.

In the contact roller charging system, when an overlapped current of an alternating current and a direct current is applied as a charging bias, a high-definition image can be obtained, as compared with when only the direct current is applied. However, the contact roller charging system easily causes so-called filming that fixes a toner to the photosensitive element. In the case of the overlapped bias, by performing constant current control on the alternating current, the charging potential of the surface of the photosensitive element can be stabilized without depending on the change in a resistance value of the roller charging unit due to the environmental change. However, a cost of a high-voltage power supply increases and an AC high-frequency sound is too loud. When the charging bias composed of only the direct current is adopted, the charging potential is easily changed due to the charge in the resistance value of the roller charging unit based on the environmental change. For this reason, measures to change the voltage according to the environmental change are needed.

Meanwhile, in the non-contact roller charging system, if the alternating-current voltage is adopted as the charging bias and the constant current control is performed on the alternating-current voltage, irregularities may be easily generated in the charging potential due to the gap change of the photosensitive element and the roller charging unit. For this reason, the voltage change needs to be changed according to the gap change. However, since this system is a non-contact system, the staining of the roller charging unit can be reduced as compared with the contact system. As a method of changing the alternating-current voltage, a method that changes a voltage change according to the detection result of the peripheral temperature of the roller charging unit, a method that changes a voltage value according to the regular detection result of the surface staining on the photosensitive element, and a method that determines an application voltage by a feedback current value are exemplified. By adopting these methods, the potential of the surface of the photosensitive element is charged to about −500 V to 700 V.

As a method of driving the roller charging unit, a method that allows the roller charging unit to be in pressure contact with the photosensitive element and rotates with the frictional force or a method that receives the driving force from a photosensitive element gear is used. The former is generally used in a low-speed machine, but the latter is generally used in a machine where high speed and high definition are required.

In FIG. 2, if the surface of the roller charging unit is tainted by the toner, the charging capability in the tainted place is lowered, and it becomes difficult to charge the photosensitive element 3Y with the targeted potential. Therefore, a cleaning roller 22Y that removes the toner attached to the surface contacts the roller charging unit 21Y. As the cleaning roller 22Y, a bristle roller where fiber is electrostatically bristled on a rotation shaft member to be rotatably supported or a melamine roller where a melamine resin is disposed on the roller can be used. From a viewpoint of the long life duration, the melamine roller is advantageous. If a slip is generated between the cleaning roller 22Y and the roller charging unit 21Y, the filming is easily generated by scraping the toner on the surface of the roller charging unit 21Y. Therefore, the linear speeds are preferably set to be equal to each other. More preferably, the cleaning roller 22Y as a driven roller is rotated along the roller charging unit 21Y.

The surface of the photosensitive element 3Y that is uniformly charged by the charging unit 20Y is exposed and scanned by a laser beam emitted from an optical writing unit and the photosensitive element carries an electrostatic latent image for Y.

The developing unit 25Y has a first developer casing unit 26Y where a first carriage screw 28Y is disposed. The developing unit 25Y has a second developer casing unit where a toner density sensor 29Y composed of a permeability sensor, a second carriage screw 30Y, a developing roller 31Y, and a doctor blade 34Y are disposed. In the two developer casing units, a Y developer that includes a magnetic carrier and a Y toner having a negatively-charged substance is included. The first carriage screw 28Y is rotated and driven by a driving unit (not shown in the drawings) and conveys the Y developer in the first developer casing unit 26Y from the front side to the back side in a direction orthogonal to a plane of paper in the drawings. The first carriage screw 28Y enters a second developer casing unit 27Y through a communication port (not shown in the drawings) that is provided in a partition wall between the first developer casing unit 26Y and the second developer casing unit 27Y.

The second carriage screw 30Y in the second developer casing unit 27Y is rotated and driven by a driving unit (not shown in the drawings) and conveys the Y developer from the back side to the front side in the drawings. The toner density of the Y developer during the carriage is detected by the toner density sensor 29Y fixed to a bottom portion of the second developer casing unit 27Y. On the upper side (in the drawings) of the second carriage screw 30Y that conveys the Y developer, the developing roller 31Y is disposed at the posture parallel to the second carriage screw 30Y. The developing roller 31Y includes a magnet roller 33Y in a developing sleeve 32Y that is composed of a non-magnetic pipe rotated and driven in a counterclockwise direction in the drawings. A part of the Y developer that is carried by the second carriage screw 30Y is fed to the surface of the developing sleeve 32Y by the magnetic force generated by the magnet roller 33Y. After the layer thickness of the Y developer is regulated by the developing sleeve 32Y corresponding to the developing member and the doctor blade 34Y disposed to hold the predetermined gap, the Y developer is carried to a development region facing the photosensitive element 3Y, and the Y toner is attached to an electrostatic latent image for Y on the photosensitive element 3Y. By this adhesion, a Y toner image is formed on the photosensitive element 3Y. The Y developer that consumes the Y toner by the development is returned to the upper side of the second carriage screw 30Y according to the rotation of the developing sleeve 32Y of the developing roller 31Y. If the Y developer is carried to a leading edge in the drawings, the Y developer is returned to the first developer casing unit 26Y through the communication port (not shown in the drawings).

The detection result of the permeability of the Y developer based on the toner density sensor 29Y is transmitted as a voltage signal to a control unit (not shown in the drawings). Since the permeability of the Y developer shows a correlation with the Y toner density of the Y developer, the toner density sensor 29Y outputs a voltage of a value according to the Y toner density. The control unit includes a RAM and stores data of Vtref for Y that is a target value of an output voltage from the toner density sensor 29Y or Vtref for C, Vtref for M, and Vtref for K that are target values of output voltages from the toner density sensors for C, M, and K mounted in another developing unit. The developing unit 25Y for Y compares the value of the output voltage from the toner density sensor 29Y and Vtref for Y and drives a toner supply device for Y (not shown in the drawings) by a time according to the comparison result. By this driving, the Y toner of the appropriate amount is supplied from the first developer casing unit 26Y to the Y developer where the Y toner density is lowered due to the consumption of the Y toner according to the development. For this reason, the Y toner density of the Y developer in the second developer casing unit 27Y is maintained in a predetermined range. With respect to the developers in the generating units (1C, 1M, and 1K) for the other colors, the same toner supply control is executed.

The Y toner image that is formed on the photosensitive element 3Y is transferred to an intermediate transfer belt to be described below. The drum cleaning device 4Y of the process unit 2Y removes the toner that remains on the surface of the photosensitive element 3Y after an intermediate transfer process. Thereby, electricity of the surface of the photosensitive element 3Y where a cleaning process is executed is removed by an electricity removing device not shown in the drawings. By removing the electricity, the surface of the photosensitive element 3Y is initialized and is prepared for next image formation.

In FIG. 1 described above, even in the generating units 10, 1M, and 1K for the other colors, C, M, and K toner images are formed on the photosensitive elements 3C, 3M, and 3K in the same way, are overlapped on an intermediate transfer belt 61, and are transferred.

Below the generating units 1Y, 10, 1M, and 1K in the drawings, an optical writing unit 40 is disposed. The optical writing unit 40 that is a latent image forming unit irradiates a laser light L emitted on the basis of image information onto the photosensitive elements 3Y, 3C, 3M, and 3K of the individual generating units 1Y, 10, 1M, and 1K. Thereby, latent images for Y, C, M, and K are formed on the photosensitive elements 3Y, 3C, 3M, and 3K. The optical writing unit 40 irradiates the laser beam L emitted from the light source onto the photosensitive elements 3Y, 3C, 3M, and 3K through plural optical lenses or mirrors, while deflecting the laser beam L by a polygon mirror 41 rotated and driven by a motor. Instead of this configuration, the configuration where light scanning based on an LED array may be adopted.

Below the optical writing unit 40, a first feed cassette 51 and a second feed cassette 52 are disposed to overlap each other in a vertical direction. In each of the feed cassettes, plural recording sheets P corresponding to recording members are stored in a state of a recording sheet bundle where the plural recording sheets are overlapped. A first paper feeding roller 51a and a second paper feeding roller 52a contact the recording sheet P that is disposed at the highest position. If the first paper feeding roller 51a is rotated and driven in a counterclockwise direction by a driving unit (not shown in the drawings), the uppermost recording sheet P in the first feed cassette 51 is discharged to a feed path 53 disposed to extend in a vertical direction at the right side in the drawings. If the second paper feeding roller 52a is rotated and driven in a counterclockwise direction by a driving unit (not shown in the drawings), the uppermost recording sheet P in the second feed cassette 52 is discharged to the feed path 53.

In the feed path 53, plural carriage roller pairs 54 are disposed. The recording sheet P that is fed to the feed path 53 is carried from the lower side to the upper side on the feed path 53, while being nipped between the rollers of the carriage roller pair 54.

On an end of the feed path 53, a registration roller pair 55 is disposed. The registration roller pair 55 stops the rotation of both the rollers immediately after the recording sheet P fed from the carriage roller pair 54 is nipped between the rollers. The recording sheet P is fed to a secondary transfer nip to be described below at appropriate timing.

On the upper side of each of the generating units 1Y, 1C, 1M, and 1K, a transfer unit 60 that endlessly moves the intermediate transfer belt 61 corresponding to an endless moving object in a counterclockwise direction while stretching the intermediate transfer. The transfer unit 60 that is the transfer unit includes a belt cleaning unit 62, a first bracket 63, and a second bracket 64, in addition to the intermediate transfer belt 61. The transfer unit 60 further includes four primary transfer rollers 65Y, 65C, 65M, and 65K, a secondary transfer backup roller 66, a driving roller 67, an auxiliary roller 68, and a tension roller 69. The intermediate transfer belt 61 is endlessly moved in a counterclockwise direction by rotating and driving of the driving roller 67, while being stretched by the eight rollers. The four primary transfer rollers 65Y, 65C, 65M, and 65K nip the endlessly moved intermediate transfer belt 61 between the photosensitive element 3Y, 3C, 3M, and 3K and form primary transfer nips. A transfer bias that has the polarity (for example, positive) reversed to the polarity of the toner is applied to a back surface (loop inner circumferential surface) of the intermediate transfer belt 61. In the course of sequentially passing through the primary transfer nips for Y, C, M, and K according to the endless movement, Y, C, M, and K toner images on the photosensitive elements 3Y, C, M, and K are overlapped on a surface of the intermediate transfer belt 61 and are primarily transferred. Thereby, toner images of four colors are overlapped on the intermediate transfer belt 61 and an overlapped toner image (hereinafter, referred to as four-color toner image) is formed.

The secondary transfer backup roller 66 nips the intermediate transfer belt 61 between the secondary transfer backup roller 66 and a secondary transfer roller 70 disposed on the outside of the loop of the intermediate transfer belt 61 and forms a secondary transfer nip. The registration roller pair 55 described above feeds the recording sheet P nipped between the rollers to the secondary transfer nip at timing synchronized with the four-color toner image on the intermediate transfer belt 61. The four-color toner image on the intermediate transfer belt 61 is collectively secondarily transferred to the recording sheet P in the secondary transfer nip, by the secondary transfer electric field generated between the secondary transfer roller 70 where the secondary transfer bias is applied and the secondary transfer backup roller 66 or the nip pressure. The four-color toner image becomes a full-color image together with a white color of the recording sheet P.

After the intermediate transfer belt passes through the secondary transfer nip, a residual transfer toner that is not transferred to the recording sheet P is attached to the intermediate transfer belt 61. This residual transfer toner is removed by the belt cleaning unit 62. The belt cleaning unit 62 brings a cleaning blade 62a to be in contact with the surface of the intermediate transfer belt 61, and scrapes and removes the residual transfer toner.

The first bracket 63 of the transfer unit 60 is configured to rock at a predetermined rotation angle with respect to a rotation shaft of the auxiliary roller 68, according to ON/OFF of driving of a solenoid (not shown in the drawings). When the printer according to the embodiment forms a monochromatic image, the first bracket 63 is slightly rotated in a counterclockwise direction, by the driving of the solenoid described above. By revolving the primary transfer rollers 65Y, 65C, and 65M for Y, C, and M around the rotation shaft of the auxiliary roller 68 in a counterclockwise direction by the rotation, the intermediate transfer belt 61 is separated from the photosensitive elements 3Y, 3C, and 3M for Y, C, and M. A monochromatic image is formed by driving only the generating unit 1K for K, among the four generating units 1Y, 10, 1M, and 1K. Thereby, the generating units can be avoided from being abraded due to the unnecessary driving of the generating units for Y, C, and M, when the monochromatic image is formed.

On the upper side of the secondary transfer nip, a fixing unit 80 is disposed. The fixing unit 80 includes a pressing/heating roller 81 that includes a heat generating source such as a halogen lamp and a fixing belt unit 82. The fixing belt unit 82 has a fixing belt 84 that is a fixing member, a heating roller 83 that includes a heat generating source such as a halogen lamp, a tension roller 85, a driving roller 86, and a temperature sensor (not shown in the drawings). The endless fixing belt 84 is endlessly moved in a counterclockwise direction, while being stretched by the heating roller 83, the tension roller 85, and the driving roller 86. In the course of the endless movement, the fixing belt 84 is heated from the back surface side, by the heating roller 83. Around the heating roller 83 of the fixing belt 84 that is heated in the above-described way, the pressing/heating roller 81 that is rotated and driven in a counterclockwise direction in the drawings contacts from the surface. Thereby, a fixing nip where the pressing/heating roller 81 is in contact with the fixing belt 84 is formed.

Outside the loop of the fixing belt 84, a temperature sensor (not shown in the drawings) is disposed to face the surface of the fixing belt 84 through a predetermined gap, and detects the surface temperature of the fixing belt 84 immediately before the fixing belt enters the fixing nip. The detection result is transmitted to a fixing power supply circuit that is not shown in the drawings. The fixing power supply circuit performs ON/OFF control of the supply of power to the heating generating source included in the heating roller 83 or the heat generating source included in the pressing/heating roller 81. Thereby, the surface temperature of the fixing belt 84 is maintained at about 140°.

After the recording sheet P passed through the secondary transfer nip is separated from the intermediate transfer belt 61, the recording sheet P is fed to the fixing unit 80. In the course of the recording sheet P being carried from the lower side to the upper side while being nipped in the fixing nip in the fixing unit 80, the recording sheet P is heated by the fixing belt 84 or pressed, and a full-color toner image is fixed.

The recording sheet P where the fixing process is executed in the above way is discharged to the outside of the machine, after the recording sheet passes between the rollers of a discharging roller pair 87. On a top surface of the casing of the printer body, a stack portion 88 is formed. The recording sheet P that is discharged to the outside of the machine by the discharging roller pair 87 is sequentially stacked on the stack portion 88.

On the upper side of the transfer unit 60, four toner cartridges 100Y, 100C, 100M, and 100K that store Y, C, M, and K toners are disposed. The Y, C, M, and K toners that are disposed in the toner cartridges 100Y, 100C, 100M, and 100K are appropriately supplied to the developing units 25Y, 25C, 25M, and 25K of the generating units 1Y, 10, 1M, and 1K. The toner cartridges 100Y, 100C, 100M, and 100K can be attached to the printer body, independently from the generating units 1Y, 10, 1M, and 1K.

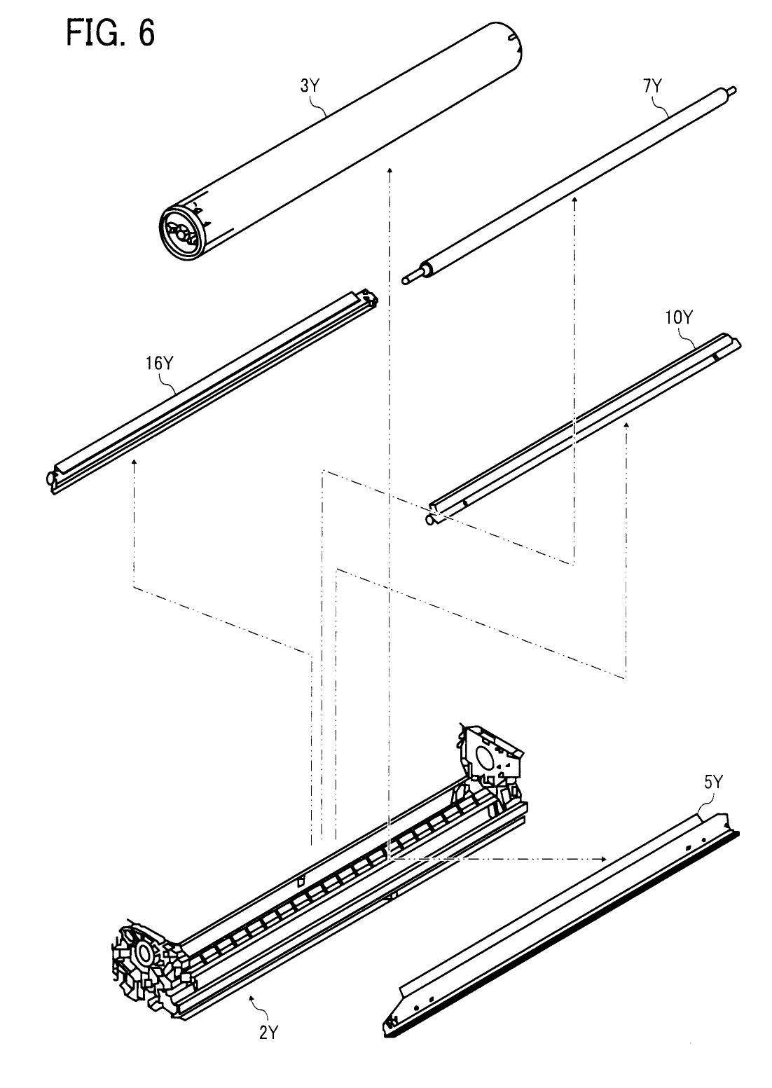

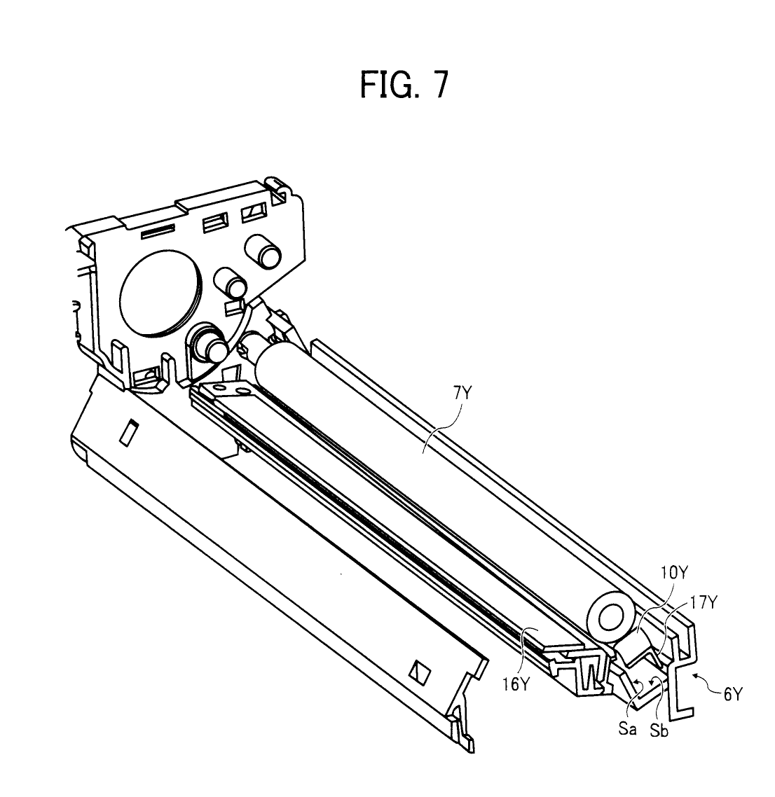

FIG. 5 is an enlarged view showing the configuration of the process unit 2Y for Y and the intermediate transfer belt 61. FIG. 6 is an assembly exploded perspective view showing the process unit 2Y. FIG. 7 is an exploded perspective view showing an inner portion of a lubricant applying device 6Y of the process unit 2Y. In these drawings, the residual transfer toner that is not transferred to the intermediate transfer belt 61 is attached to the surface of the photosensitive element 3Y after passing through the primary transfer nip for Y contacting the intermediate transfer belt 61. The residual transfer toner is removed by the drum cleaning device 4Y of the process unit 2Y.

The drum cleaning device 4Y brings a free end of a cantilever-supported cleaning blade 5Y to be in contact with the surface of the photosensitive element 3Y in a counter direction, and scrapes the residual transfer toner from the surface of the photosensitive element 3Y by a blade edge thereof. The scraped residual transfer toner falls to a collection coil in the drum cleaning device 4Y and is discharged to the outside of the drum cleaning device 4Y. The discharged residual transfer toner falls to the inner side of a waste toner bottle (not shown in the drawings).

After the cleaning process is executed by the drum cleaning device 4Y, on the surface of the photosensitive element 3Y, a lubricant applying process and a lubricant smoothing process based on the lubricant applying device 6Y are executed. The lubricant applying device 6Y is rotated and driven in a clockwise direction while contacting a brush leading edge of an applying brush roller 7Y including a rotation shaft member 8Y to be rotatably supported and a brush roller portion 9Y with plural bristles standing upright on a peripheral surface thereof. The solid lubricant 10Y that is biased to the applying brush roller 7Y together with a holding member 17Y by a coil spring 19Y is pressed against the applying brush roller 7Y. The applying brush roller 7Y applies the lubricant powder scraped off from the solid lubricant 10Y to the surface of the photosensitive element 3Y, by the rotating and driving thereof. Thereby, by lowering frictional resistance of the surface of the photosensitive element 3Y, to-be-cleaned capability is improved, transferability is improved, and filming is suppressed.

As the bristles that are used in the brush roller portion 9Y of the applying brush roller 7Y corresponding to the applying member, bristles that are made of insulating or conducting polyethylene terephthalate or an acrylic resin may be exemplified. Instead of the applying brush roller 7Y, an applying sponge roller that includes a roller portion made of a sponge may be used.

As the solid lubricant 10Y, a solid lubricant that is made of various fatty acid salts or a solid lubricant that is made of zinc stearate may be exemplified. Also, solid lubricants that use a fatty acid such as a stearic acid, a palmitic acid, a myristic acid, and an oleic acid and a fatty acid metal salt made of a metal such as zinc, aluminum, calcium, magnesium, iron, the lithium as main components may be exemplified. In particular, stearic acid zinc is preferable.

Next, the characteristic configuration of the printer according to the embodiment will be described.

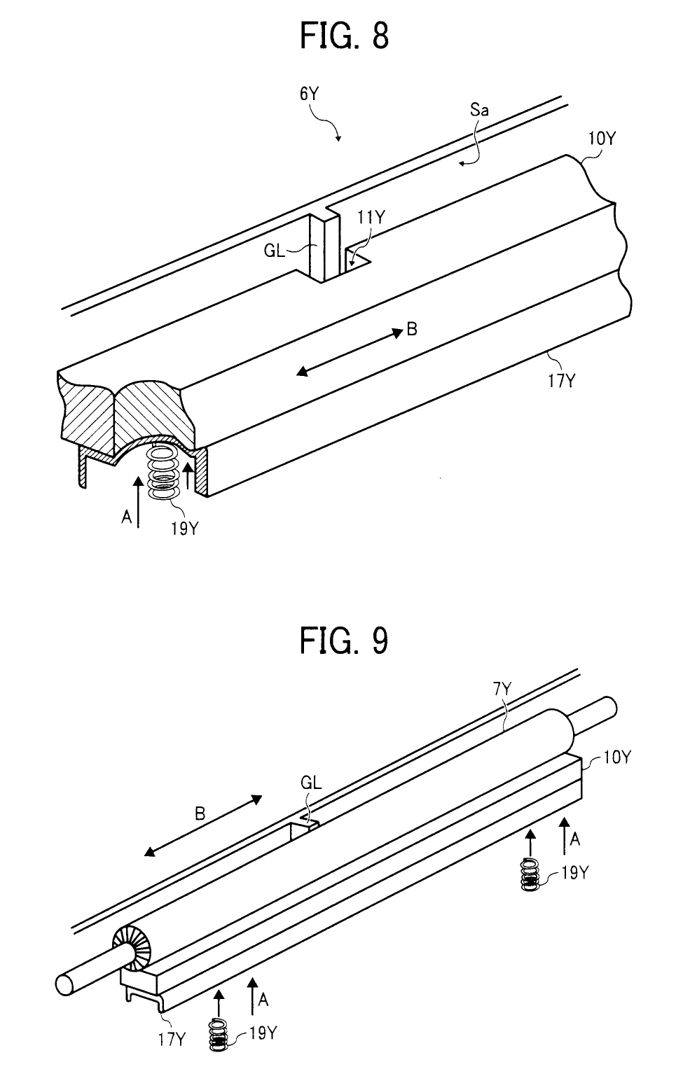

FIG. 8 is an enlarged perspective view showing an inner portion of the lubricant applying device 6Y for Y. FIG. 9 is an enlarged perspective view showing an inner portion of the lubricant applying device 6Y. In these drawings, the solid lubricant 10Y is fixed to the surface of the holding member 17Y made of C-shape steel, by both-sided tape. The coil spring 19Y contacts a back surface of a lubricant fixing surface in the holding member 17Y. The coil spring 19Y biases the solid lubricant 10Y in a direction of an arrow A toward the applying brush roller (not shown in the drawings) through the holding member 17Y. The direction of the arrow A is a direction along an orthogonal virtual surface orthogonal to a rotation axis direction of the applying brush roller 7Y and a central direction of the applying brush roller 7Y.

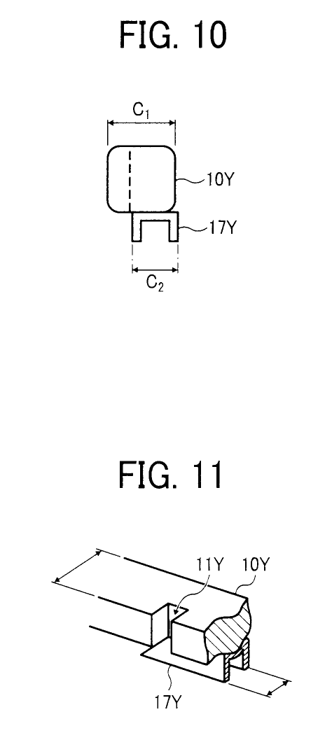

The solid lubricant 10Y is formed in an elongated block shape to contact almost an entire region of the brush roller portion of the applying brush roller 7Y in a longitudinal direction. As shown in FIG. 10, the width C₁ that is a longitudinal direction dimension in the solid lubricant 10Y having the block shape is set to a value larger than the width C₂ of the holding member 17Y. For this reason, on the surface of the holding member 17Y, the solid lubricant 10Y protrudes in a width direction more than the holding member 17Y. On the side of the protruding solid lubricant place, as shown in FIG. 8 or 11, a chipped concave portion 11Y is formed.

Meanwhile, on an inside wall Sa (refer to FIG. 7) that faces the concave portion 11Y of the solid lubricant 10Y among plural inside walls in the casing of the lubricant applying device 6Y, as shown in FIG. 8, a guide rail GL that extends in a direction of an arrow A in the drawings, that is, in a spring biasing direction is formed integrally with the casing. The solid lubricant 10Y is set to the guide rail GL at the posture to engage the concave portion 11Y corresponding to the engagement portion. As such, in the engaged state, the guide rail GL allows movement, in a direction toward the applying brush roller 7Y, of the solid lubricant 10Y biased to the applying brush roller 7Y by the coil spring 19Y, that is, slide movement in the direction of the arrow A in the drawings. Meanwhile, the guide rail GL regulates movement, in the same direction, of the solid lubricant 10Y having a frictional surface which is rubbed by the rotating applying brush roller 7Y and to which the force of the rotation direction and the force of a direction (direction of an arrow B in the drawings) orthogonal to the rotation direction may be applied. In this way, the guide rail GL functions as a guide portion that guides movement of the solid lubricant 10Y toward the applying brush roller 7Y.

In this configuration, the guide rail GL can guide the movement of the solid lubricant 10Y toward the applying brush roller 7Y while regulating the horizontal movement corresponding to the movement of the solid lubricant 10Y in the direction of the arrow B in the drawings, and avoid generation of the horizontal movement of the solid lubricant 10Y. The width C₁ of the solid lubricant 10Y can be set to be larger than the width C₂ of the holding member 17Y to protrude the solid lubricant 10Y from the holding member 17Y. As shown in FIG. 11, by providing the concave portion 11Y in the protruding place, only the solid lubricant 10Y can be slid and rubbed on the guide rail GL. Since the solid lubricant 10Y is a material having very small surface frictional resistance, smooth slide movement is enabled by sliding and rubbing only the solid lubricant 10Y.

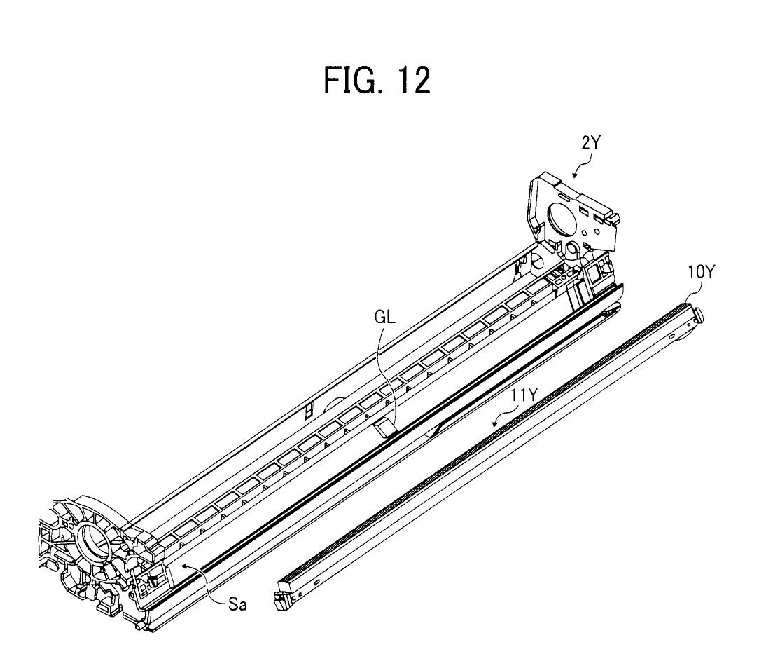

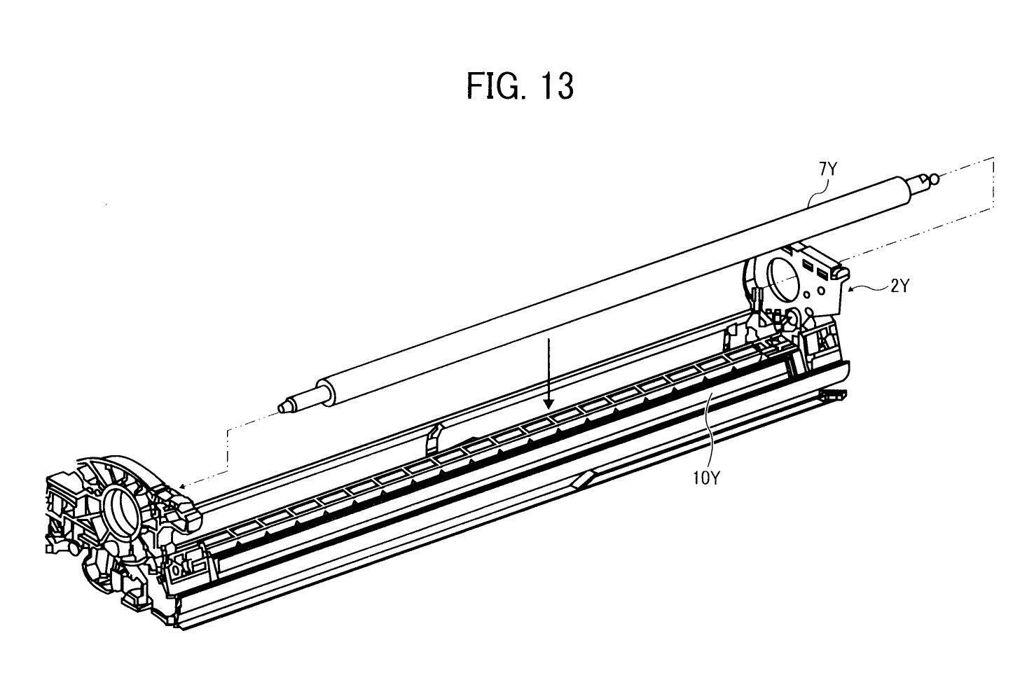

When the solid lubricant 10Y and the holding member 17Y are assembled in the device, as shown in FIG. 12, the solid lubricant 10Y and the holding member 17Y are pressed against a bottom plate of the casing, while engaging the concave portion 11Y of the solid lubricant 10Y with the guide rail GL of the casing. At this time, since the solid lubricant 10Y and the holding member 17Y are pressed against the resistance of the spring, if a hand is released, the solid lubricant 10Y or the holding member 17Y may be flicked from the casing. For this reason, at the same time as when the hand is released, as shown in FIG. 13, the applying brush roller 7Y is set to a bearing, while the solid lubricant 10Y is continuously pressed by the applying brush roller 7Y.

The lubricant applying device 6Y for Y is described in detail above. However, even in the lubricant applying devices for the other colors, the horizontal movement of the solid lubricant can be avoided by the same configuration. As the rotation direction of the applying brush roller 7Y, a direction that becomes a counter direction in the contact portion with the photosensitive element 3Y or a direction that becomes a forward direction may be adopted.

Next, modifications of the printer according to the embodiment will be described. The configurations of the modifications are the same as that of the first embodiment, as long as the specific description is not given.

### First Modification

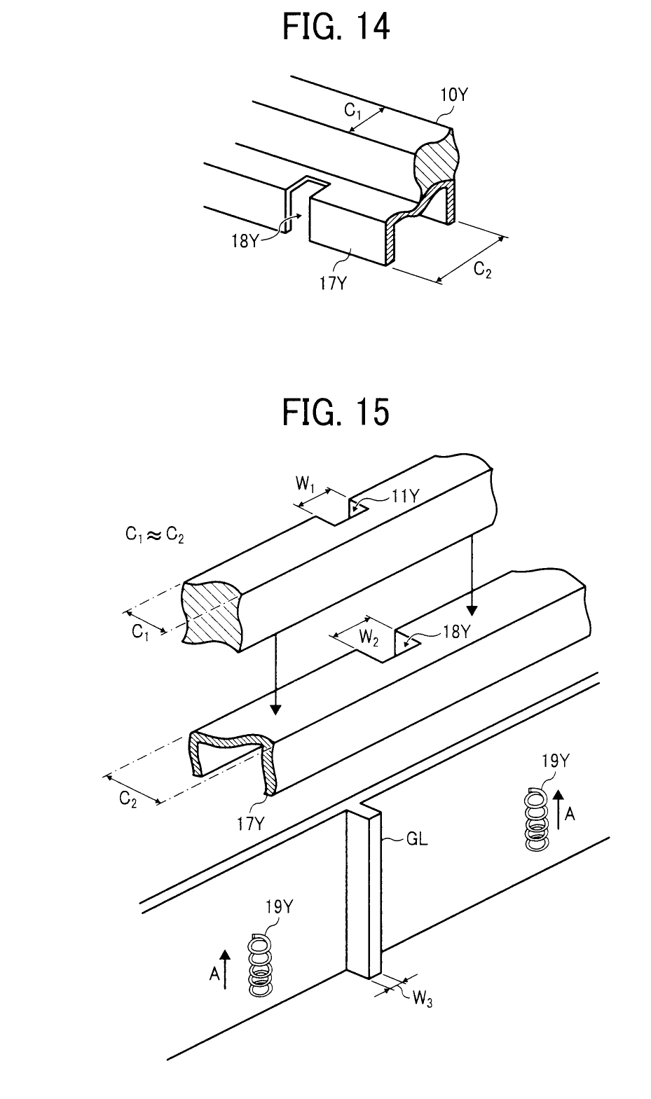

FIG. 14 is an enlarged exploded perspective view showing a solid lubricant 10Y for Y and a holding member 17Y in a printer according to a first modification. In FIG. 14, different from the embodiment, the width C₁ of the solid lubricant 10Y is set to be smaller than the width C₂ of the holding member 17Y. For this reason, different from the embodiment, the holding member 17Y protrudes in a width direction more than the solid lubricant 10Y. In the protruding place, a concave portion 18Y that engages with a guide rail of a casing (not shown in the drawings) is formed. By engaging the concave portion 18Y with the guide rail and regulating the horizontal movement of the holding member 17Y to horizontally move together with the solid lubricant 10Y, the horizontal movement of the solid lubricant 10Y can be avoided. By making the guide rail not contact the solid lubricant 10Y, the solid lubricant 10Y can be avoided from being split or chipped due to strong pressing of the guide rail.

### Second Modification

If the solid lubricant 10Y protrudes in the width direction more than the holding member 17Y as described above in the embodiment shown in FIG. 11 or the holding member 17Y protrudes in the width direction more than the solid lubricant 10Y as described above in the first modification shown in FIG. 14, a dead space in the device may be increased. In the protruding region, in a height direction, only a movable range of the solid lubricant 10Y or the holding member 17Y becomes a valid region and the other region becomes the dead space that is not effectively used.

Therefore, in the printer according to a second modification, as shown in FIG. 15, the width C₁ of the solid lubricant 10Y and the width C₂ of the holding member 17Y are set to be almost equal to each other. The concave portions to receive the guide rail GL of the casing are provided in the solid lubricant 10Y and the holding member 17Y, respectively (11Y and 18Y). The width W₁ of the concave portion 11Y of the solid lubricant 10Y and the width W₂ of the concave portion 18Y of the holding member 17Y are larger than the width W₃ of the guide rail. Thereby, the guide rail GL can be received in both of the concave portions 11Y and 18Y.

A relationship between the width W₁ of the concave portion 11Y of the solid lubricant 10Y and the width W₂ of the concave portion 18Y of the holding member 17Y is appropriately set according to a priority between competing factors, the damage of the lubricant and the pressing trouble. Specifically, when the priority is set on preventing the damage of the solid lubricant 10Y, the width W₂ of the concave portion 18Y of the holding member 17Y is set to be smaller than the width W₁ of the concave portion 11Y of the solid lubricant 10Y and only the concave portion 18Y of the holding member 17Y is engaged with the guide rail GL. The guide rail GL is received in the concave portion 11Y of the solid lubricant 10Y. However, a predetermined gap is formed between an inside wall of the concave portion 11Y and a side of the guide rail GL. Thereby, the solid lubricant 10Y can be prevented from being damaged due to pressing of the guide rail GL into the solid lubricant 10Y.

Meanwhile, when the priority is set on preventing the pressing trouble of the solid lubricant 10Y, the width W₁ of the concave portion 11Y of the solid lubricant 10Y is set to be smaller than the width W₂ of the concave portion 18Y of the holding member 17Y and only the concave portion 11Y of the solid lubricant 10Y is engaged with the guide rail GL. The guide rail GL is received in the concave portion 18Y of the holding member 17Y. However, a predetermined gap is formed between an inside wall of the concave portion 18Y and a side of the guide rail GL. Thereby, the pressing trouble of the solid lubricant 10Y against the applying brush roller may not be generated, the trouble being attributable to hooking of the minute protrusions on the surface of the holding member 17Y having the relatively large surface frictional resistance against the lubricant applying brush.

If the prevention of the damage and the suppressing of the pressing trouble are to be equally executed, the widths W₁ and W₂ are set to have the same value. Thereby, by contacting the inside wall of the concave portion 11Y of the solid lubricant 10Y with the guide rail GL and allowing the solid lubricant to be attached to the side of the guide rail GL, the surface frictional resistance of the guide rail GL is lowered. In this case, the concave portion 18Y of the holding member 17Y is smoothened on the guide rail GL and generation of the pressing trouble can be suppressed.

### Third Modification

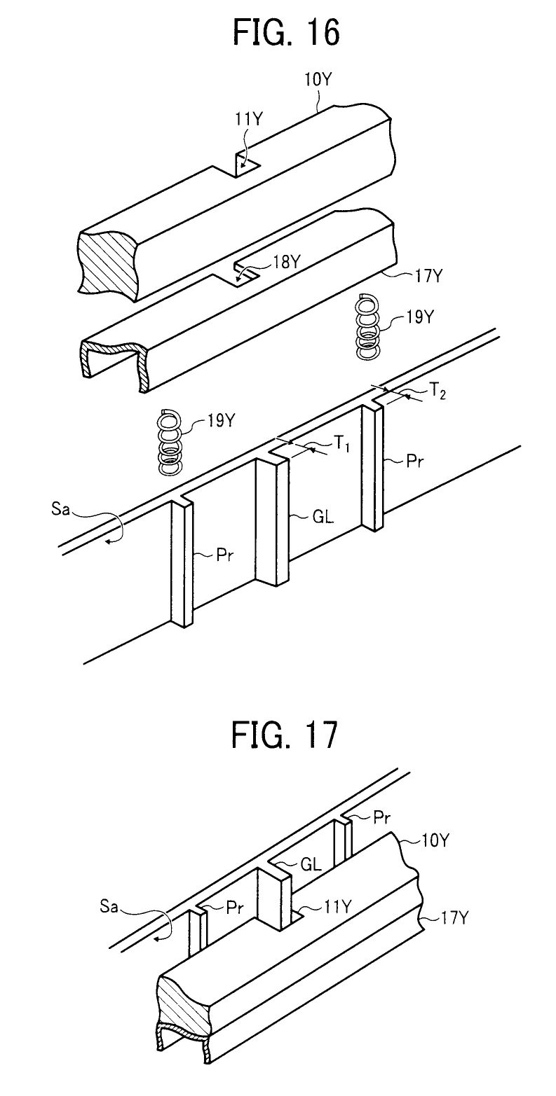

FIG. 16 is an assembly exploded perspective view showing a solid lubricant 10Y for Y, a holding member 17Y, and a casing in a printer according to a third modification. As shown in FIG. 16, even in the printer according to the third modification, similar to the second modification, the concave portions 11Y and 18Y are provided in the solid lubricant 10Y and the holding member 17Y, respectively. The third modification is different from the second modification in that auxiliary rails Pr are provided on an inside wall surface Sa of the casing.

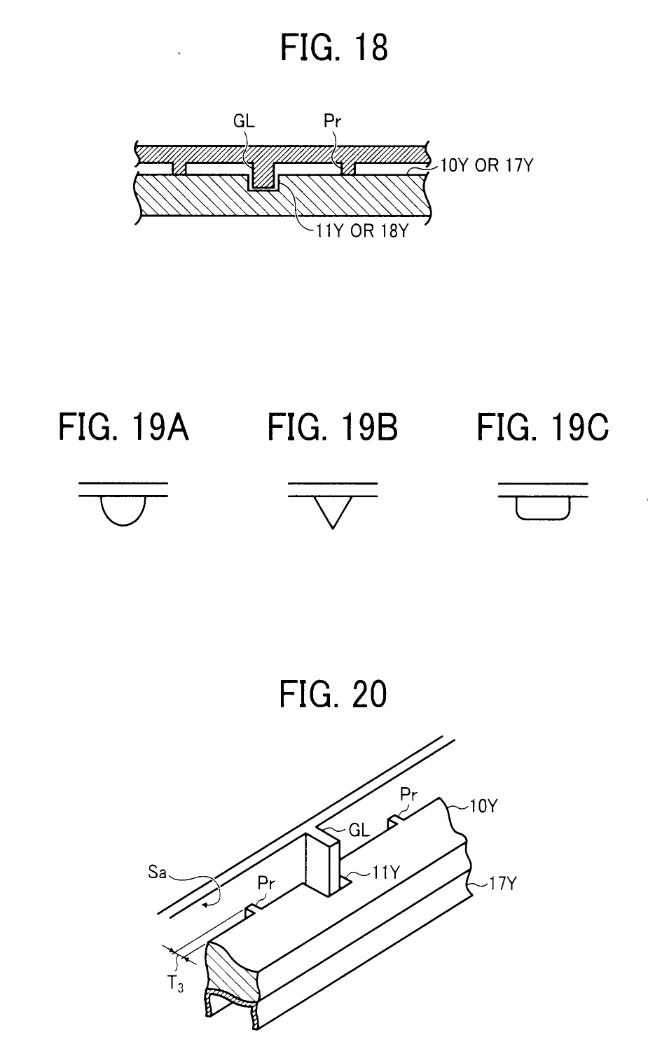

The auxiliary rails Pr are provided at sides of the guide rail GL at the predetermined distances with the guide rail GL. The protrusion amounts T₂ of the two auxiliary rails Pr from the inside wall surface Sa are smaller than the protrusion amount T₁ from the inside wall surface Sa of the guide rail GL. Thereby, as shown in FIG. 17 or 18, in a state where the guide rail GL is received in the concave portion 11Y of the solid lubricant 10Y or a concave portion (not shown in the drawings) of the holding member 17Y, leading edges of the auxiliary rails Pr contact the sides of the solid lubricant 10Y or the holding member 17Y. In a state where there is not auxiliary rail Pr, the entire region of the side of the solid lubricant 10Y or the side of the holding member 17Y is slid and rubbed on the inside wall surface Sa of the casing. However, in this modification, since the auxiliary rails Pr are provided, the sides do not entirely contact the inside wall surface Sa. Since only the leading edge of the auxiliary rail Pr is slid and rubbed on the side of the solid lubricant 10Y or the holding member 17Y, sliding and friction resistance is greatly decreased. Thereby, the pressing trouble of the lubricant may be prevented, the trouble being attributable to the hooking.

The sectional shape of the guide rail GL or the auxiliary rail Pr is not limited to the rectangular shape. As shown in FIGS. 19A to 19C, a circular shape, a polygonal shape or an elliptical shape may be adopted.

### Fourth Modification

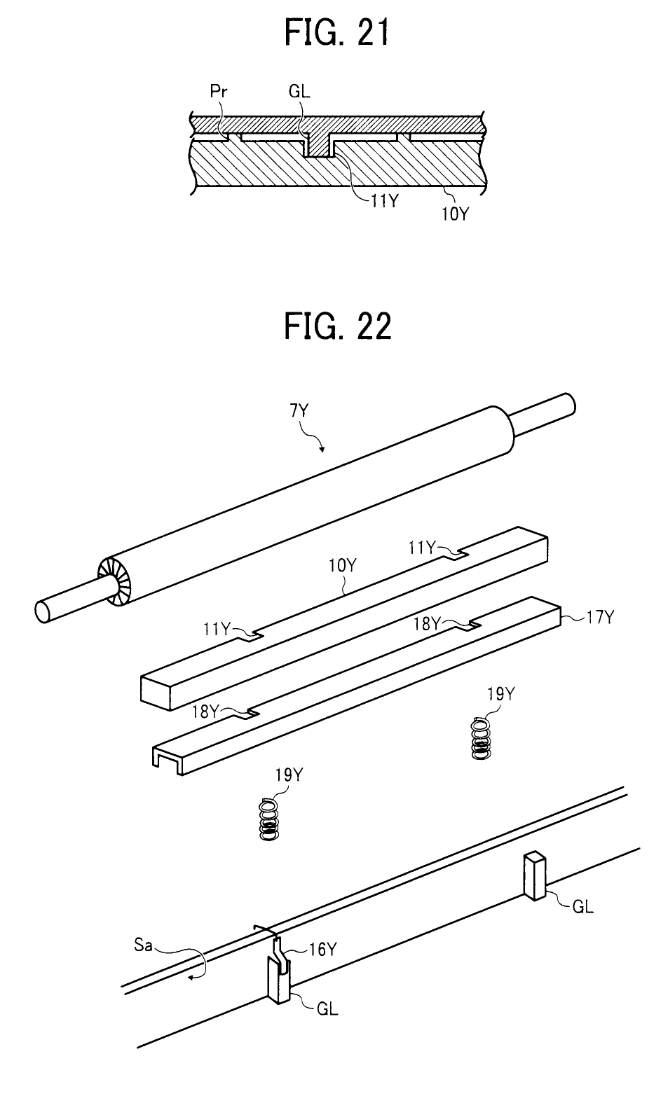

FIG. 20 is an assembly exploded perspective view showing a solid lubricant 10Y for Y, a holding member 17Y, and a casing in a printer according to a fourth modification. The fourth modification is different from the third modification in that an auxiliary rail Pr made of a lubricant is provided on the side of the solid lubricant 10Y, instead of the inside wall surface Sa of the casing. The protrusion amount of the auxiliary rail Pr from the side of the lubricant is smaller than the protrusion T1 of the guide rail GL. Thereby, as shown in FIG. 21, only the auxiliary rail Pr made of the lubricant can be slid and rubbed on the inside wall surface Sa of the casing, and the pressing trouble of the lubricant may not be generated, the trouble being attributable to the hooking.

The auxiliary rail is provided in the solid lubricant 10Y. However, the auxiliary rail may be provided in the holding member 17Y.

### Fifth Modification

FIG. 22 is an assembly exploded perspective view showing a solid lubricant 10Y for Y, a holding member 17Y, and a casing in a printer according to a fifth modification. In the lubricant applying device, the concave portion 11Y of the solid lubricant 10Y and the concave portion 18Y of the holding member 17Y are provided in both ends of the solid lubricant in a longitudinal direction. For this reason, the two guide rails GL that correspond to the concave portions are provided in the inside wall surface Sa of the casing. In this configuration, as compared with the embodiment where only one guide rail GL or concave portion is provided in the central portion of the solid lubricant in the longitudinal direction, fluctuation of the solid lubricant 10Y or the holding member 17Y in both ends of the solid lubricant in the longitudinal direction can be suppressed.

As shown in FIG. 22, the dimensions of the solid lubricant 10Y or the holding member 17Y in the longitudinal direction are almost equal to the dimension of the brush roller portion of the applying brush roller 7Y in the rotation axis direction. For this reason, the concave portions 11Y provided at both ends of the solid lubricant in the longitudinal direction and the concave portions 18Y provided at both ends of the holding member 17Y in the longitudinal direction are positioned in the region between one end and the other end of the brush roller portion in the rotation axis direction. Likewise, the two guide rails GL that are provided on the inside wall surface Sa of the casing are positioned in a region between one end and the other end of the brush roller portion of the applying brush roller 7Y in the rotation axis direction. That is, in the embodiment and the modifications described above, the guide portion composed of the guide rail GL or the concave portion is disposed between one end and the other end of the brush roller portion in the rotation axis direction. With this configuration, as compared with the case where the guide means is provided on the outer side of both ends of the brush roller portion like the configuration where the protruding members are provided on both ends of the brush roller portion, it may be possible to reduce the size of the lubricant applying device in the rotation axis direction of the roller. Since the size of the lubricant applying device in the rotation axis direction of the roller affects the size of the process unit or the developing unit, the size of the process unit or the developing unit can be decreased by decreasing the size of the former.

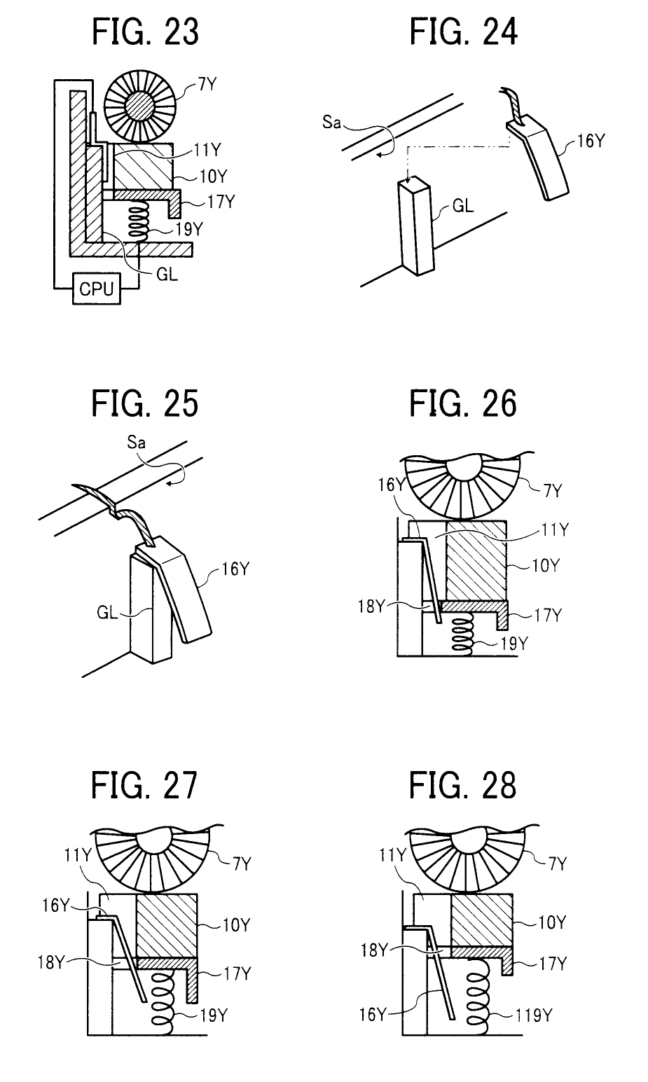

An electrode 16Y is fixed to one of the two guide rails GL. As shown in FIG. 23, the electrode 16Y is received in the concave portion 11Y of the solid lubricant 10Y together with the guide rail GL. To the electrode 16Y, a CPU is electrically connected. To the CPU, a metallic holding member 17Y is electrically connected through a metallic coil spring 19Y.

When the thickness of the solid lubricant 10Y is sufficiently large, the electrode 16Y contacts the inside wall of the concave portion 11Y of the solid lubricant 10Y, but does not reach the holding member 17Y. Therefore, the electrode 16Y and the holding member 17Y are not electrically connected to each other. If the solid lubricant 10Y is consumed and the thickness thereof is gradually decreased, the holding member 17Y comes close to the applying brush roller 7Y (as compared with a state shown in the drawings). At this time, the concave portion of the holding member 17Y gradually comes close to the electrode 16Y. If the solid lubricant is almost entirely consumed and the thickness thereof is almost minimized, the concave portion of the holding member 17Y reaches the electrode 16Y and the inside wall of the concave portion contacts the electrode 16Y. Thereby, the CPU that corresponds to the life duration notifying unit detects electrical connection of the electrode 16Y and the holding member 17Y and notifies a user of that the solid lubricant 10Y is completely consumed, through display. As such, in the fifth modification, the guide rail GL can be used as a support member of the life duration detecting electrode, and the cost can be decreased.

### Sixth Modification

FIG. 24 is an assembly exploded perspective view showing a guide rail GL for Y and an electrode 16Y in a printer according to a sixth modification. FIG. 25 is a perspective view showing the guide rail GL and the electrode 16Y. Similar to the fifth modification, in the printer according to the sixth modification, the electrode 16Y is fixed to the guide rail GL. The sixth modification is different from the fifth modification in that an inclined portion is provided in the electrode 16Y. This inclined portion is inclined to be apart from the guide rail GL in the electrode place at the position apart from the applying brush roller (not shown in the drawings).

In a state where the electrode 16Y is fixed, if the solid lubricant is set, as shown in FIG. 26, an electrode leading edge of the electrode 16Y farthest from the applying brush roller 7Y in a rail extension direction contacts the inside wall of the concave portion 18Y of the holding member 17Y. Thereby, electric connection of the electrode 16Y and the holding member 17Y is detected by the CPU (not shown in the drawings). The CPU that detects the electric connection determines that the solid lubricant 10Y is correctly set. That is, the CPU detects the electric connection when the solid lubricant 10Y is in an initial state, and can determine whether the solid lubricant is correctly set, in addition to the life duration.

If the solid lubricant 10Y is consumed and as a result the thickness thereof is decreased, as shown in FIG. 27, instead of the leading edge of the electrode 16Y in the rail extension direction, an approximately central portion contacts the inside wall of the concave portion 18Y of the holding member 17Y. Even in this state, since the electrode 16Y and the holding member 17Y are electrically connected to each other, the CPU determines that the solid lubricant 10Y is not completely consumed.

If the solid lubricant 10Y is completely consumed, as shown in FIG. 28, the concave portion 18Y of the holding member 17Y moves to the position near a base portion. In this state, the concave portion 18Y cannot contact the electrode 16Y, and the electrode 16Y and the holding member 17Y enter a non-conductive state. In this case, the CPU determines that the solid lubricant 10Y is completely consumed and notifies the user of that the solid lubricant 10Y is completely consumed. Then, if the solid lubricant 10Y is replaced with a new solid lubricant by work of the user or a service man, the state becomes a state shown in FIG. 26, and the CPU detects electric connection of the electrode 16Y and the holding member 17Y and grasps that the new solid lubricant 10Y is correctly set.

### Seventh Modification

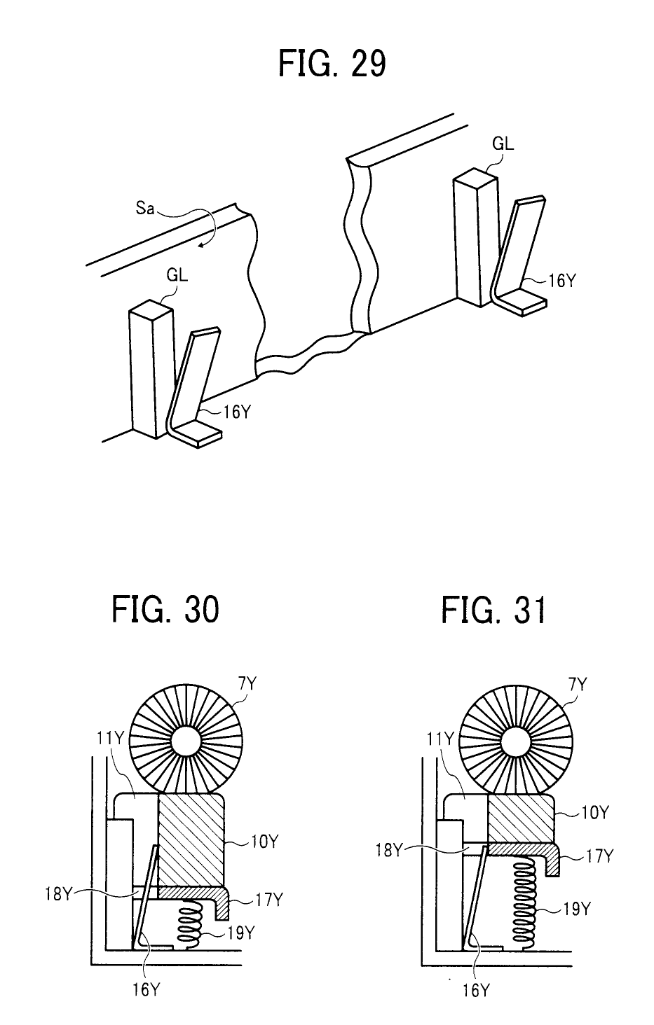

FIG. 29 is an exploded perspective view showing a guide rail GL for Y and an electrode 16Y in a printer according to the seventh modification. In the printer, the two guide rails GL are provided on the inside wall Sa of the casing. The guide rails GL are received in the concave portions that are provided in both ends of the solid lubricant and the holding member (not shown in the drawings) in a longitudinal direction.

Each of two guide rails GL is provided with the electrode 16Y fixed thereto. The electrodes 16Y are configured to be inclined. However, as compared with the printer according to the sixth modification, the inclination is reversed in shape. Specifically, the inclination is established in a manner such that as the electrode is closer to the applying brush roller (not shown), the electrode is further apart from the guide rail GL.

In a state where the electrode 16Y having the inclination is fixed to the guide rail GL, the solid lubricant is set. In this case, as shown in FIG. 30, an leading edge of the electrode 16Y which is the closest portion to the applying brush roller 7Y in a rail extension direction of the electrode 16Y contacts the inside wall of the concave portion 11Y of the solid lubricant 10Y. In this state, the electrode 16Y and the holding member 17Y enter a non-conductive state.

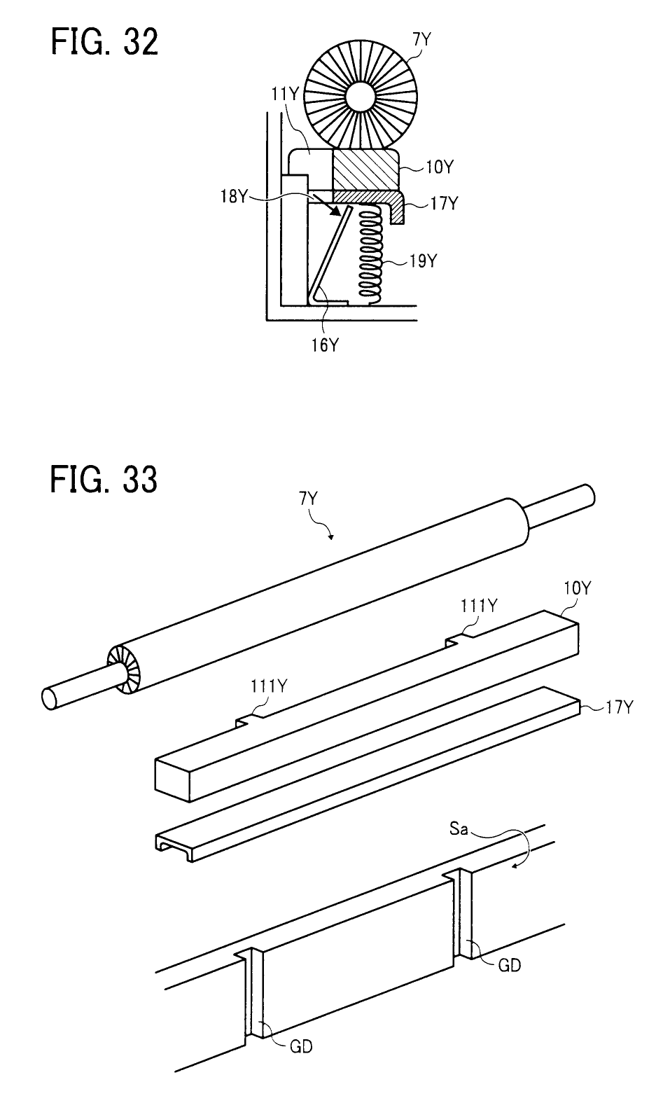

As the solid lubricant 10Y is consumed and as a result, the thickness thereof is decreased, the holding member 17Y gradually gets closer to the applying brush roller 7Y. Finally, when the thickness of the solid lubricant 10Y becomes smaller to the extent that the life of the solid lubricant comes to an end, as shown in FIG. 31, the leading end of the electrode 16Y and the inside wall of the concave portion 18Y come into contact with each other, so that they are electrically connected (enter an electrical contact state). Subsequently, if the solid lubricant 10Y is further consumed, as shown in FIG. 32, the leading end of the electrode 16Y is separated from the inside wall of the concave portion 18Y of the holding member 17Y, and the electrode 16Y moves out of the concave portion 18Y in a moment by its restoring force. Due to this, the electrode 16Y and the holding member 17Y are electrically disconnected from each other (enter an electrically non-contact state).

CPU notifies a user of that the life of the solid lubricant 10Y comes to an end not before long if the electrical contact state of the two electrodes changes from an initial state (state of FIG. 30) where both of the two electrodes 16Y are electrically disconnected from the holding member 17Y to a state (state of FIG. 31) where at least one of the two electrodes 16Y are electrically connected to the holding member 17Y. Subsequently, if the electrical contact state changes back from the state where the electrodes 16Y are electrically connected to the holding member 17Y to the state where the electrodes 16Y are electrically disconnected from the holding member 17Y (state of FIG. 32), the CPU notifies a user of that the life of the solid lubricant Y finally comes to an end.

With this configuration, a user is enabled to be notified that the life of the solid lubrication comes to an end in no time so as to be ready for replacement of the solid lubricant. Further, even if the solid lubricant 10Y is subject to uneven wear at one end portion thereof in the longitudinal direction because of some factors, the end of the life of the solid lubricant at the very end portion can be appropriately detected by the corresponding electrode 16Y of the end portion suffering from the uneven wear. Moreover, if the life of the solid lubricant 10Y comes to an end, the leading end portion of the electrode 16Y is separated from the holding member 17Y promptly by the principle of a leaf spring and as a result, enters the electrically non-contact state. Accordingly, it may be possible to certainly detect the end of the life of the solid lubricant.

### Eighth Modification

FIG. 33 is an assembly exploded perspective view showing an applying brush roller 7Y for Y, a solid lubricant 10Y, a holding member 17Y, and a casing in a printer according to an eighth modification. In the lubricant applying device, the eighth modification is different from the fifth modification in the following point. That is, on the inside wall surface Sa of the casing, two guide grooves GD are provided, instead of the two guide rails. Of a solid lubricant 10Y and a holding member 17Y, only the solid lubricant 10Y is provided with two convex portions 111Y to be individually engaged with the two guide grooves GD. Due to the same reason as that related to the printer according to the fifth modification, both of the convex portions 111Y provided at both ends of the solid lubricant 10Y in the longitudinal direction are positioned in a region between one end and the other end of the brush roller portion of the applying brush roller 7Y in the longitudinal direction, or in a rotation axis direction. The two guide grooves GD provided in the inside wall surface Sa of the casing are also positioned in a region between one end and the other end of the brush roller portion of the applying brush roller 7Y in the rotation axis direction. Even with this configuration, as compared with the case in which a guide means is provided on the outer side of both ends of the brush roller portion, it may be possible to reduce the size of the lubricant applying device in the rotation axis direction of the roller.

### Ninth Modification

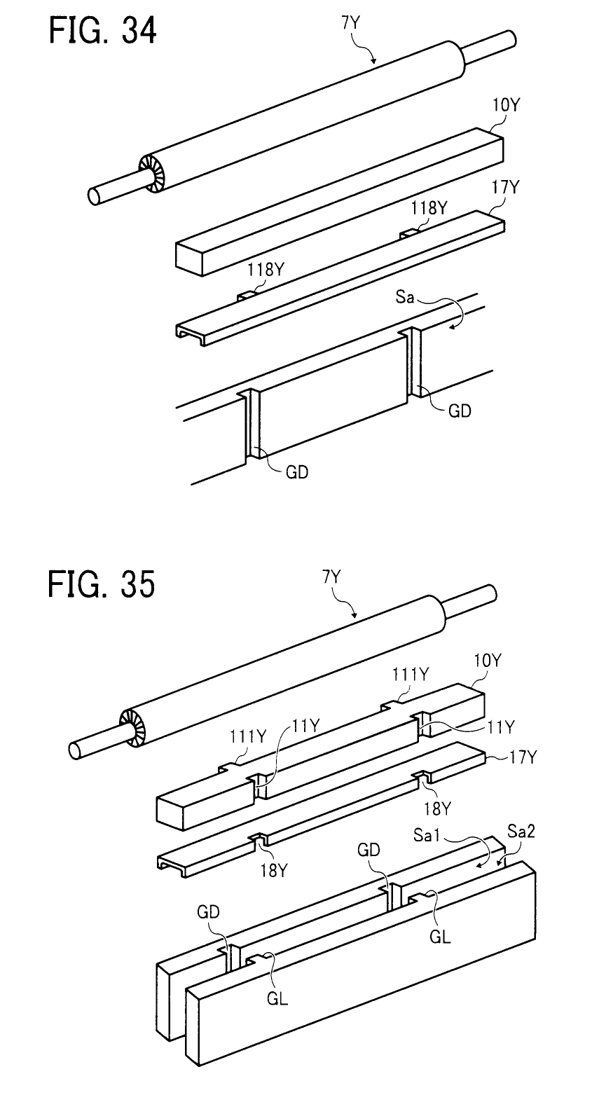

FIG. 34 is an assembly exploded perspective view showing an applying brush roller 7Y for Y, a solid lubricant 10Y, a holding member 17Y, and a casing in a printer according to a ninth modification. The ninth modification is different from the eighth modification in the following point. In the lubricant applying device, convex portions 118Y to be engaged with guide grooves GD are provided in a holding member 17Y, instead of a solid lubricant 10Y.

In the printer according to the eighth modification described above, the convex portion 118Y that is made of the lubricant of the solid lubricant 10Y exhibits the very low frictional resistance against the inside wall of the guide groove GD, and the solid lubricant 10Y can be smoothly slid in an extension direction of the guide groove GD. Thereby, a pressing trouble or sliding trouble of the solid lubricant 10Y against the brush may not be generated, the trouble being attributable to the convex portion 111Y being caught by the minute protrusions on the inside wall of the guide groove GD. However, when the solid lubricant is horizontally moved by the strong force, the convex portion 118Y may be strongly pressed against the inside wall of the guide groove GD. As a result, there is a problem in that the solid lubricant 10Y easily splits or chips. Meanwhile, in the printer according to the ninth modification, even though the solid lubricant 10Y is horizontally moved by the strong force, the solid lubricant 10Y is not pressed but the convex portion 118Y of the holding member 17Y made of a metal having high rigidity is pressed strongly against the inside wall of the guide groove GD. Therefore, splitting or chipping of the solid lubricant 10Y is not generated. Meanwhile, the pressing trouble or the sliding trouble of the solid lubricant 10Y against the brush is likely to occur that is attributable to the convex portion 118Y being caught by the minute protrusions on the inside wall of the guide groove GD.

The convex portions to be engaged with the guide grooves GD may be provided for both of the solid lubricant 10Y and the holding member 17Y. In this case, the widths of the convex portions provided for both sides are set to be equal. Thereby, as compared with the case where the convex portion is provided for only either one of the solid lubricant 10Y and the holding member 17Y, the pressing trouble or the sliding trouble of the solid lubricant 10Y against the brush may be suppressed as well as the splitting or the chipping of the solid lubricant 10Y is suppressed.

### Tenth Modification

FIG. 35 is an assembly exploded perspective view showing an applying brush roller 7Y for Y, a solid lubricant 10Y, a holding member 17Y, and a casing in a printer according to the tenth modification. In the lubricant applying device, the two guide rails GL are provided for an inside wall surface Sa2 that is one of two inside wall surfaces Sa1 and Sa2 of the casing which face each other with the solid lubricant 10Y interposed therebetween, among the plural inside wall surfaces of the casing of the lubricant applying device. On the other inside wall surface Sa1 of the two inside surface walls Sa1 and Sa2, the guide grooves GD are provided at the positions facing the two guide rails GL of the inside wall surface Sa2.

In the solid lubricant 10Y, the two convex portions 111Y to be individually engaged with the two guide grooves GD of the inside wall surface Sa1 of the casing are provided at both ends of the lubricant longitudinal direction. The two concave portions 11Y to be individually engaged with the two guide rails GL of the inside wall surface Sa2 of the casing are provided in both ends of the lubricant longitudinal direction. In the lubricant longitudinal direction, the convex portion 111Y provided on one side in the width direction and the concave portion 11Y provided on the other side correspond, in position, to each other, and the convex portion 111Y and the concave portion 11Y face each other, with the lubricant therebetween, in the width direction.

In the holding member 17Y, the concave portions 18Y to be engaged with the guide rails GL or to receive the guide rails GL therein in a non-contact manner are provided at the positions communicating with the two concave portions 11Y of the solid lubricant 10Y.

As such, in the printer according to the tenth modification, the convex portion 111Y is provided in one of the two sides arranged in the width direction of the solid lubricant 10Y, the concave portion 11Y is provided in the other side, and the convex portion 111Y and the concave portion 11Y are provided at the positions facing each other in the width direction. The reason why the above configuration is adopted is as follows. That is, of the convex portion 111Y and the concave portion 11Y shown in FIG. 35, only the convex portion 111Y is provided. As a result, the dimension of the solid lubricant 10Y in the widthwise direction varies depending on the position in the lubricant longitudinal direction. Specifically, in the lubricant longitudinal direction, in the place where the convex portion 111Y is not provided, the basic width dimension of the solid lubricant 10Y becomes the dimension in the width direction. Meanwhile, in the lubricant longitudinal direction, in the place where the convex portion 111Y is provided, the dimension of the solid lubricant 10Y in the width direction becomes a value of the sum of the basic width dimension and the protrusion amount of the convex portion 111Y from the side of the lubricant. That is, in the place where the convex portion 111Y is provided, the dimension of the width direction is large, as compared with the places where the convex portion 111Y is not provided. The dimension difference leads to the difference in lubricant scraping amount, and the difference in the lubricant scraping amounts results in the difference in lubricant applying amount. This is because the lubricant applying amount in the place corresponding to the convex portion 111Y of the solid lubricant 10Y in the rotation axis direction of the applying brush roller 7Y may be larger than the lubricant applying amount in the place not corresponding to the convex portion 111Y of the solid lubricant 10Y. As such, if the lubricant applying amount is different, irregularities of an image quality may be generated in a formed image.

Further, of the convex portion 111Y and the concave portion 11Y, only the concave portion 11Y shown in FIG. 35 is provided. In this case, the lubricant applying amount in the place corresponding to the convex portion 111Y of the solid lubricant 10Y in the rotation axis direction of the applying brush roller 7Y may be smaller than the lubricant applying amount in the place not corresponding to the convex portion 111Y. As such, even when the lubricant applying amount is different, irregularities of an image quality may be generated in a formed image.

Therefore, the convex portion 111Y is provided for any one side of two sides of the solid lubricant 10Y in the width direction, and the concave portion 11Y is provided for the other side at the position corresponding to the convex portion 111Y through the solid lubricant 10Y. In this configuration, as compared with the case where only the convex portion 111Y or the concave portion 11Y is provided, the irregularities of the image quality can be suppressed by decreasing the variation in the lubricant width along the lubricant longitudinal direction. In the printer according to the tenth modification, since the protruding amount of the convex portion 111Y and the dent amount of the concave portion 11Y are equally set, in the lubricant longitudinal direction, in the place where the convex portion 111Y and the concave portion 11Y are provided and the place where the convex portion 111Y and the concave portion 11Y are not provided, the lubricant width dimensions become equal to each other. Therefore, generation of the irregularities of the image quality can be avoided.

### Eleventh Modification

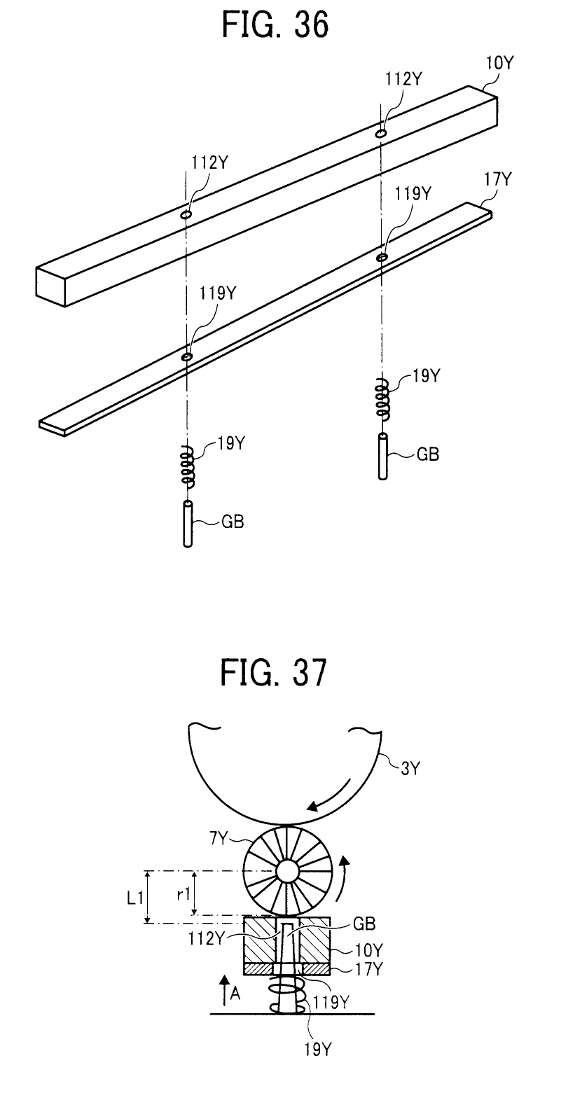

FIG. 36 is an assembly exploded perspective view showing a solid lubricant for Y and a holding member 17Y in a printer according to the eleventh modification. In the printer according to the eleventh modification, instead of the guide rail, a guide rod GB is provided as a guide portion to guide the movement of the solid lubricant 10Y. The guide rod GB is provided to protrude straightly to the solid lubricant on the bottom wall surface (Sb of FIG. 7) of the casing. In this example, the guide rod GB is formed integrally with the bottom wall of the casing. However, the guide rod may be separated from the casing. In this case, the guide rod GB can be formed of a material different from a material of the casing.

In the solid lubricant 10Y, two holes 112Y to receive the guide rod GB provided on the bottom wall of the casing are provided. The holes 112Y are provided to be individually positioned in both ends of the solid lubricant 10Y in the longitudinal direction. The two guide rods GB described above are provided on the bottom wall of the casing to be individually inserted into the two holes 112Y.

Also, in the holding member 17Y, through-holes 119Y to individually receive the two guide rods GB are provided in both ends of the longitudinal direction, respectively.

When the lubricant applying device is assembled, first, the coil spring 19Y is inserted into the guide rod GB. In addition, the solid lubricant 10Y is fixed to the holding member 17Y. At this time, in a state where the hole 112Y of the solid lubricant 10Y communicates with the through-hole 119Y of the holding member 17Y, the solid lubricant 10Y is fixed to the holding member 17Y. Next, the solid lubricant 10Y and the holding member 17Y are set in the casing, while the guide rods GB are inserted into the through-hole 119Y of the holding member 17Y and the hole 112Y of the solid lubricant 10Y. Then, the applying brush roller that is not shown in the drawings is set. Since the outer diameter of the coil spring 19Y is larger than the inner diameter of the through-hole 119Y of the holding member 17Y, the coil spring 19Y is not put into the through-hole 119Y. The coil spring 19Y that is inserted into the guide rod GB biases the holding member 17Y toward the applying brush roller (not shown in the drawings), while being interposed between the bottom wall surface of the casing and the bottom back surface of the holding member 17Y. By inserting the coil spring 19Y into the guide rod GB, generation of buckling of the coil spring 19Y can be avoided.

The holes 112Y that are provided in both ends of the solid lubricant 10Y, the through-holes 119Y that are provided in both ends of the holding member, and the two guide rods GB that are provided on the bottom surface of the casing are positioned in a region between one end and the other end of the brush roller portion of the applying brush roller (not shown in the drawings) in the rotation axis direction. Therefore, similar to the printers according to the embodiment and the modifications described above, as compared with the case where the guide means made of the guide rod GB is provided on the outer side of both ends of the brush roller portion, it may be possible to reduce the size of the lubricant applying device in the rotation axis direction of the roller.

FIG. 37 is a cross-sectional view showing an applying brush roller 7Y in a printer according to an eleventh modification and the peripheral configuration thereof. The through-hole that passes through the solid lubricant 10Y from the lower end to the upper end in the thickness direction is provided as the hole 112Y of the solid lubricant 10Y. The distance L1 from the rotation center of the applying brush roller 7Y to the leading edge of the guide rod GB protruded toward the bottom wall surface of the casing is set to a value larger than the radius r1 of the applying brush roller 7Y. For this reason, regardless of the thickness of the solid lubricant 10Y, the leading edge of the guide rod GB is positioned in the hole 112Y of the lower side of the upper end face of the solid lubricant 10Y.

The solid lubricant 10Y or the holding member 17Y engages the hole 112Y or the through-hole 119Y corresponding to the engagement portion with the guide rod GB. As such, in the engaged state, the guide rod GB moves in a direction toward the applying brush roller 7Y in the solid lubricant 10Y biased to the applying brush roller 7Y by the coil spring 19Y, that is, allows slide movement in a direction of an arrow A in the drawings. Meanwhile, the movement, in the same direction, of the solid lubricant 10Y, to which the force of the rotation direction and the force of the direction orthogonal to the rotation direction are applied, is regulated directly or through the holding member 17Y. In this way, the guide rod GB functions as a guide portion that guides movement of the solid lubricant 10Y toward the applying brush roller 7Y.

In this configuration, the guide rod GB guides the movement of the solid lubricant 10Y toward the applying brush roller 7Y while regulating the horizontal movement of the solid lubricant 10Y, and generation of the horizontal movement of the solid lubricant 10Y can be avoided. The diameter of the hole 112Y and the diameter of the through-hole 119Y are set to be equal to each other. The hole 112Y or the through-hole 119Y that is circular in sectional shape is provided. However, the hole 112Y or the through-hole 119Y may be elliptical or polygonal in shape.

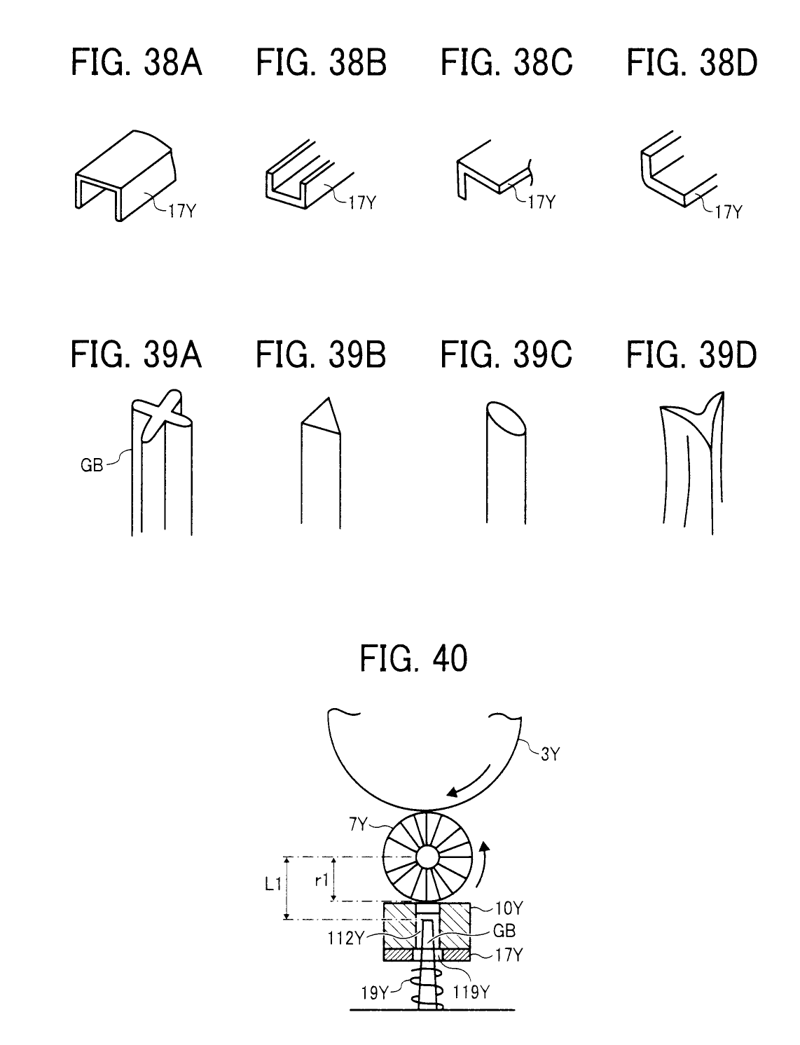

The example of the case where the flat holding member is used as the holding member 17Y is described. However, similar to the embodiment, the holding member made of C-shape steel shown in FIG. 38A may be used at the posture shown in the drawings and the solid lubricant may be fixed to the holding member. As shown in FIG. 38B, the holding member made of C-shape steel that is postured upside down as compared with FIG. 38A may be used as the holding member 17Y, and the solid lubricant may be fixed to the holding member. As shown in FIG. 38C, the holding member made of L-shape steel that is disposed at the posture shown in the drawings may be used as the holding member 17Y and the solid lubricant may be fixed to the holding member. As shown in FIG. 38D, the holding member made of L-shape steel that is postured upside down as compared with FIG. 38C may be used as the holding member 17Y, and the solid lubricant may be fixed to the holding member. This is the same in the embodiment and the first to tenth modifications.

### Twelfth Modification

The printer according to the twelfth modification is different from the printer according to the eleventh modification in the following point. That is, the diameter of the hole 112Y of the solid lubricant 10Y is different from the diameter of the through-hole 119Y of the holding member 17Y. The diameters of the hole 112Y and the diameter of the through-hole 119Y are appropriately selected according to a priority between competing factors, the damage of the lubricant and the pressing trouble.

Specifically, when the priority is set on preventing the damage of the solid lubricant 10Y, the diameter of the through-hole 119Y of the holding member 17Y is set to be smaller than the diameter of the hole 112Y of the solid lubricant 10Y, and only the through-hole 119Y of the holding member 17Y is engaged with the guide rod GB. The guide rod GB is received in the through-hole 119Y of the holding member 17Y, but the predetermined gap is formed between the inside wall of the solid lubricant 10Y and the guide rod GB. Thereby, the solid lubricant 10Y can be prevented from being damaged due to the guide rod GB being pressed against the solid lubricant 10Y.

Meanwhile, when the priority is set on preventing the pressing trouble of the solid lubricant 10Y, the diameter of the hole 112Y of the solid lubricant 10Y is set to be smaller than the diameter of the through-hole 119Y of the holding member 17Y, and only the hole 112Y of the solid lubricant 10Y is engaged with the guide rod GB. The guide rod GB is received in the through-hole 119Y of the holding member 17Y, but the predetermined gap is formed between the inside wall and the guide rod GB. Thereby, the pressing trouble of the solid lubricant 10Y against the applying brush roller can be prevented, the pressing trouble being attributable to hooking of minute protrusions on the surface of the holding member 17Y having the relatively large surface frictional resistance against the surface of the guide rod GB.

In the printer according to the eleventh modification, both the hole 112Y and the through-hole 119Y come into contact with the guide rod GB, the lubricant powder is attached to the guide rod GB, the surface frictional resistance of the guide rod GB is lowered, and the guide rod GB fits into the through-hole 119Y. Therefore, the guide rod GB can be avoided from being pressed against the solid lubricant 10Y with the excessive force. Thereby, the generation of the pressing trouble can be suppressed as well as the damage of the lubricant can be prevented.

### Thirteenth Modification

A printer according to a thirteenth modification is different from the printer according to the eleventh modification in the following point. That is, in the printer according to the eleventh modification, a guide rod that has a horizontal section shape of a complete round is adopted as the guide rod GB. Meanwhile, in the printer according to the thirteenth modification, a guide rod that has a horizontal section shape of a non-complete round may be used as the guide rod GB. For example, a guide rod having a flower shape shown in FIG. 39A, a guide rod having a triangular shape shown in FIG. 39B, a guide rod having an elliptical shape shown in FIG. 39C, and a guide rod having a star shape may be used. By adopting the non-complete round shape, reduced is the contact area of the inside wall of the hole 112Y of the solid lubricant 10Y and the inside wall of the through-hole 119Y of the holding member 17Y, and thus the frictional resistance thereof is reduced, and thereby the smooth slide movement can be realized.

### Fourteenth Modification

FIG. 40 is a cross-sectional view showing an applying brush roller 7Y in a printer according to a fourteenth modification and the peripheral configuration thereof. The printer according to the fourteenth modification is different from the printer according to the eleventh modification in the following point. That is, as the hole 112Y provided in the solid lubricant 10Y, instead of the through-hole, a bored hole that does not reach the upper end of the solid lubricant 10Y is provided. Similar to the distance in the printer according to the eleventh modification, the distance L1 from the rotation center of the applying brush roller 7Y to the leading edge of the guide rod GB is larger than the radius r1 of the applying brush roller 7Y. Therefore, regardless of the thickness of the solid lubricant 10Y, the leading edge of the guide rod GB is positioned in the hole 112Y of the solid lubricant 10Y.

When the solid lubricant 10Y is in an initial state, as shown in FIG. 44, the hole 112Y does not reach the upper end of the solid lubricant 10Y. Then, as the upper end of the solid lubricant 10Y is cut, the distance of the upper end of the hole 112Y and the upper end of the solid lubricant 10Y becomes shorter, and the hole 112Y becomes the through-hole, similar to the printer according to the eleventh modification. As such, if the hole becomes the through-hole, in the place where the hole 112Y is provided in the lubricant longitudinal direction, the applying amount of the lubricant powder may be decreased by the area of the hole, as compared with the other places. However, until the hole 112Y becomes the through-hole, that is, within the predetermined period from the initial state, the hole does not pass through, and the scraping surface of the solid lubricant 10Y becomes a surface having no hole. Therefore, regardless of the lubricant longitudinal direction, the applying amount can be equalized.

### Fifteenth Modification

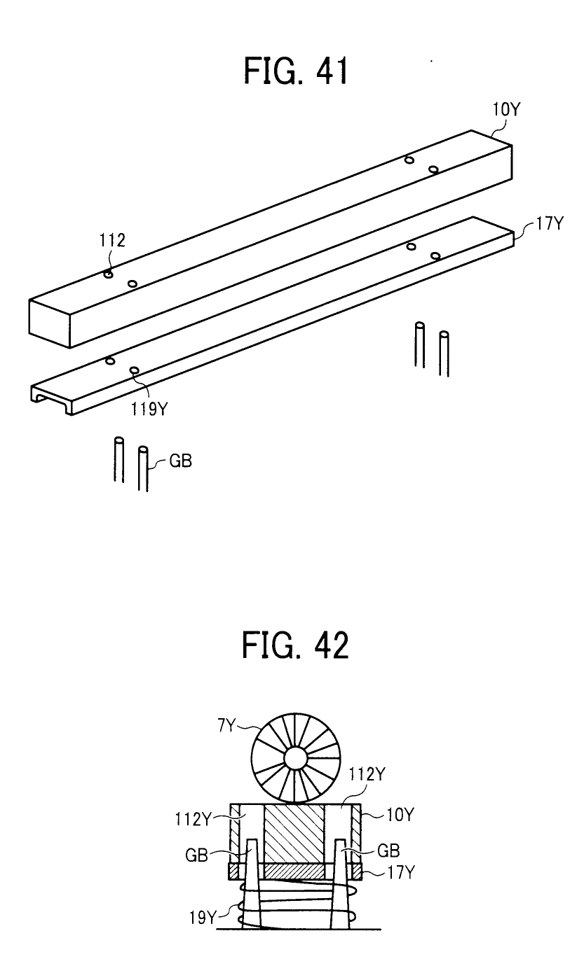

FIG. 41 is an assembly exploded perspective view showing a solid lubricant 10Y for Y and a holding member 17Y in a printer according to a fifteenth modification. The printer according to the fifteenth modification is different from the printer according to the eleventh modification shown in FIG. 36. That is, in the printer according to the fifteenth modification, in both ends of the solid lubricant 10Y or the holding member 17Y in a longitudinal direction, only one hole 112Y and one through-hole 119Y are provided. In the lubricant width direction (lateral direction), the positions where the hole 112Y and the through-hole 119Y are provided are the central position of the lubricant width direction. Meanwhile, in the printer according to the fifteenth modification, in both ends of the solid lubricant 10Y and the holding member 17Y in the longitudinal direction, two holes 112Y and two through-holes 119Y are provided. In the lubricant width direction, the positions where the hole 112Y and the through-hole 119Y are provided are the positions near both ends of the lubricant width direction. As such, in both ends in the longitudinal direction thereof, the holes 112Y and the through-holes 119Y are provided in both ends in the width direction thereof, and the four guide grooves to be engaged with the holes 112Y and the through-holes 119Y are provided. In this configuration, as compared with the printer according to the eleventh modification, fluctuation of the solid lubricant 10Y or the holding member 17Y can be suppressed better by performing a good regulation of the movement of the solid lubricant 10Y and the holding member 17Y rotating around the central portion in the longitudinal direction.

As a method of setting the coil spring 19Y to the two guide rods GB in both ends of the longitudinal direction thereof, as shown in FIG. 42, one coil spring 19Y may pass through the two guide rods GB and the individual coil springs 19Y may pass through the two guide rods GB.

### Sixteenth Modification

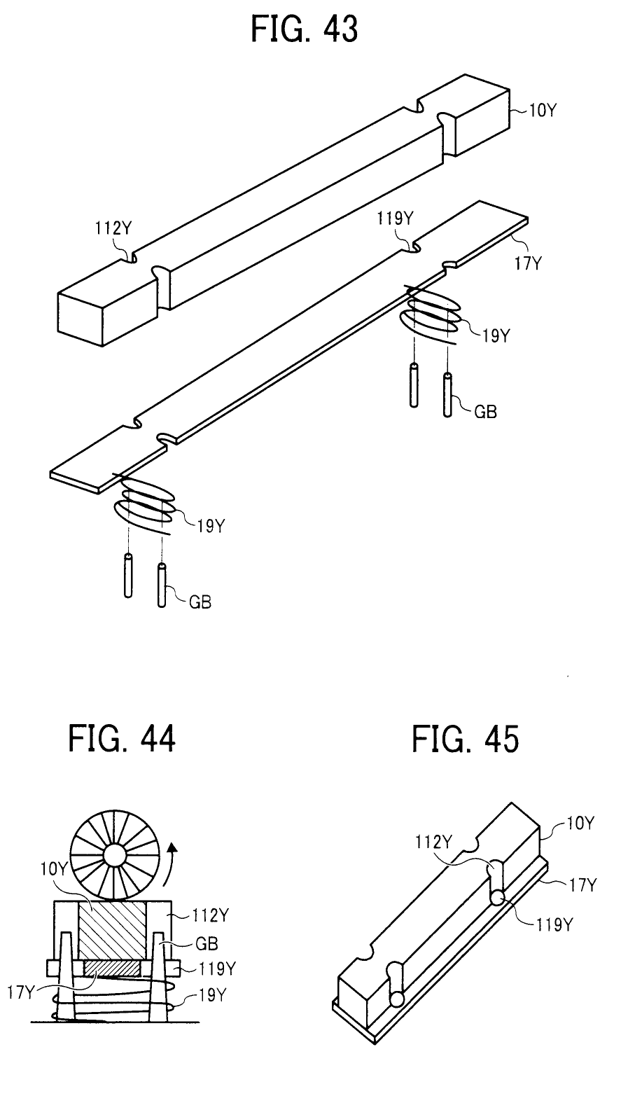

In the printer according to the fifteenth modification shown in FIG. 41, as described above, the two holes 112Y that are arranged in the width direction are provided in both ends of the solid lubricant in the longitudinal direction. However, the two holes 112Y are preferably disposed as far as possible, because, if the distance of the two holes 112Y is excessively short, a crack is easily formed between the holes. However, according to the width of the solid lubricant 10Y, the distance of the two holes 112Y may be increased to a desired value. In this case, if the width of the solid lubricant 10Y is increased, the same distance can be set to the predetermined value. However, in this case, the size of the device may be increased. Therefore, in the printer according to a sixteenth modification, as shown in FIG. 43 or 44, a circular hole where an entire inner portion is surrounded with the solid lubricant 10Y in a peripheral direction is not provided but provided is a semicircular hole where about a half portion of the peripheral direction is chipped. Even though the semicircular hole 112Y having the semicircular shape is provided, the holes 112Y are provided in both ends of the width direction thereof. Therefore, the movement of the solid lubricant 10Y in the width direction is regulated by the guide rod GB, similar to the circular hole.

In this configuration, as compared with the case where the hole 112Y having the circular hole is provided, the distance of the two holes 112Y that are arranged in the width direction can be increased and the shock resistance of the solid lubricant 10Y can be increased.

### Seventeenth Modification

FIG. 45 is a perspective view showing a solid lubricant 10Y for Y and a holding member 17Y in a printer according to a seventeenth modification. The printer according to the seventeenth modification is different from the printer according to the sixteenth modification in the following point. That is, in the printer according to the sixteenth modification, as shown in FIG. 43, the through-hole 119Y that is provided in the holding member 17Y has a semicircular shape. Meanwhile, in the printer according to the seventeenth modification, as shown in FIG. 45, the through-hole 119Y of the holding member 17Y has a circular shape.

### Eighteenth Modification

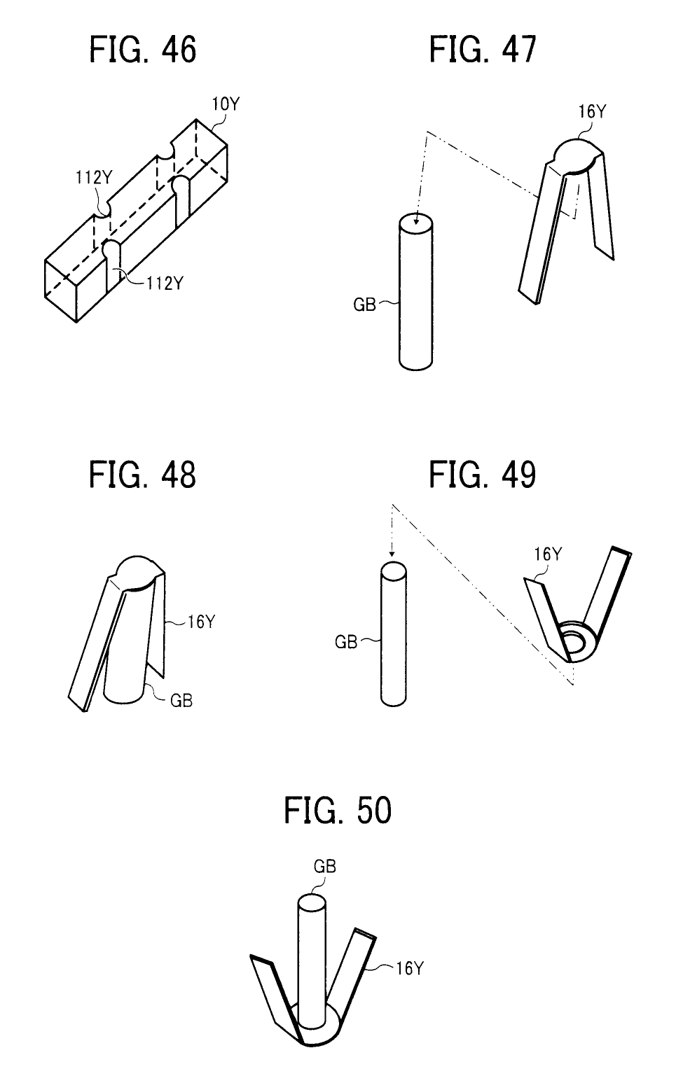

FIG. 46 is a perspective view showing a solid lubricant 10Y for Y and a holding member 17Y in a printer according to an eighteenth modification. The printer according to the seventeenth modification is different from the printer according to the sixteenth modification in the following point. That is, in the printer according to the sixteenth modification, the positions of the hole 112Y that is provided in one end of the solid lubricant in the width direction and the hole 112Y that is provided in the other end are shifted in the longitudinal direction. As such, if the positions are shifted, as compared with the printer according to the sixteenth modification, the distance between the two holes 112Y can be increased and the shock resistance of the solid lubricant 10Y can be increased. By shifting the positions of the hole 112Y of one end in the width direction and the hole 112Y of the other end in the longitudinal direction, the applying amount can be suppressed from being decreased due to the hole 112Y. Thereby, as compared with the printer according to the sixteenth modification, the fluctuation of the lubricant applying amount in the longitudinal direction due to providing of the solid lubricant 10Y in the hole 112Y can be alleviated.

### Nineteenth Modification

FIG. 47 is an assembly exploded perspective view showing a guide rod GB for Y and an electrode 16Y in a printer according to a nineteenth modification. FIG. 48 is a perspective view showing the guide rod GB and the electrode 16Y. The printer according to the nineteenth modification is different from the printer according to the eleventh modification shown in FIG. 36 in the following point. That is, the electrode 16Y that has two blades formed in a shape where the blades are expanded as the blades become distant from the applying brush roller is fixed to the guide rod GB. By the same principle as the electrode of the printer according to the sixth modification shown in FIGS. 26 and 27, the electrode 16Y is electrically connected to the holding member (not shown in the drawings) or is not electrically connected to the holding member according to the thickness of the solid lubricant (not shown in the drawings). Specifically, when the solid lubricant is in an initial state, the electrode 16Y brings the leading edges of the blades to be in contact with the holding member and enters a conductive state. If the solid lubricant is consumed and as a result, the thickness thereof is decreased, instead of the leading edges of the blades of the electrode 16Y, approximately central portions of the blades contact the holding member. In this state, since the electrode 16Y and the holding member are electrically connected to each other, the CPU determines that the solid lubricant is not completely consumed. Then, if the solid lubricant is almost completely consumed, the holding member is separated from the blades of the electrode 16Y, and the electrode 16Y and the holding member enter a non-conductive state. In this case, the CPU determines that the solid lubricant is completely consumed and notifies the user of that the solid lubricant is completely consumed. If the solid lubricant is replaced with a new solid lubricant by work of the user or the service man, the CPU detects electric connection of the electrode 16Y and the holding member and grasps that the new solid lubricant is correctly set.

### Twentieth Modification

FIG. 49 is an assembly exploded perspective view showing a guide rod GB for Y and an electrode 16Y in a printer according to a twentieth modification. FIG. 50 is a perspective view showing the guide rod GB and the electrode 16Y. The printer according to the twentieth modification is different from the printer according to the nineteenth modification in the following point. That is, the mounting posture of the electrode 16Y with respect to the guide rod GB is upside-down as compared with the nineteenth modification. The electrode 16Y that is mounted at the above posture is electrically connected to the holding member (not shown in the drawings) or is not electrically connected to the holding member, by the same principle as the electrode of the printer according to the seventh modification shown in FIGS. 34 to 36 described above. Specifically, if the solid lubricant is in an initial state, the leading edges of the blades of the electrode 16Y contact the inside wall of the hole of the solid lubricant. In this state, the electrode 16Y and the holding member enter a non-conductive state. If the solid lubricant is consumed and as a result, the thickness of the solid lubricant is almost minimized, the leading edges of the blades of the electrode 16Y and the inside wall of the through-hole of the holding member contact each other and enter a conductive state. Then, if the solid lubricant is further consumed, the leading edges of the blades of the electrodes 16Y are separated from the inside wall of the through-hole of the holding member, and instantly move to the outside of the through-hole by the restoring force. Thereby, the electrode 16Y and the holding member enter a non-conductive state again.

If the state changes from an initial state where the electrode 16Y does not contact the holding member to a state where the electrode 16Y is electrically connected to the holding member, the CPU notifies the user of that the solid lubricant is almost completely consumed. Then, if the electrode 16Y electrically connected to the holding member enters a conductive state again, the CPU notifies the user of that the solid lubricant 10Y is completely consumed.

Until now, the example of the printer that forms the color image by the tandem system is described. However, the present invention can be applied to an image forming apparatus that forms a monochromatic image.

In the printers according to the embodiment and the various modifications, the applying brush roller 7Y that includes the rotation shaft member 8Y to be rotatably supported and the brush roller portion 9Y with the plural bristles standing upright on the peripheral surface thereof is used as the applying member. The guide rail GL, the guide groove GD or the guide rod that functions as the guide portion is provided in a region, between the one end and the other end of the brush roller portion 9Y in the rotation axis direction, among the entire region inside the casing of the device body. In this configuration, the size of the lubricant applying device can be decreased, as compared with the case where the guide rail GL, the guide groove GD or the guide rod is provided outside the above region.

In the printers according to the embodiment or the first to tenth modifications, the guide rail GL that extends along the inside wall surface Sa of the casing and the guide groove GD that extends along the inside wall surface Sa are provided as the guide portion. As the engagement portion, the concave portion to be engaged with the guide rail GL and the convex portion to be engaged with the guide groove GD are provided in the solid lubricant 10Y and the holding member 17Y. In this configuration, by moving the solid lubricant 10Y to be engaged with the guide rail GL or the guide groove GD along the rail or the groove, the horizontal movement of the solid lubricant can be avoided while the movement of the solid lubricant 10Y toward the applying brush roller 7Y is guided. Alternatively, by moving the holding member 17Y to be engaged with the guide rail GL or the guide groove GD along the rail or the groove, the horizontal movement of the solid lubricant can be avoided while the movement of the solid lubricant 10Y toward the applying brush roller 7Y is indirectly guided.

In the printer according to the second modification, the concave portions to be engaged with the guide rail GL are provided in both the solid lubricant 10Y and the holding member 17Y (11Y and 18Y). In this configurations, because of the above-described reason, as compared with the case where only one of the solid lubricant 10Y and the holding member 17Y is engaged with the concave portion, the pressing trouble or sliding trouble of the solid lubricant 10Y against the brush may be suppressed as well as the splitting and the chipping of the solid lubricant 10Y may be suppressed. Even though the convex portions to be engaged with the guide groove GD are provided in both the solid lubricant 10Y and the holding member 17Y, the same effect can be obtained.

In the printer according to the second modification, in the case where the width of the concave portion 18Y of the holding member 17Y is set to be smaller than the width of the concave portion 11Y of the solid lubricant 10Y, only the concave portion 18Y of the holding member 17Y is engaged with the guide rail GL, and the guide rail GL is received in the concave portion 11Y of the solid lubricant in a non-contact manner, so that the solid lubricant can be prevented from being damaged due to pressing of the guide rail GL against the solid lubricant 10Y.

In the printer according to the second modification, in the case where the width of the concave portion 18Y of the holding member 17Y is set to be larger than the width of the concave portion 11Y of the solid lubricant 10Y, only the concave portion 11Y of the solid lubricant 10Y is engaged with the guide rail GL, and the guide rail GL is received in the concave portion 18Y of the holding member 17Y in a non-contact manner, so that the trouble of the solid lubricant 10Y against the applying brush roller may not be generated, the trouble being attributable to hooking of the minute protrusions on the surface of the holding member 17Y having the relatively large surface frictional resistance against the surface of the guide rail GL.

In the printer according to the tenth modification, the two guide rails GL are provided on an inside wall surface Sa2 that is one of two inside wall surfaces Sa1 and Sa2 of the casing which face each other with the solid lubricant 10Y interposed therebetween, among the plural inside wall surfaces in the casing of the lubricant applying device. On the other inside wall surface Sa1 of the two inside surface walls Sa1 and Sa2, the guide grooves GD are provided at the positions facing the two guide rails GL of the inside wall surface Sa2. In the solid lubricant 10Y, the two convex portions 111Y to be individually engaged with the two guide grooves GD of the inside wall surface Sa1 of the casing are provided at both ends of the lubricant longitudinal direction. The two concave portions 11Y to be individually engaged with the two guide rails GL of the inside wall surface Sa2 of the casing are provided in both ends of the lubricant longitudinal direction. In this configuration, as described above, the difference of the lubricant scraping amounts in the formation places of the concave portion 11Y and the convex portion 111Y in the lubricant longitudinal direction and the other places is decreased and generation of the lubricant applying irregularities in the rotation axis direction of the applying brush roller 7Y can be suppressed.

In the eleventh to twentieth modifications, the guide rod GB that protrudes to the inside wall of the casing is provided as the guide portion. As the engagement portion, the hole 112Y that receives the guide rod GB is provided in the solid lubricant 10Y. In this configuration, the horizontal movement of the solid lubricant 10Y can be avoided while the movement of the solid lubricant 10Y toward the applying brush roller 7Y is guided by the guide rod GB.

In the printers according to the eleventh to the twentieth modifications, the through-hole 119Y that receives the guide rod GB is provided in the holding member 17Y in a state where the solid lubricant 10Y communicates with the hole 112Y of the solid lubricant 10Y. Therefore, the guide rod GB that communicates with the through-hole 119Y of the holding member 17Y can be inserted into the hole 112Y of the solid lubricant 10Y that is held on the holding member 17Y.

In the printer according to the twelfth modification, in the case where the diameter of the through-hole 119Y of the holding member 17Y is set to be smaller than the diameter of the hole 112Y of the solid lubricant 10Y, only the through-hole 119Y of the holding member 17Y of the through-hole 119Y and the hole 112Y is engaged with the guide rail GB, and the guide rail GB is received in the hole 112Y of the solid lubricant 10Y in a non-contact manner, so that the solid lubricant 10Y can be prevented from being damaged due to pressing of the guide rail GB against the solid lubricant 10Y.

In the printer according to the second modification, in the case where the diameter of the through-hole 119Y of the holding member 17Y is set to be larger than the diameter of the hole 112Y of the solid lubricant 10Y, only the hole 112Y of the solid lubricant 10Y of the through-hole 119Y and the hole 112Y is engaged with the guide rail GB, and the guide rail GB is received in the through-hole 119Y of the holding member 17Y in a non-contact manner, so that the pressing trouble of the solid lubricant 10Y against the applying brush roller may not be generated, the trouble being attributable to hooking of minute protrusions on the surface of the holding member 17Y having the relatively large surface frictional resistance against the surface of the guide rail GB.

In the printer according to the thirteenth modification, the guide rod having a horizontal section shape of a non-complete round may be used as the guide rod GB. Therefore, the contact area of the inside wall of the hole 112Y of the solid lubricant 10Y and the inside wall of the through-hole 119Y of the holding member 17Y can be reduced, and thus the frictional resistance thereof can be reduced, and thereby the smooth slide movement can be realized.

In the printers according to the fifth to seventh modifications and the nineteenth and twentieth modifications, when the holding member 17Y biased to the applying brush roller 7Y together with the solid lubricant 10Y by the coil spring 19Y corresponding to the biasing portion approaches the predetermined position with respect to the applying brush roller 7Y according to the consumption of the solid lubricant 10Y, the electrode 16Y that contacts or is separated from the conductive portion (inside wall of the concave portion or inside wall of the through-hole) provided in the holding member 17Y is fixed to the guide rail GL or the guide rod GB corresponding to the guide portion, and the CPU that is the life duration notifying unit to notify that the solid lubricant 10Y is completely consumed on the basis of ON/OFF of the electric connection between the electrode 16Y and the conductive portion is provided. In this configuration, when the solid lubricant 10Y is completely consumed, this can be automatically notified to the user. The conductive portion that is electrically connected to the electrode 16Y may be provided in the solid lubricant 10Y, instead of the holding member 17Y.

### Second Embodiment

Next, the characteristic configuration of the printer according to the second embodiment will be described.

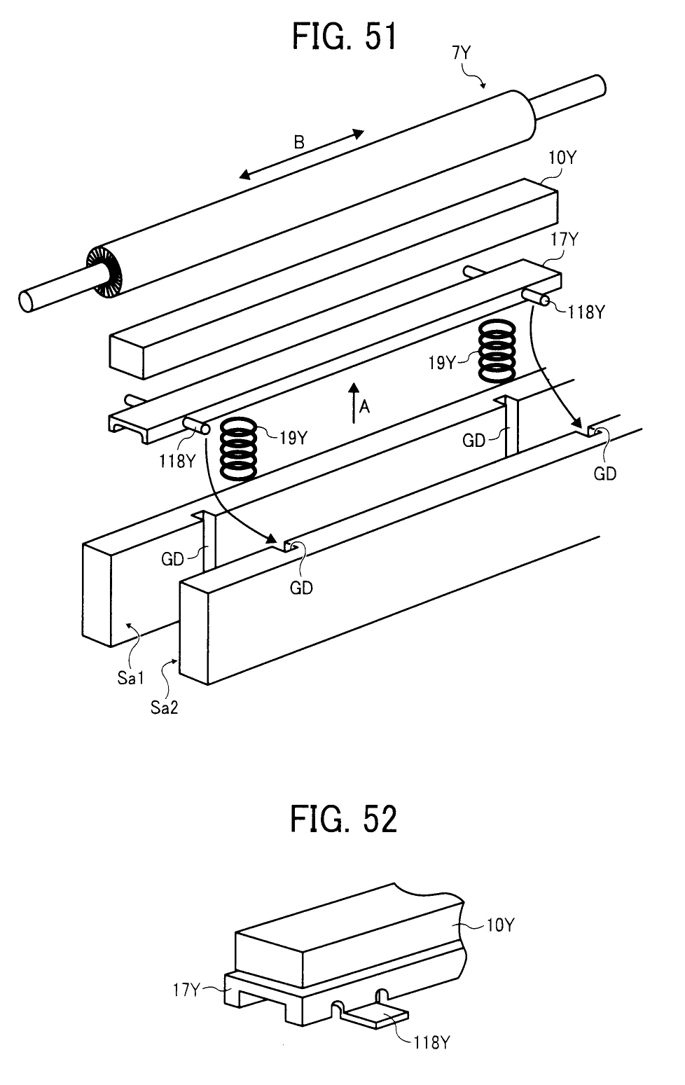

FIG. 51 is an assembly exploded perspective view partially showing the inner configuration of a solid lubricant applying device 6Y for Y in a printer according to the embodiment. In FIG. 51, the solid lubricant 10Y is fixed to the surface of the holding member 17Y made of C-shape steel, by both-sided tape. The coil spring 19Y presses a back surface of a lubricant fixing surface in the holding member 17Y. The coil spring 19Y biases the solid lubricant 10Y in a direction of an arrow A in the drawings toward the applying brush roller 7Y through the holding member 17Y. The direction of the arrow A is a direction along an orthogonal virtual surface orthogonal to a rotation axis direction of the applying brush roller 7Y and a central direction of the applying brush roller 7Y.

The solid lubricant 10Y is formed in an elongated block shape to contact almost an entire region of the brush roller portion of the applying brush roller 7Y in a longitudinal direction.

In the holding member 17Y, the convex portions 118Y that have the rod shape are formed on the two sides arranged in the lateral direction. The convex portions are formed in both ends of one side in the longitudinal direction.

The two guide grooves GD that receive the convex portions 118Y having the rod shape in the holding member 17Y are formed in each of the two inside wall surfaces Sa1 and Sa2 facing the two sides of the solid lubricant 10Y, among the plural inside walls in the casing of the lubricant applying device. These guide grooves GD extend in the direction of the arrow A in the drawings that is the biasing direction of the coil spring 19Y. The holding member 17Y where the solid lubricant 10Y is fixed to the surface is set to the inner portion of the lubricant applying device at the posture where the four convex portions 118Y are engaged with the four guide grooves GD.

The guide grooves GD allow movement, in a direction toward the applying brush roller 7Y, of the holding member 17Y biased to the applying brush roller 7Y by the coil spring 19Y, that is, slide movement in the direction of the arrow A in the drawings. Meanwhile, the force of the rotation direction and the force of a rotation axis direction (direction of an arrow B in the drawings) orthogonal to the rotation direction may be applied to a frictional surface of the rotating applying brush roller 7Y, and the movement of the holding member 17Y to be horizontally moved in the rotation axis direction together with the solid lubricant 10Y is regulated. Thereby, the guide groove GD functions as a guide portion that guides movement of the solid lubricant 10Y and the holding member 17Y toward the applying brush roller 7Y.

In this configuration, the guide rail GD can guide the movement of the solid lubricant 10Y toward the applying brush roller 7Y while regulating the horizontal movement corresponding to the movement of the solid lubricant 10Y and the holding member 17Y in the direction of the arrow B in the drawings, and thus avoid generation of the horizontal movement of the solid lubricant 10Y.

The lubricant applying device 6Y for Y is described in detail. However, even in the lubricant applying devices for the other colors, the horizontal movement of the solid lubricant can be avoided by the same configuration. As the rotation direction of the applying brush roller 7Y, there may be adopted a direction that becomes a counter direction in the contact portion with the photosensitive element 3Y or a direction that becomes a forward direction. Described is the example of the case where the convex portion having the rod shape is provided as the convex portion 118Y of the holding member 17Y. However, the shape of the convex portion 118Y is not limited to the rod shape. For example, as shown in FIG. 52, a convex portion 118Y that has a flat shape may be provided.

Next, printers according to individual examples where the characteristic configuration is added to the printer according to the second embodiment will be described. The configurations of the printer according to the examples are the same as that of the embodiment, as long as the specific description is not given.

### First Example

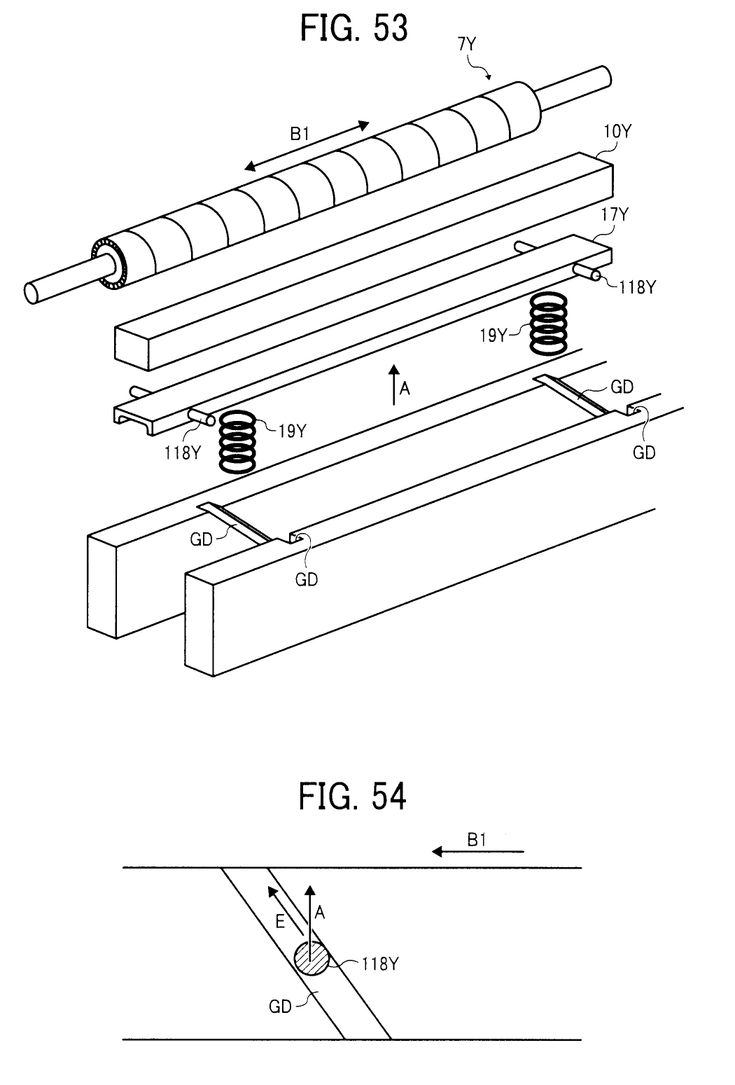

FIG. 53 is an assembly exploded perspective view partially showing the inner configuration of a lubricant applying device 6Y for Y in a printer according to the first example. The printer is different from the printer according to the embodiment in that a guide groove is provided as the guide groove GD in which the guide groove is inclined in a direction of an arrow A in the drawings, which is the biasing direction of the coil spring 19Y.

FIG. 54 is a schematic view showing movement of the holding member 17Y in the guide groove GD of the convex portion 118Y. If the holding member (not shown in the drawings) is biased in the direction of the arrow A in the drawings by the coil spring, the convex portion 118Y that is provided in the holding member moves in the direction of the arrow A in the drawings. In this case, the convex portion 118Y contacts one of the two sidewalls of the guide groove GD. Since the sidewall is inclined in the direction (same direction as the brush rotation axis direction) orthogonal to the direction of the arrow A, if the convex portion 11 contacts the sidewall, the force of the direction of the arrow A of the convex portion 118Y is converted into the force of the direction of the arrow E in the drawings along the sidewall. The direction of the arrow E is the same as the total force of the force of the direction of the arrow A and the force of the direction of the arrow B corresponding to the brush rotation axis direction. For this reason, the convex portion 118Y contacts the side of the guide groove GD having the inclined portion and moves in both the direction of the arrow A and the direction of the arrow B1. As such, in the printer according to the first example, provided in the guide groove GD is the inclined portion that makes the force of the biasing direction (direction of the arrow A) applied from the coil spring 19Y to the convex portion 118Y of the holding member 17Y converted into the force of both the biasing direction and the brush rotation axis direction (direction of the arrow B1).

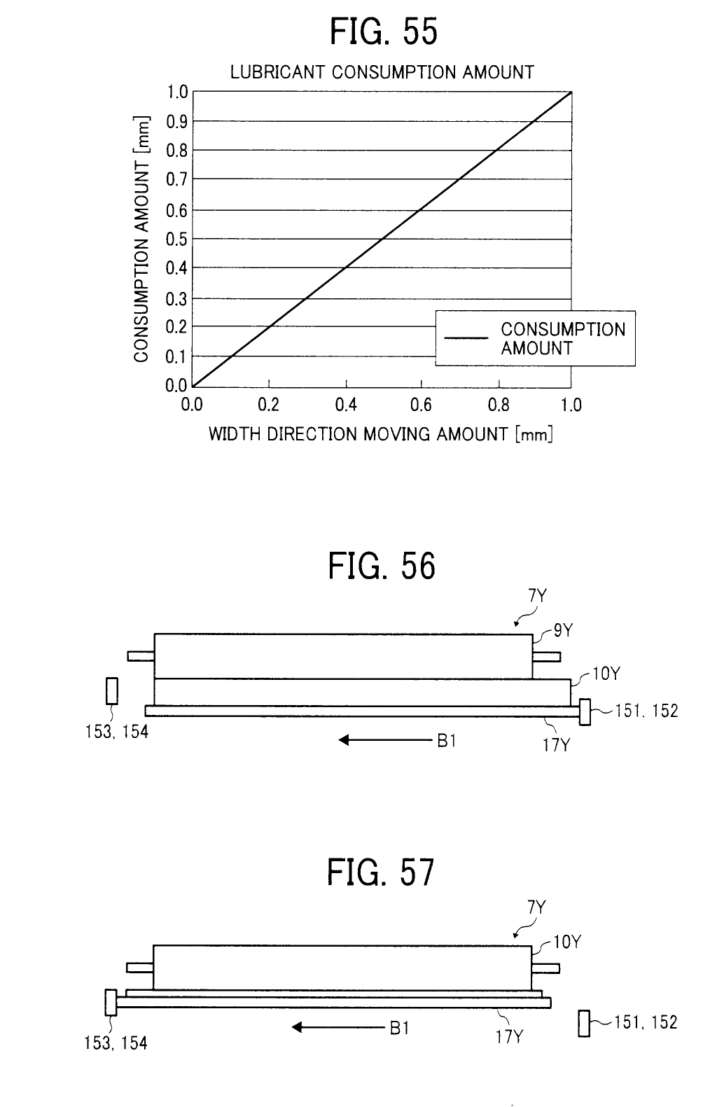

In FIG. 54, the stop position of the convex portion 118Y in the longitudinal direction of the guide groove GD is determined according to the thickness of the solid lubricant not shown in the drawings. When the solid lubricant is relatively thick, the convex portion 118Y is stopped at the position relatively apart from the applying brush roller (not shown in the drawings), in the guide groove GD. This position is near the lower end in the drawing. If the thickness of the solid lubricant decreases, the convex portion 118Y comes close to the applying brush roller. The convex portion 118Y moves little by little in the guide groove GD in the direction of the arrow E. Thereby, the solid lubricant or the holding member (not shown in the drawings) moves in the direction of the arrow E. In this case, the holding member or the solid lubricant moves little by little in the direction of the arrow B1, when the thickness of the solid lubricant decreases. A correlative relationship is realized between the moving amount in the direction of the arrow B1 and the consumption amount (thickness decrease amount) of the solid lubricant. For example, when the guide groove GD is inclined by 45° in the direction of the arrow A, as shown in FIG. 55, the consumption amount of the solid lubricant and the moving amount of the solid lubricant or the holding member in the direction of the arrow B1 are equalized.

FIG. 56 is a side view showing a solid lubricant 10Y in an initial state and the peripheral configuration thereof. As shown in FIG. 56, as the solid lubricant 10Y or the holding member 17Y, used is a solid lubricant or a holding member where the length in the longitudinal direction is larger than the length of the brush roller portion 9Y of the applying brush roller 7Y in a rotation axis direction. As shown in FIG. 56, the solid lubricant 10Y in the initial state is set to the device at the posture where the end of the side opposite to the direction of the arrow B1 is positioned on the outer side of the end of the brush roller portion 9Y. In this state, a new product detecting first electrode 151 and a new product detecting second electrode 152 that are fixed to the device make contact with the metallic holding member 17Y and are electrically connected to the metallic holding member 17Y. A central processing unit (CPU) that is not shown in the drawings detects the electric connection and grasps that the new solid lubricant 10Y is set. In FIG. 56, only one new product detecting electrode is shown. This is because the new product detecting first electrode 151 and the new product detecting second electrode 152 are arranged with the predetermined gap in a direction orthogonal to the plane of paper.

If the new solid lubricant 10Y shown in FIG. 56 is scraped by the applying brush roller 7Y and the thickness thereof is gradually decreased, the solid lubricant 10Y and the holding member 17Y move little by little in the direction of the arrow B1 in the drawings. In this case, the holding member 17Y is separated from the new product detecting first electrode 151 and the new product detecting second electrode 152 shown in the drawings.

FIG. 57 is a side view showing a completely consumed solid lubricant 10Y and the peripheral configuration thereof. As shown in FIG. 57, when the solid lubricant 10Y is completely consumed and as a result, the thickness thereof is minimized, the end of the holding member 17Y in a direction of an arrow B1 makes contact with a life duration detecting first electrode 153 and a life duration detecting second electrode 154. Thereby, the life duration detecting first electrode 153 and the life duration detecting second electrode 154 are electrically connected to each other through the holding member 17Y. The CPU that is not shown in the drawings detects the electric connection and grasps that the solid lubricant 10Y is completely consumed. The CPU displays a message to notify the user of that the solid lubricant is completely consumed on a display.

In the above configuration, the new product detecting first electrode 151, the new product detecting second electrode 152, the life duration detecting first electrode 153, the life duration detecting second electrode 154, and the CPU function as a moving amount detecting unit to detect the moving amounts of the solid lubricant 10Y and the holding member 17Y in the direction of the arrow B1. The CPU functions as a consumption amount grasping unit that grasps the consumption amount of the solid lubricant 10Y, on the basis of the detecting result of the moving amount.

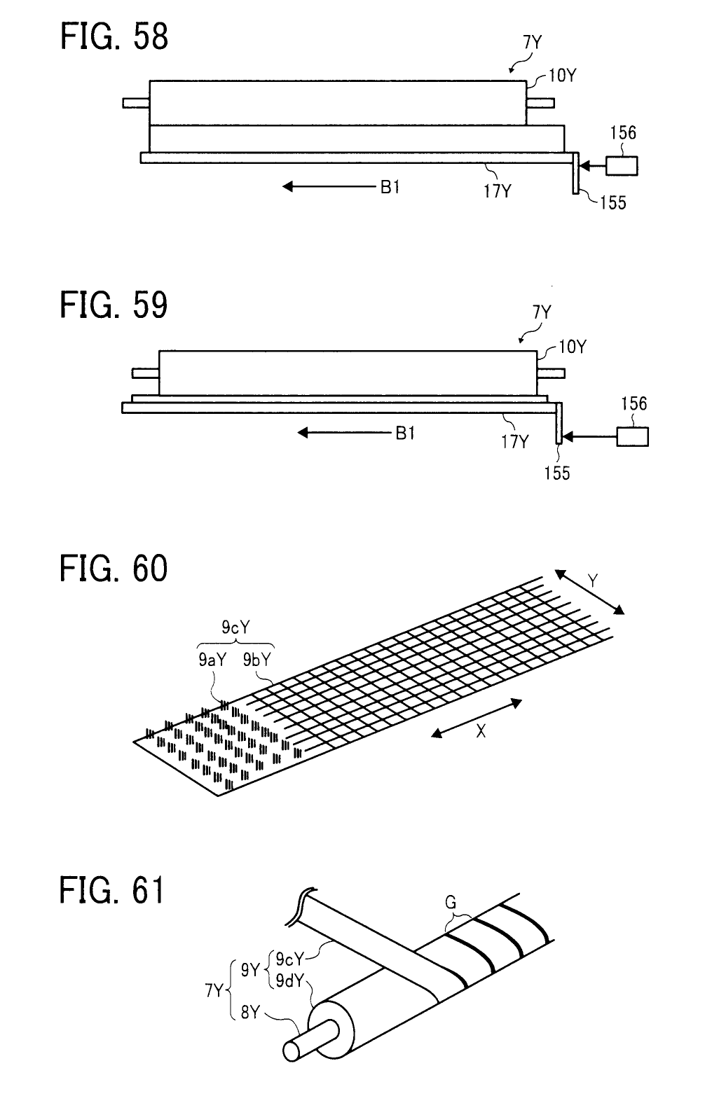

FIG. 58 is a side view showing a solid lubricant 10Y in an initial state in a printer according to a modification of the first example and the peripheral configuration thereof. FIG. 59 is a side view showing the completely consumed solid lubricant 10Y in the printer according to the modification and the peripheral configuration thereof. In the printer according to the modification, instead of the new product detecting electrodes and the life duration detecting electrodes, a distance sensor 156 is provided. In a place facing the distance sensor 156 in the holding member 17Y, an inspected member 155 is fixed. The distance sensor 156 detects the distance between the inspected member 155 and the distance sensor by reflection of ultrasonic waves and infrared rays. The distance sensor 156 grasps the moving amount of the holding member 17Y in the direction of the arrow B1, on the basis of the change amount of the distance. Different from the printer according to the first example where only the moving amount from the new product state to the completely consumed state can be detected, the minute movement of the holding member 17Y can be detected. For this reason, the user can grasp the remaining solid lubricant 10Y and can accurately grasp the preparation timing for replacing the solid lubricant 10Y.

In the printer according to the first example, the force of the rotation axis direction is applied from the applying brush roller 7Y to the solid lubricant 10Y on the frictional surface, and the solid lubricant 10Y is pressed using the force. For this reason, the applying brush roller 7Y is studied to certainly apply the force from one end side to the other end side in the rotation axis direction, without depending on the characteristic of the brush.

FIG. 60 is a perspective view showing a bristled brush sheet 9cY that is used in a brush roller portion of an applying brush roller 7Y. The bristled brush sheet 9cY is obtained by bristling plural bristles 9aY with respect to rectangular woven fabric 9bY, using the known technology.

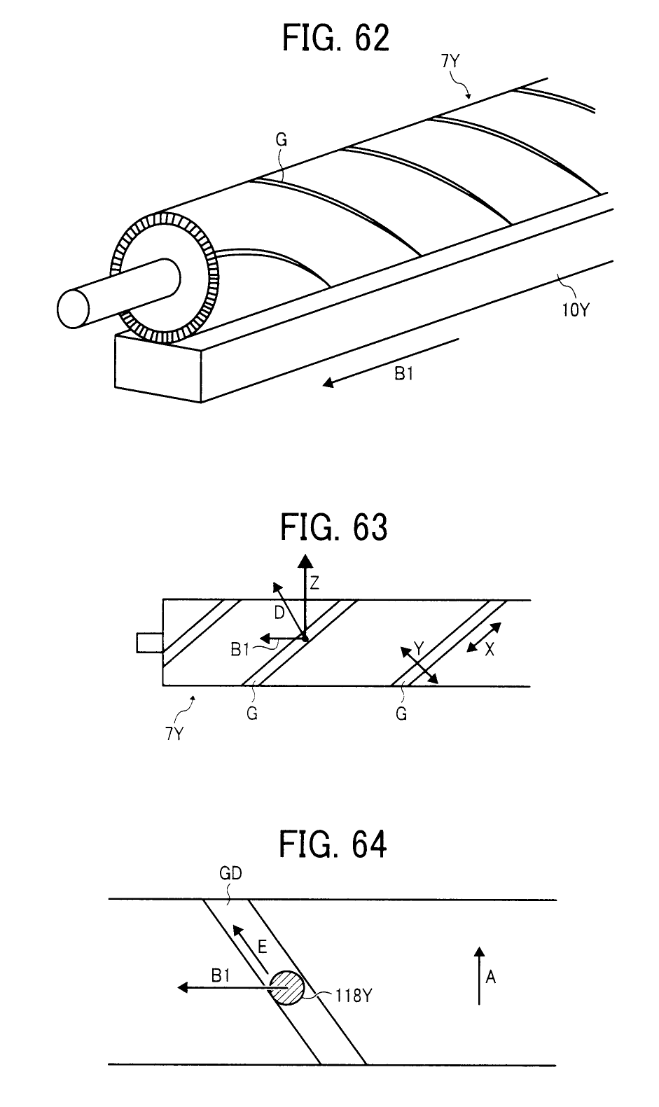

FIG. 61 is a perspective view showing one end of an applying brush roller 7Y in a rotation axis direction and a solid lubricant 10Y. The applying brush roller 7Y has a metallic rotation shaft member 8Y and a brush roller portion 9Y that rotates around the rotation shaft member 8Y. The brush roller portion 9Y includes a roller portion 9dY and a bristled brush sheet 9cY that is wound in a spiral shape around the peripheral surface thereof. As shown in FIG. 61, a slight gap G is provided between spirally wound sheets to make the bristled brush sheet 9cY having a rectangular shape wind along the peripheral surface of the roller portion 9dY having a roller shape. By providing the gap G, as shown by the arrow B1 in FIG. 62, the applying brush roller 7Y applies the force, which is applied from one end side to the other end side of the rotation axis direction, to the solid lubricant 10Y.

FIG. 63 is a schematic view showing a relationship between an applying brush roller 7Y and various directions. In FIG. 63, a direction of an arrow X is the same as the direction of the arrow X in FIG. 60 and shows a longitudinal direction in the bristled brush sheet 9cY. A direction of an arrow Y in FIG. 63 is the same in the direction of the arrow Y in FIG. 60 and shows a lateral direction in the bristled brush sheet 9cY. In FIG. 63, a direction of an arrow Z shows a direction where the applying brush roller 7Y moves on the frictional surface of the applying brush roller 7Y and the solid lubricant. In the case of the common applying brush roller, the force of the direction of the arrow Z is applied from the applying brush roller to the solid lubricant. As shown in FIG. 61, in the applying brush roller 7Y where the bristled brush sheet 9cY is wounded in a spiral shape, as shown by an arrow D in FIG. 63, the force of a direction almost orthogonal to an extension direction of the spiral gap G is applied from the applying brush roller 7Y to the solid lubricant. The direction of the arrow D is a direction where the total force of the force of the direction of the arrow Z and the force of the direction of the arrow C orthogonal to the Z direction is applied. For this reason, the force of the direction of the arrow Z and the force of the direction of the arrow B1 are applied to the solid lubricant on the frictional surface of the applying brush roller 7Y. As shown in FIG. 62, the solid lubricant 10Y moves in the direction of the arrow B1 along the brush rotation axis direction.

The state shown in FIG. 54 shows the movement of the convex portion 118Y of the holding member, when the applying brush roller (not shown in the drawings) does not rotate. When the applying brush roller does not rotate, the convex portion 118Y to be moved in the direction of the arrow A contacts the sidewall of the guide groove and the force of the direction of the arrow A is applied in the direction of the arrow E. At this time, the movement of the solid lubricant in the direction of the arrow E is suppressed by the friction of the sidewall and the convex portion 118Y.

If the applying brush roller rotates, as shown in FIG. 62, the force of the direction of the arrow B1 is applied from the applying brush roller 7Y to the solid lubricant 10Y. Likewise, the force of the direction of the arrow B1 is applied to the holding member 17Y. In this case, as shown in FIG. 64, the convex portion 118Y that contacts one sidewall of the guide groove GD in a stop state is separated from the sidewall. Immediately before the convex portion is separated from the sidewall, urged is the movement in the direction of the arrow E that is suppressed by the friction with the sidewall and the convex portion 118Y smoothly moves in the direction of the arrow E. The convex portion 118Y contacts the sidewall opposite to the sidewall previously being in contact and is pressed in the direction of the arrow E. At this time, the solid lubricant 10Y is pressed against the applying brush roller in the direction of the arrow E, by the force of the direction of the arrow A based on biasing of the coil spring 19Y and the force of the direction of the arrow B1 based on the brush. Thereby, generation of the pressing trouble of the solid lubricant 10Y can be suppressed.

### Second Example

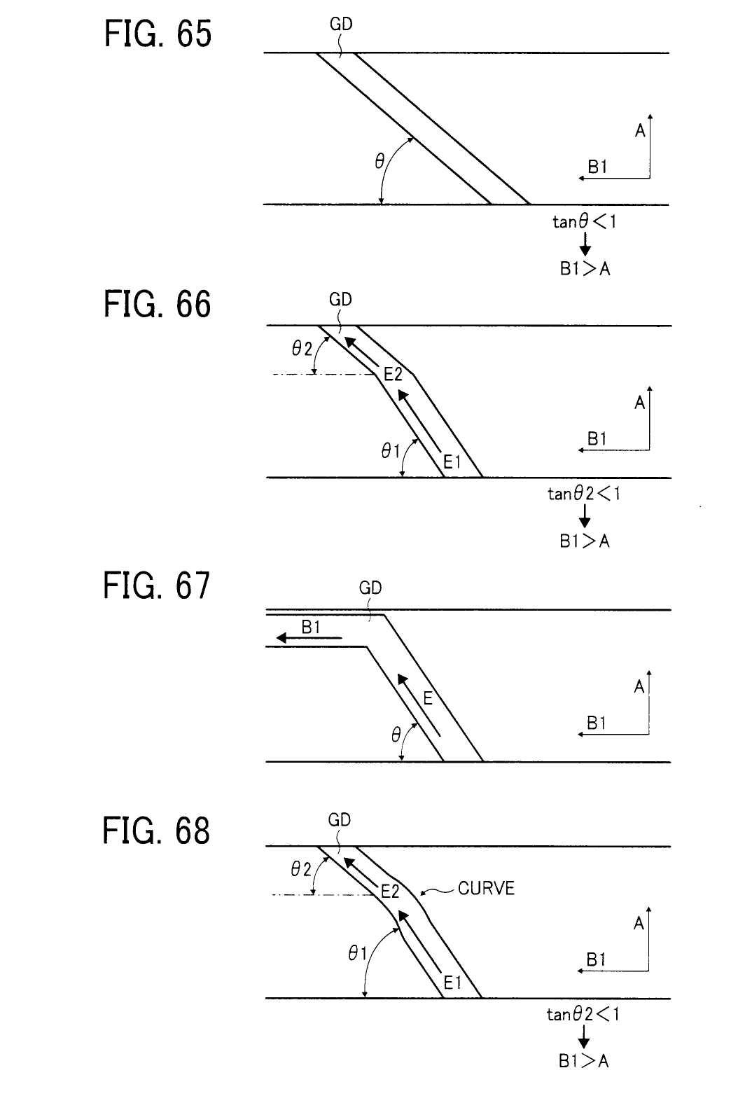

FIG. 65 is a schematic view showing an inclination angle θ of a guide groove in a lubricant applying device of a printer according to the second example. The inclination angle θ of the guide groove shows the inclination of a groove extension direction with respect to the direction of the arrow B1 that is the brush rotation axis direction. In the printer according to the second modification, the inclination angle θ is set to a value satisfying the condition of “tan θ<1.” In this case, tan θ has the same value as “a side in a height direction/a bottom side” in a triangle that has the bottom side extending in the direction of the arrow B1 and the side in the height direction extending in the direction of the arrow A. Therefore, satisfying the condition of “tan θ<1” means that the bottom side is greater than the side in the height direction. That the bottom side is greater than the side in the height direction means that the moving amount of the solid lubricant in the direction of the arrow B1 when the thickness of the solid lubricant decreases by 1 mm becomes larger than the moving amount in the direction of the arrow A.

That is, in the printer according to the second example, the inclination angle θ is set to a value that makes the moving amount of the solid lubricant in the direction of the arrow B1 larger than the moving amount of the solid lubricant in the biasing direction (direction of the arrow A). In this configuration, the moving amount of the solid lubricant in the direction of the arrow B1 becomes larger than the decrease amount of the thickness of the solid lubricant. By detecting the moving amount, the thickness decrease is amplified and detected. Therefore, the thickness decrease can be detected with high sensitivity.

### Third Example

FIG. 66 is a schematic view showing an inclination angle θ of a guide groove in a lubricant applying device of a printer according to the third example. The inclination angle θ of the guide groove is set through two steps of a first inclination angle θ1 and a second inclination angle θ2. In the configuration shown in FIG. 66, if the value of the inclination angle θ increases, the moving amount of the solid lubricant in the direction of the arrow B1 decreases when the thickness of the solid lubricant decreases by 1 mm. When the solid lubricant is used in an initial state during a predetermined period, the convex portion of the holding member (not shown in the drawings) moves in the direction of the arrow E1 according to the inclination in a region of the inclination angle θ1 in the guide groove GD. Then, if the solid lubricant is almost completely consumed, the convex portion (not shown in the drawings) moves in the direction of the arrow E2 according to the inclination in a region of the inclination angle θ2 in the guide groove GD. Since the inclination angle θ2 is smaller than the inclination angle θ1, when the solid lubricant is almost completely consumed, the movement in the direction of the arrow B1 with respect to the thickness decrease becomes large, as compared with the case of the initial state. That is, when the solid lubricant is almost completely consumed, the thickness decrease of the solid lubricant can be detected with high sensitivity, as compared with the case of the initial state.

The solid lubricant moves in the direction of the arrow B1 according to the consumption. However, when the total moving amount of the solid lubricant in the direction of the arrow B1 until the solid lubricant in the initial state is completely consumed is set to a large value, the size of the device in the brush rotation axis direction may increase. For this reason, the total moving amount needs to be maintained to a predetermined amount. Meanwhile, the moving amount of the direction of the arrow B1 with respect to the thickness decrease amount is preferably increased to detect the thickness decrease of the solid lubricant with high sensitivity. However, in this case, the total moving amount may not be within a desired range.

Therefore, in the printer according to the third example, when the solid lubricant in the initial state is used during a predetermined period, the convex portion of the holding member is moved in the region of the relatively large inclination angle θ1 in the guide groove GD, and the moving amount of the solid lubricant in the direction of the arrow B1 with respect to the thickness decrease amount of the solid lubricant is set to be relatively small. When the remaining amount of the solid lubricant is large, suppressing of the device size based on setting of the relatively large moving amount of the solid lubricant in the direction of the arrow B per unit thickness decrease amount is preferred in comparison to the detection of the thickness decrease of the solid lubricant with high sensitivity. Meanwhile, when the solid lubricant is almost completely consumed, the convex portion of the holding member is moved in the region of the relatively small inclination θ2 in the guide groove GD, and the moving amount of the solid lubricant in the direction of the arrow B1 with respect to the thickness decrease amount of the solid lubricant is set to be relatively large. When the solid lubricant is almost completely consumed, the thickness decrease of the solid lubricant is detected with high sensitivity and timing of when the solid lubricant is completely consumed is detected with high precision. Therefore, in this printer, the size increase of the solid applying device can be suppressed while the timing of when the solid lubricant is completely consumed is detected with high precision.

### Fourth Example

FIG. 67 is a schematic view showing an inclination angle θ of a guide groove in a lubricant applying device of a printer according to the fourth example. When the solid lubricant (not shown in the drawings) is used in an initial state during a predetermined period, the convex portion of the holding member moves in the direction of the arrow E, in a region having the inclination angle θ in the guide groove GD. In one end of the guide groove GD in a longitudinal direction, the inclination angle θ becomes zero, and one end extends in the direction of the arrow B1 along the rotation axis direction of the applying brush roller. When the solid lubricant is completely consumed, the convex portion of the holding member (not shown in the drawings) enters one end of the guide groove GD. In this state, if the applying brush roller rotates and the force of the direction of the arrow B1 is applied from the brush to the solid lubricant, the convex portion of the holding member significantly moves in the direction of the arrow B1 in one end of the guide groove GD. Thereby, the complete consumption of the solid lubricant is detected with high sensitivity.

### Fifth Example

FIG. 68 is a schematic view showing an inclination angle θ of a guide groove in a lubricant applying device of a printer according to the fifth example. Similar to the printer according to the third example, in this printer, the inclination angle θ of the guide groove GD is set through two steps of a first inclination angle θ1 and a second inclination angle θ2. Of an entire region of the guide groove GD in a longitudinal direction, in a region where the inclination angle θ changes from θ1 to θ2, provided is a curve portion that binds inclined portions having different angles in a curve trajectory. In this configuration, as compared with the case where the inclined portions having the different angles are bound as they are, the convex portion can be smoothly moved at a change point of the inclination and generation of the movement defect of the convex portion can be suppressed.

Until now, the example of the case where the present invention is applied to the printer that forms the color image by the tandem system is described. However, the present invention can be applied to an image forming apparatus that forms a monochromatic image.

In the printers according to the examples described above, provided in the guide groove GD is the inclined portion that makes the force of the biasing direction (direction of the arrow A) applied from the coil spring 19Y corresponding to the biasing portion to the holding member 17Y converted into the force of both the biasing direction and the direction of the arrow B1 corresponding to the direction orthogonal to the brush movement direction on the frictional surface, and provided are the movement detecting unit that detects the moving amount of the holding member 17Y in the direction of the arrow B1 and the consumption amount grasping unit that grasps the consumption amount of the solid lubricant 10Y on the basis of the detection result. In this configuration, the timing of when the solid lubricant 10Y is completely consumed can be detected on the basis of the above-described consumption amount.

In the printers according to the examples, the applying brush roller that includes the rotation shaft member 8Y to be rotatably supported and the brush roller portion 9Y with the plural bristles standing upright on the peripheral surface of the rotation shaft member is used as the applying member. The guide portion GD is provided in the region, between one end and the other end of the brush roller portion 9Y in the rotation axis direction, of the entire region inside the casing of the lubricant applying device. In this configuration, the size of the device can be decreased, as compared with the case where the guide groove GD is provided outside the region.

In the printers according to the examples, the brush roller portion 9Y is configured using a roller portion 9dY that rotates around the rotation shaft member 8Y and the bristled brush sheet 9cY that is wound in a spiral shape around the peripheral surface thereof. The gap G is provided between the sheets of the spirally wound bristled brush sheet 9cY, and the force of the direction of the arrow B1 is applied form the brush roller portion 9Y to the solid lubricant 10Y on the frictional surface. In this configuration, as described above, the convex portion 118Y that contacts one sidewall of the guide groove GD in a stop state is separated from the sidewall. Immediately before the convex portion is separated from the sidewall, the movement in the direction of the arrow E that is suppressed by the friction with the sidewall is urged. Thereby, the convex portion 118Y can be smoothly moved in the guide groove GD.

In the printer according to the second example, provided as the inclined portion provided in the guide groove GD is the inclined portion having the inclination angle θ that makes the moving amount of the solid lubricant 10Y in the direction of the arrow B1 larger than the moving amount of the solid lubricant 10Y in the biasing direction (direction of the arrow A). In this configuration, as described above, the thickness decrease of the solid lubricant 10Y can be amplified and can be detected with high sensitivity.

In the printer according to the third example, the inclined portions where the inclination angles are changed in at least two steps are provided as the inclined portions provided in the guide groove GD. The moving amount of the solid lubricant 10Y in the direction of the arrow B1 with respect to the thickness decrease of the solid lubricant can be changed according to the period of time.

In the printer according to the third example, the inclination angle θ is changed in at least two steps, such that the moving amount of the solid lubricant 10Y in the initial state, where the solid lubricant is not consumed in the direction of the arrow B1 when the solid lubricant is consumed by the predetermined thickness, is smaller than the moving amount of the solid lubricant 10Y in the direction of the arrow B1 when the solid lubricant is consumed by the predetermined thickness. In this configuration, as described above, the size increase of the lubricant applying device can be suppressed while the timing of when the solid lubricant is completely consumed is detected with high precision.

In the printer according to the fourth example, in the end region of the side of the applying brush roller 7Y in the entire region of the guide groove GD in the longitudinal direction, the inclination is set to be zero and the end region is extended in the direction of the arrow B1. In this configuration, as described above, the solid lubricant 10Y can be significantly moved in the direction of the arrow B1 when the solid lubricant is completely consumed and the complete consumption of the solid lubricant can be detected with high sensitivity.

In the printer according to the fifth example, of the entire region of the guide groove GD in a longitudinal direction, in the region where the inclination angle θ changes, provided is the curve portion that binds the inclined portions having the different angles in the curve trajectory. Therefore, the convex portion can be smoothly moved at the change point of the inclination and generation of the movement defect of the convex portion can be suppressed.

### Third Embodiment

Next, the characteristic configuration of a printer according to the third embodiment will be described.

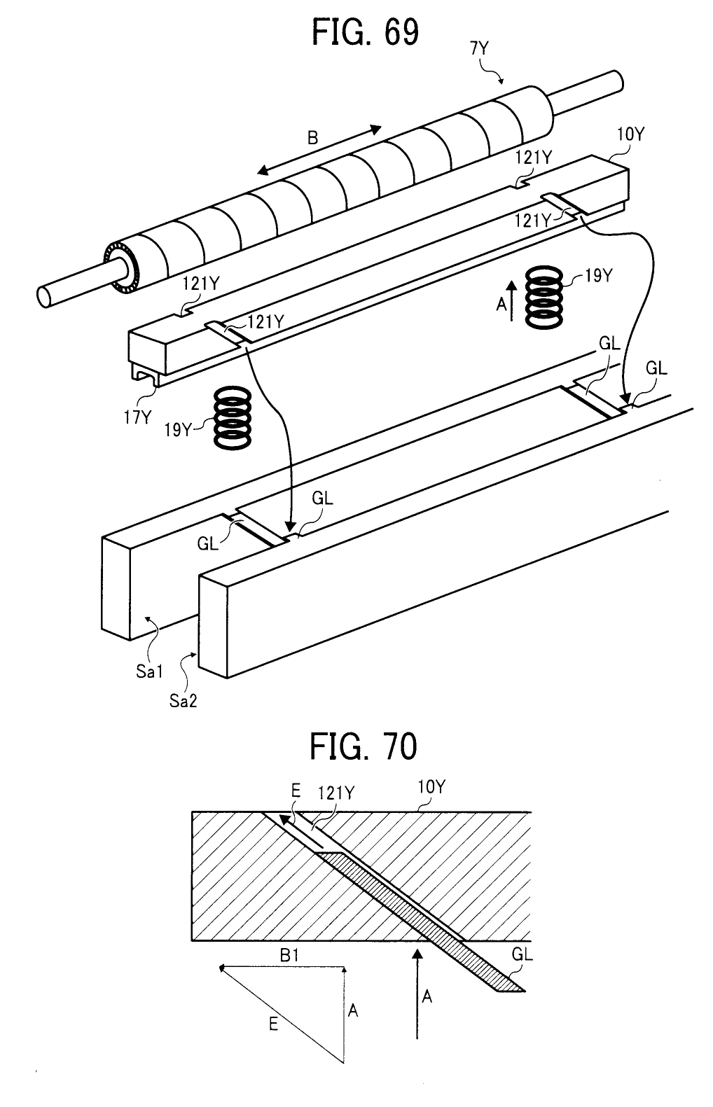

FIG. 69 is an enlarged perspective view partially showing an inner portion of a lubricant applying device for Y. In FIG. 69, the solid lubricant 10Y is fixed to the surface of the holding member 17Y made of C-shape steel, by both-sided tape. The coil spring 19Y is pressed against a back surface of a lubricant fixing surface in the holding member 17Y. The coil spring 19Y biases the solid lubricant 10Y in a direction of an arrow A toward the applying brush roller (not shown in the drawings) through the holding member 17Y. The direction of the arrow A is a direction along an orthogonal virtual surface orthogonal to a rotation axis direction of the applying brush roller 7Y and a central direction of the applying brush roller 7Y.

The solid lubricant 10Y is formed in an elongated block shape to be in contact with almost an entire region of the brush roller portion of the applying brush roller 7Y in a longitudinal direction. The width that is a longitudinal direction dimension in the solid lubricant 10Y having the block shape is set to a value larger than the width of the holding member 17Y. For this reason, on the surface of the holding member 17Y, the solid lubricant 10Y protrudes more in a width direction than the holding member 17Y. On the side of the protruding solid lubricant place, a concave portion 11Y that has an inclination groove shape is formed. The two sides exist in the width direction, and concave portions 121Y are formed at the sides. In one side, the concave portions 121Y are provided in both ends in the lubricant longitudinal direction that is a direction along the brush rotation axis direction.

Meanwhile, in each of two inside walls Sa1 and Sa2, that face the concave portions 121Y of the solid lubricant 10Y among plural inside walls in the casing of the lubricant applying device, two inclined guide rails GL are formed. The solid lubricant 10Y is set at the posture where the concave portion 121Y corresponding to the engagement portion thereof is engaged with the guide rail GL.

FIG. 70 is a schematic view movement of the solid lubricant 10Y on the guide rail GL. In FIG. 70, a direction of an arrow B1 shows a direction from one end of the brush to the other end, of a direction along the rotation axis direction of the applying brush roller (not shown in the drawings). By biasing the holding member (not shown in the drawings) in the direction of the arrow A by the coil spring, the solid lubricant 10Y moves in the direction of the arrow A in the drawings. At this time, an inner surface of the concave portion 11Y of the solid lubricant 10Y contacts the side of the guide rail GD. The side extends in a direction of an arrow E that includes components of the direction of the arrow A along the lubricant thickness direction and the direction of the arrow B1 along the brush rotation axis direction. If the inner surface of the concave portion 121Y contacts the side of the guide rail GL, the force of the direction of the arrow A of the solid lubricant 10Y is converted into the force of the direction of the arrow E along the guide rail GL. The solid lubricant 10Y moves along the guide rail GL having the inclination of the direction of the arrow E and moves in the direction of the arrow A and the direction of the arrow B1.

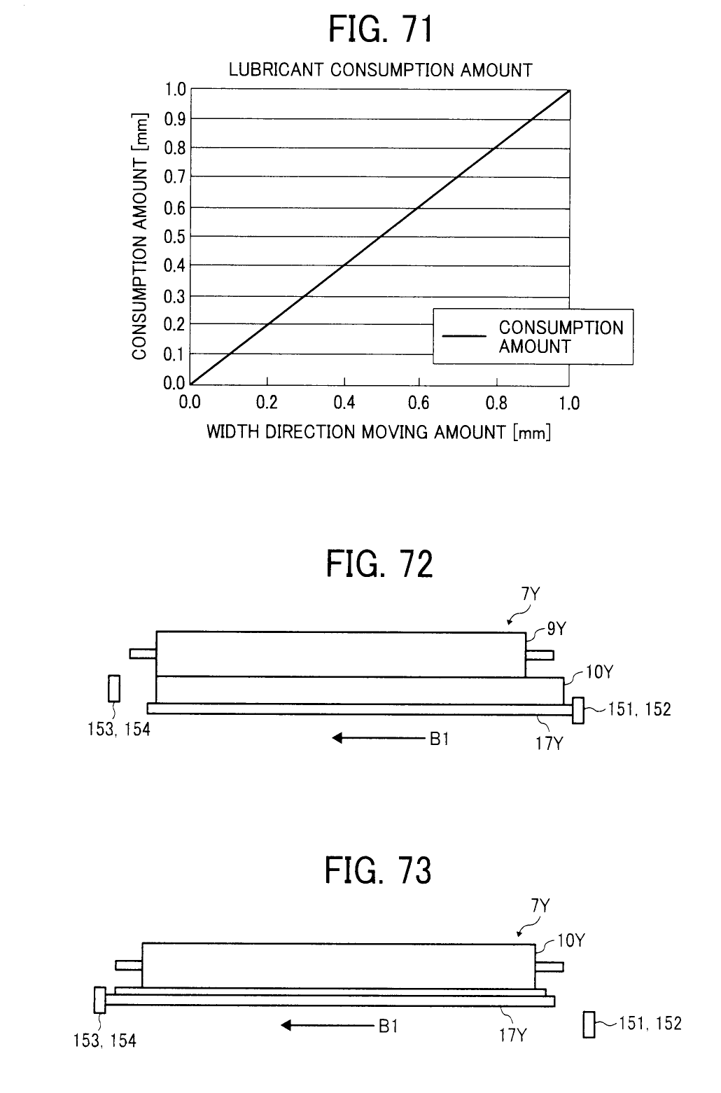

In FIG. 70, a place where a bottom surface of the solid lubricant 10Y is positioned in an extension direction of the guide rail GL is determined according to the thickness of the solid lubricant 10Y. When the thickness of the solid lubricant 10Y is relatively large, the bottom surface of the solid lubricant 10Y is positioned in a place relatively apart from the applying brush roller (not shown in the drawings). The position is the position near the lower end of the rail in FIG. 70. When the thickness of the solid lubricant 10Y decreases, the bottom surface of the solid lubricant 10Y comes close to the applying brush roller. In FIG. 20, the bottom surface level gradually rises. That is, when the thickness of the solid lubricant 10Y decreases, the bottom surface of the solid lubricant 10Y moves little by little in the direction of the arrow E. When the solid lubricant 10Y moves in the direction of the arrow E, the solid lubricant 10Y also moves in the direction of the arrow B1. A correlative relationship is realized between the moving amount in the direction of the arrow B1 and the consumption amount (thickness decrease amount) of the solid lubricant. For example, when the guide rail GL is inclined by 45° in the direction of the arrow A and the direction of the arrow B1, as shown in FIG. 71, the consumption amount of the solid lubricant 10Y and the moving amount of the solid lubricant 10Y or the holding member in the direction of the arrow B1 are equalized.

In this embodiment, an inclination angle of the guide rail GL is set, such that the side in the direction of the arrow B1 is larger than the side in the direction of the arrow A in a triangle formed by the vector of the direction of the arrow B1 and the vector of the direction of the arrow E. Therefore, the moving amount of the solid lubricant 10Y in the direction of the arrow B1 when the thickness of the solid lubricant is decreased by 1 mm becomes larger than 1 mm. In this configuration, the moving amount of the solid lubricant 10Y in the direction of the arrow B1 is lager than the decrease amount of the thickness of the solid lubricant 10Y. As will be described below, the consumption amount of the solid lubricant 10Y is grasped on the basis of the movement of the solid lubricant in the direction of the arrow B1. By detecting the moving amount of the solid lubricant in the direction of the arrow B1 larger than the thickness decrease amount, the thickness decrease is amplified and detected. Therefore, the thickness decrease can be detected with high sensitivity.

FIG. 72 is a side view showing a solid lubricant 10Y in an initial state and the peripheral configuration thereof. As shown in FIG. 72, as the solid lubricant 10Y or the holding member 17Y, used is a solid lubricant or a holding member where the length in the longitudinal direction is larger than the length of the brush roller portion 9Y of the applying brush roller 7Y in a rotation axis direction. As shown in FIG. 72, the solid lubricant 10Y in the initial state is set to the device at the posture where the end of the side opposite to the direction of the arrow B1 is positioned on the outer side of the end of the brush roller portion 9Y. In this state, a new product detecting first electrode 151 and a new product detecting second electrode 152 that are fixed to the device make contact with the metallic holding member 17Y and are electrically connected to the metallic holding member 17Y. A central processing unit (CPU) that is not shown in the drawings detects the electric connection and grasps that the new solid lubricant 10Y is set. In FIG. 72, only one new product detecting electrode is shown. This is because the new product detecting first electrode 151 and the new product detecting second electrode 152 are arranged with the predetermined gap in a direction orthogonal to the plane of sheet.

If the new solid lubricant 10Y shown in FIG. 72 is scraped by the applying brush roller 7Y and the thickness thereof is gradually decreased, the solid lubricant 10Y and the holding member 17Y move little by little in the direction of the arrow B1 in the drawings. In this case, the holding member 17Y is separated from the new product detecting first electrode 151 and the new product detecting second electrode 152 shown in the drawings.

FIG. 73 is a side view showing a completely consumed solid lubricant 10Y and the peripheral configuration thereof. As shown in FIG. 73, when the solid lubricant 10Y is completely consumed and as a result, the thickness thereof is minimized, the end of the holding member 17Y in a direction of an arrow B1 contacts a life duration detecting first electrode 153 and a life duration detecting second electrode 154. Thereby, the life duration detecting first electrode 153 and the life duration detecting second electrode 154 are electrically connected to each other through the holding member 17Y. The CPU that is not shown in the drawings detects the electric connection and grasps that the solid lubricant 10Y is completely consumed. The CPU displays a message to notify the user of that the solid lubricant is completely consumed on a display.

In the above configuration, the new product detecting first electrode 151, the new product detecting second electrode 152, the life duration detecting first electrode 153, the life duration detecting second electrode 154, and the CPU function as a moving amount detecting unit to detect the moving amounts of the solid lubricant 10Y and the holding member 17Y in the direction of the arrow B1. The CPU functions as a consumption amount grasping unit that grasps the consumption amount of the solid lubricant 10Y, on the basis of the detecting result of the moving amount. The coil spring 19Y or the guide rail GL functions as a lubricant moving unit that moves the solid lubricant 10Y in the brush rotation axis direction corresponding to the direction orthogonal to the applying member surface movement direction, by the moving amount according to the thickness decrease amount.

In the printer according to this embodiment, if the force of the rotation axis direction is applied from the applying brush roller 7Y to the solid lubricant 10Y on the frictional surface and the solid lubricant 10Y is pressed using the force, the solid lubricant is moved in the direction of the arrow B1.

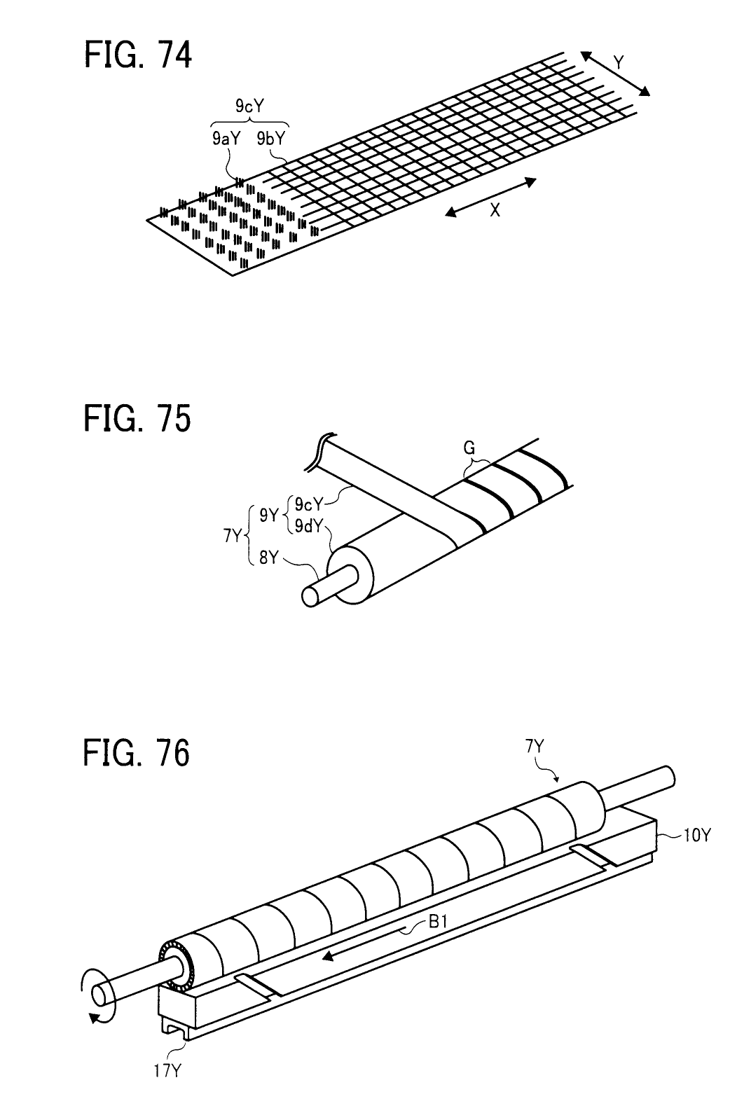

FIG. 74 is a perspective view showing a bristled brush sheet 9cY that is used in a brush roller portion of an applying brush roller 7Y. The bristled brush sheet 9cY is obtained by bristling plural bristles 9aY with respect to rectangular woven fabric 9bY, using the known technology.

FIG. 75 is a perspective view showing one end of an applying brush roller 7Y in a rotation axis direction and a solid lubricant 10Y. The applying brush roller 7Y has a metallic rotation shaft member 8Y and a brush roller portion 9Y that rotates around the rotation shaft member 8Y. The brush roller portion 9Y includes a roller portion 9dY and a bristled brush sheet 9cY that is wound in a spiral shape around the peripheral surface thereof. As shown in FIG. 75, a slight gap G is provided between spirally wound sheets to make the bristled brush sheet 9cY having a rectangular shape wound along the peripheral surface of the roller portion 9dY having a roller shape. By providing the gap G, as shown by the arrow B1 in FIG. 76, the applying brush roller 7Y applies the force applied from one end side to the other end side of the rotation axis direction to the solid lubricant 10Y.

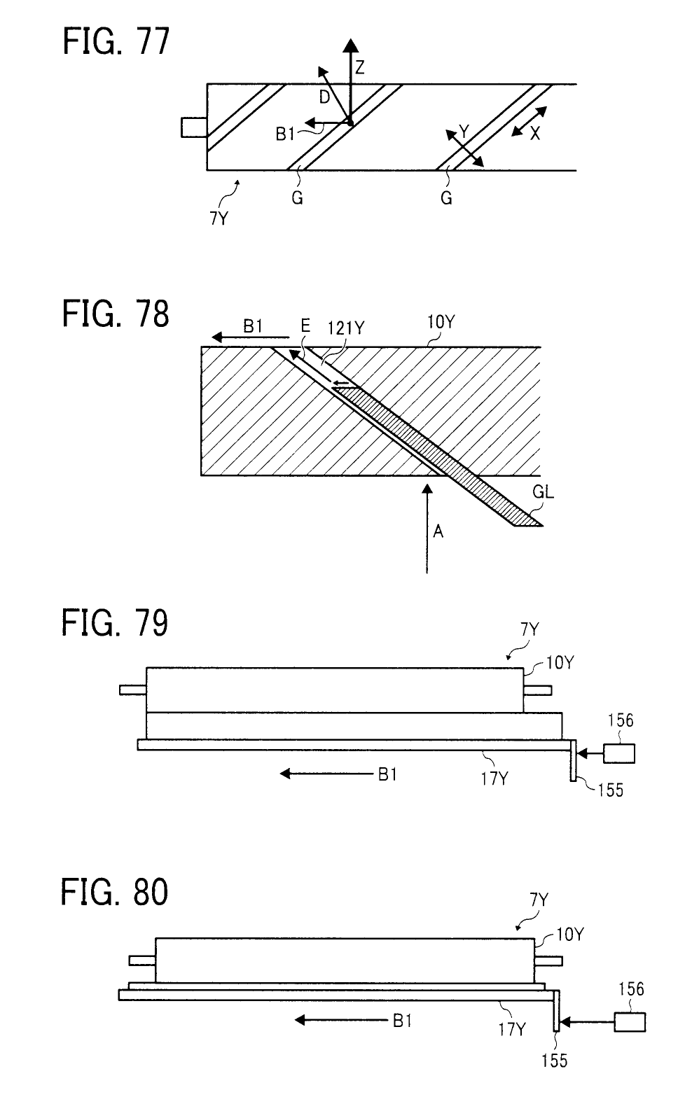

FIG. 77 is a schematic view showing a relationship between an applying brush roller 7Y and various directions. In FIG. 77, a direction of an arrow X is the same as the direction of the arrow X in FIG. 74 and shows a longitudinal direction in the bristled brush sheet 9cY. A direction of an arrow Y in FIG. 77 is the same in the direction of the arrow Y in FIG. 74 and shows a lateral direction in the bristled brush sheet 9cY. In FIG. 77, a direction of an arrow Z shows a direction where the applying brush roller 7Y moves on the frictional surface of the applying brush roller 7Y and the solid lubricant. In the case of the common applying brush roller, the force of the direction of the arrow Z is applied from the applying brush roller to the solid lubricant. As shown by an arrow D in FIG. 77, in the applying brush roller 7Y where the bristled brush sheet 9cY is wounded in a spiral shape, the force of a direction almost orthogonal to an extension direction of the spiral gap G is applied from the applying brush roller 7Y to the solid lubricant. The direction of the arrow D is a direction where the total force of the force of the direction of the arrow Z and the force of the direction of the arrow C orthogonal to the Z direction is applied. For this reason, the force of the direction of the arrow Z and the force of the direction of the arrow B1 are applied to the solid lubricant on the frictional surface of the applying brush roller 7Y. As shown in FIG. 76, the solid lubricant 10Y moves in the direction of the arrow B1 along the brush rotation axis direction. In this configuration, the applying brush roller 7Y and the coil spring 19Y function as a moving force applying unit that applies the moving force of the brush rotation axis direction to the solid lubricant 10Y.

The state shown in FIG. 70 shows the movement of the convex portion 118Y of the holding member, when the applying brush roller (not shown in the drawings) does not rotate. When the applying brush roller does not rotate, the inner surface of the concave portion 121Y of the solid lubricant 10Y to be moved in the direction of the arrow A contacts the side of the guide rail GL and the force of the direction of the arrow A is applied in the direction of the arrow E along the side. At this time, the movement of the solid lubricant 10Y in the direction of the arrow E is suppressed by the friction of the side of the rail and the inner surface of the concave portion.

As shown in FIG. 76, if the applying brush roller 7Y rotates, the force of the direction of the arrow B1 is applied from the applying brush roller 7Y to the solid lubricant 10Y. In this case, as shown in FIG. 78, the inner surface of the concave portion 121Y that contacts one side of the guide rail GL in a stop state is separated from the side of the rail. Immediately before the inner surface of the concave portion 121Y is separated from the side of the rail, the movement in the direction of the arrow E that is suppressed by the friction with the side of the rail is urged and the solid lubricant 10Y smoothly moves in the direction of the arrow E. The convex portion 118Y contacts the side opposite to the side previously being in contact of the rail and is pressed in the direction of the arrow E. At this time, the solid lubricant 10Y is pressed against the applying brush roller in the direction of the arrow E, by the force of the direction of the arrow A based on biasing of the coil spring and the force of the direction of the arrow B1 based on the brush. Thereby, generation of the pressing trouble of the solid lubricant 10Y can be suppressed.

The example of the case where the two concave portions 121Y are provided with one side of the solid lubricant 10Y is described. However, three or more concave portions may be provided.

Next, modifications of the printer according to the third embodiment will be described. The configurations of the printers according to the modifications are the same as that of the first embodiment, as long as the specific description is not given.

### First Modification

FIG. 79 is a side view showing a solid lubricant 10Y in an initial state in a printer according to a first modification and the peripheral configuration thereof. FIG. 80 is a side view showing the completely consumed solid lubricant 10Y in the printer according to the first modification and the peripheral configuration thereof. In the printer according to the modification, instead of the new product detecting electrodes and the life duration detecting electrodes, a distance sensor 156 is provided. In a place facing the distance sensor 156 in the holding member 17Y, an inspected member 155 is fixed. The distance sensor 156 detects the distance of the inspected member 155 and the distance sensor by reflection of ultrasonic waves and infrared rays. The distance sensor 156 grasps the moving amount of the holding member 17Y in the direction of the arrow B1, on the basis of the change amount of the distance. Different from the printer according to the embodiment where only the moving amount from the new product state to the completely consumed state can be detected, the minute movement of the holding member 17Y can be detected. For this reason, the user can grasp the remaining solid lubricant 10Y and can accurately grasp exchange preparation timing of the solid lubricant 10Y.

### Second Modification

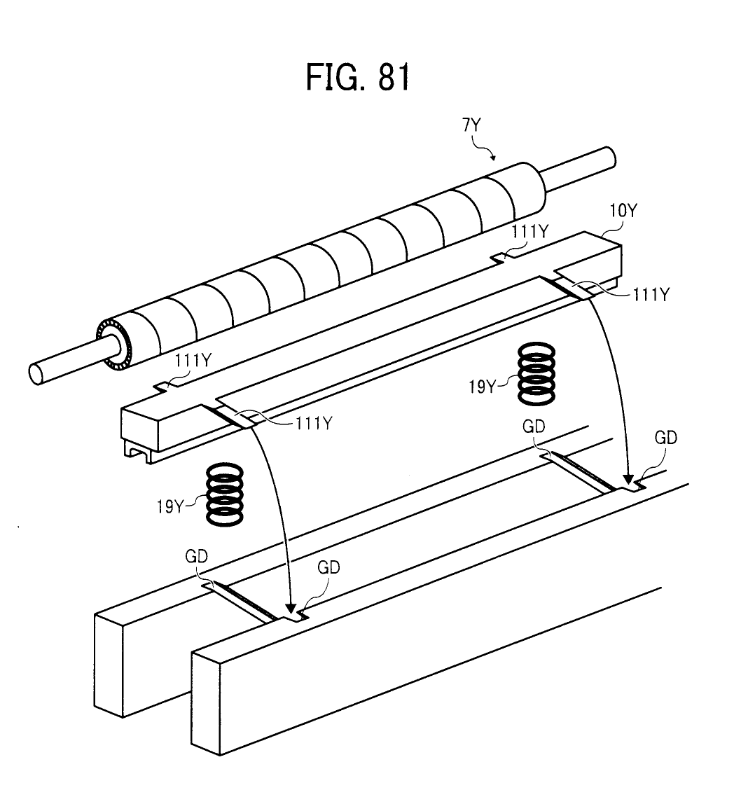

FIG. 81 is an enlarged perspective view partially showing an inner portion of a lubricant applying device for Y in a printer according to a second modification. In the printer according to the second modification, a relationship of the rail and the concave portion that guide the oblique movement of the solid lubricant 10Y is reversed to the relationship in the embodiment. Specifically, instead of the guide rail, the guide groove GD is provided in the inside wall of the casing. Instead of the concave portion having the inclination groove, the convex portion 111Y having the guide rail shape is provided in the solid lubricant 10Y. At the posture where the four convex portions 111Y provided in the solid lubricant 10Y are engaged with the four guide grooves GD provided in the inside wall of the casing, the holding member 17Y and the solid lubricant 10Y are set. As such, even though the relationship of the rail and the concave portion is reversed to the relationship in the embodiment, the same function and effect as those in the embodiment can be obtained.

### Third Modification

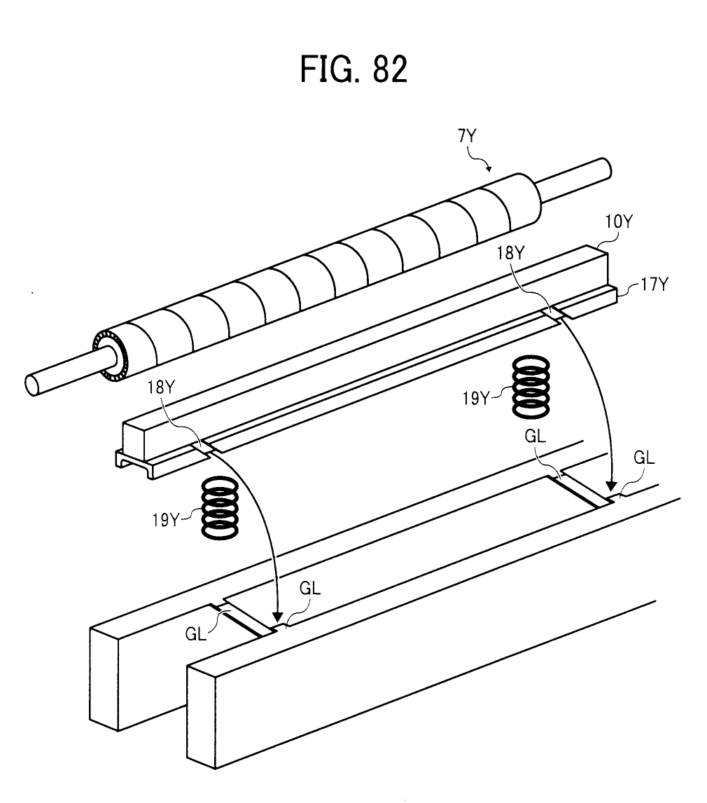

FIG. 82 is an enlarged perspective view partially showing an inner portion of a lubricant applying device for Y in a printer according to a third modification. In the printer according to the third modification, as the inclination groove to be engaged with the guide rail GL of the inside wall of the casing, the concave portion 18Y is provided in the metallic holding member 17Y, instead of providing the concave portion in the solid lubricant 10Y.

In the embodiment described above, by providing the concave portion having the inclination groove shape in the solid lubricant 10Y having an excellent lubricating property and sliding and rubbing the solid lubricant 10Y on the side of the guide rail GL, the solid lubricant 10Y can be smoothly moved along the guide rail GL. Meanwhile, if the concave portion 11Y of the solid lubricant 10Y is strongly pressed against the guide rail GL, splitting, cracking, and chipping may be easily generated in the solid lubricant 10Y. Further, loosening of the solid lubricant 10Y may be increased by increasing the width of the concave portion 11Y by the consumption.

Meanwhile, in the printer according to the third modification, instead of the solid lubricant 10Y, the concave portion 18Y of the holding member 17Y that is made of a metal having high rigidity is slid and rubbed on the guide rail GL, and generation of splitting of the solid lubricant 10Y due to strong pressing of the solid lubricant 10Y against the guide rail GL can be avoided. Since the metallic concave portion 18Y is not consumed, loosening of the solid lubricant 10Y based on the width increase of the concave portion 18Y is not generated, even though the solid lubricant 10Y is used during a long period. Meanwhile, the pressing trouble of the solid lubricant 10Y is easily generated, the trouble being attributable to the metallic concave portion 18Y being caught by the minute unevenness of the surface of the guide rail GL.

### Fourth Modification

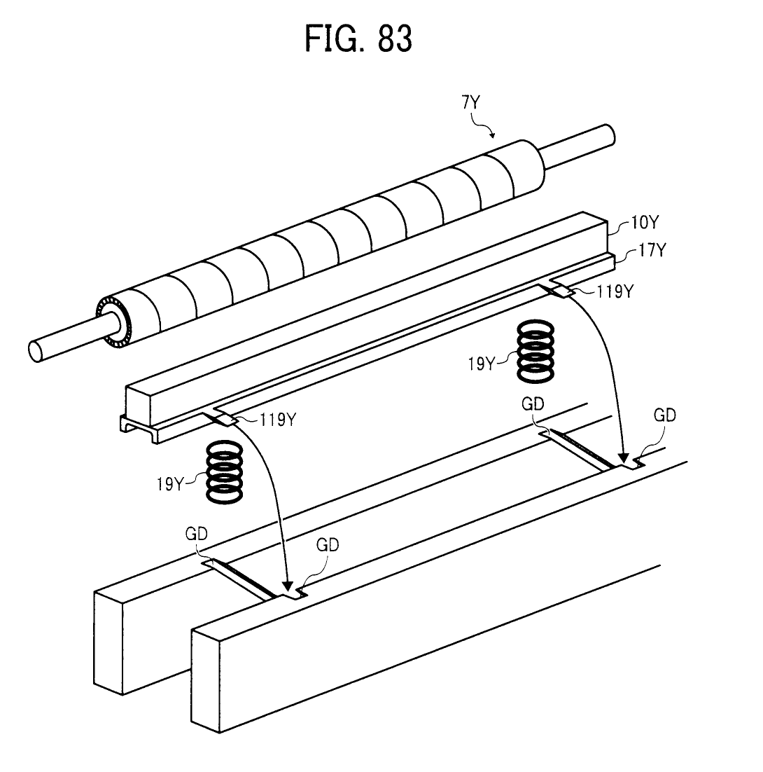

FIG. 83 is an enlarged perspective view partially showing an inner portion of a lubricant applying device for Y in a printer according to a fourth modification. The printer according to the fourth modification is different from the printer according to the second modification in that, as the engagement portion to be engaged with the guide rail GL of the inside wall of the casing, the convex portion 119Y is provided in the metallic holding member 17Y, instead of providing the convex portion in the solid lubricant 10Y. The splitting of the solid lubricant 10Y due to strong pressing of the solid lubricant 10Y against the guide groove DG can be avoided and the loosening of the solid lubricant 10Y due to the width increase of the concave portion can be avoided. Meanwhile, the pressing trouble of the solid lubricant 10Y is easily generated, the trouble being attributable to the metallic convex portion 119Y being caught with the minute unevenness of the surface of the guide groove GD.

### Fifth Modification

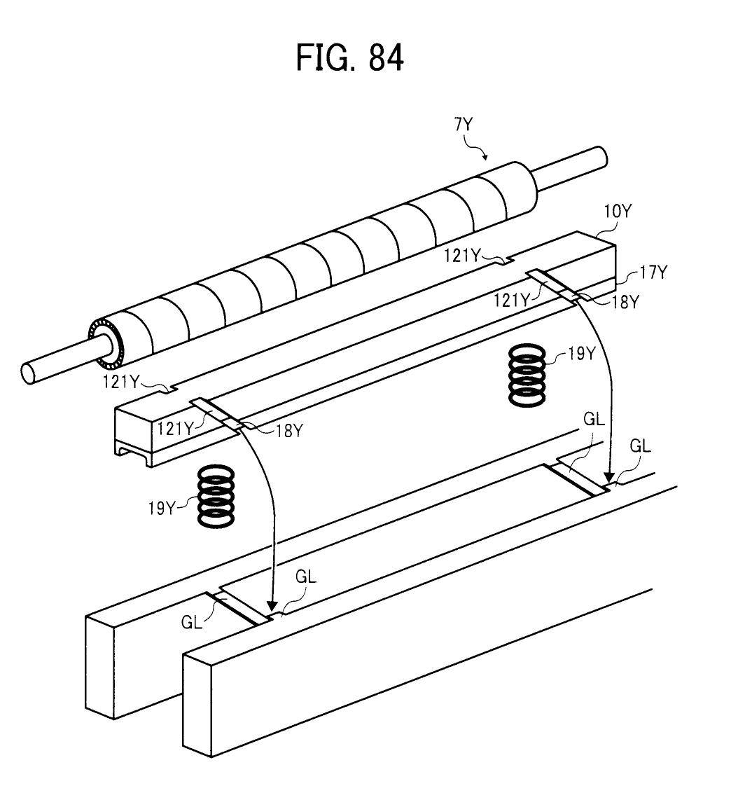

FIG. 84 is an enlarged perspective view partially showing an inner portion of a lubricant applying device for Y in a printer according to a fifth modification. The printer according to the fifth modification is different from the printer according to the embodiment in that the concave portion 11Y is provided in the solid lubricant 10Y and the concave portion 18Y connected to the concave portion 121Y and having the same inclination as the concave portion 121Y is provided in the holding member 17Y. The widths of the concave portions are equal to each other. By contacting the concave portion 18Y of the metallic holding member 17Y with the guide rail GL, the pressing force of the solid lubricant 10Y with respect to the rail when any force is applied to the solid lubricant 10Y is reduced. Thereby, as compared with the printer according to the embodiment, the splitting of the solid lubricant 10Y may not easily occur, the splitting being attributable to the pressing of the solid lubricant 10Y against the guide rail GL. By suppressing the width increase of the concave portion 121Y of the solid lubricant 10Y, loosening of the solid lubricant 10Y can be suppressed from being generated due to the width increase. By sliding and rubbing the concave portion 121Y of the solid lubricant 10Y on the side of the guide rail GL and applying the lubricant powder on the side, the frictional force of the concave portion 18Y of the metallic holding member 17Y and the guide rail GL is reduced. Thereby, the holding member 17Y can be smoothly slid on the guide rail GL, as compared with the printer according to the third modification. Since the concave portion 18Y engaged with the guide rail GL exists in the holding member 17Y, the solid lubricant 10Y on the holding member 17Y can be moved to the contact position with the applying brush roller 7Y, even though the length of the guide rail GL is shortened.

### Sixth Modification

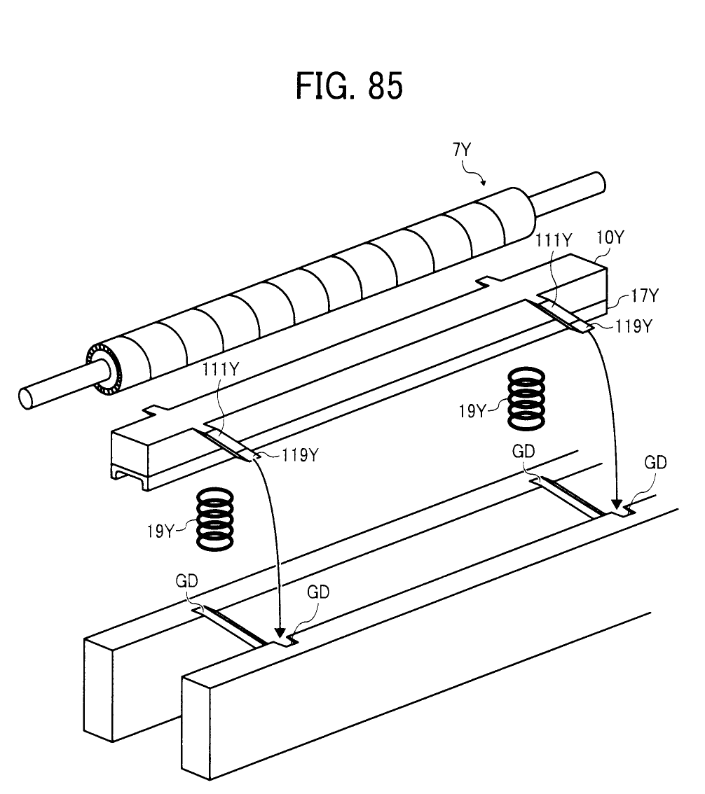

FIG. 85 is an enlarged perspective view partially showing an inner portion of a lubricant applying device for Y in a printer according to a sixth modification. The printer according to the sixth modification is different from the printer according to the second modification in that the convex portion 111Y is provided in the solid lubricant 10Y and the convex portion 119Y connected to the concave portion 11Y and having the same inclination as the convex portion 111Y is provided in the holding member 17Y. The widths of the convexes portions are equal to each other.

In the printer according to the second modification, by providing the convex portion 111Y having the inclined guide rail shape in the solid lubricant 10Y having an excellent lubricating property and sliding and rubbing the solid lubricant 10Y on the inner surface of the guide groove GD, the solid lubricant 10Y can be smoothly moved along the guide groove GD. Meanwhile, if the convex portion 111Y of the solid lubricant 10Y is strongly pressed against the guide groove GD, splitting, cracking, and chipping may be easily generated in the convex portion 111Y.

Meanwhile, in the printer according to the sixth modification, by allowing the convex portion 111Y of the metallic holding member 17Y to be in contact with the guide groove GD, the pressing force of the solid lubricant 10Y against the guide groove GD of the convex portion 119Y is reduced. Thereby, as compared with the printer according to the second modification, the splitting of the convex portion 111Y can be suppressed from being generated, the splitting being attributable to the pressing of the convex portion 111Y of the solid lubricant 10Y against the guide groove GD. By suppressing the width decrease of the convex portion of the solid lubricant 10Y, loosening of the solid lubricant 10Y can be suppressed from being generated due to the width decrease. By sliding and rubbing the convex portion 111Y of the solid lubricant 10Y on the inner surface of the guide groove GD and applying the lubricant powder on the inner surface, the frictional force of the convex portion 119Y of the metallic holding member 17Y and the guide groove GD is reduced. Thereby, the holding member 17Y can be smoothly slid in the guide groove GD, as compared with the printer according to the fourth modification. Since the convex portion 119Y engaged with the guide groove GD exists in the holding member 17Y, the solid lubricant 10Y on the holding member 17Y can be moved to the contact position with the applying brush roller 7Y, even though the length of the guide groove GD is shortened.

### Seventh Modification

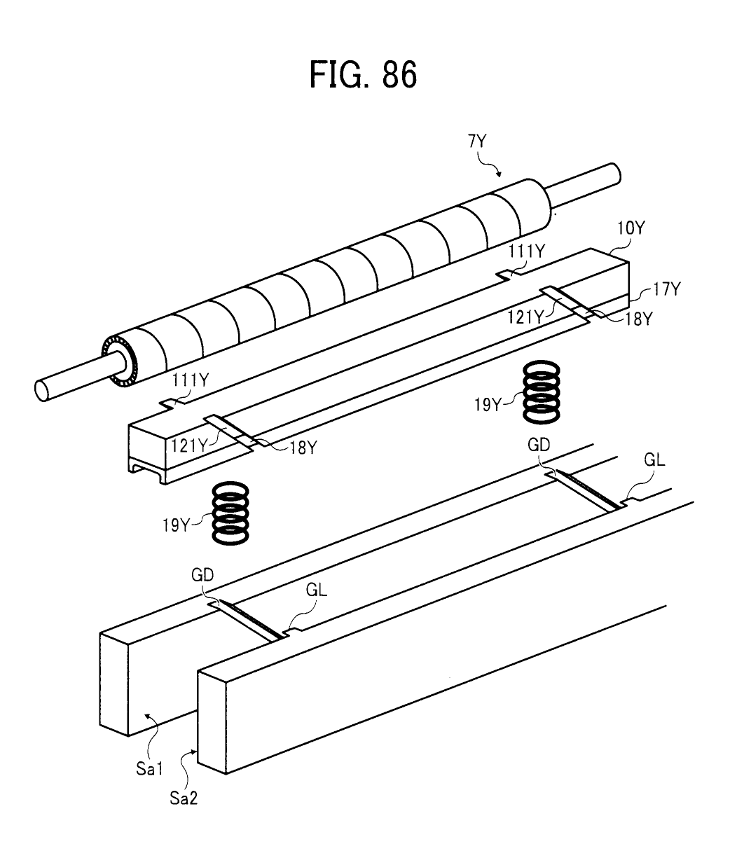

FIG. 86 is an enlarged perspective view partially showing an inner portion of a lubricant applying device for Y in a printer according to a seventh modification. In the printer according to the seventh modification, the two guide rails GL are provided on an inside wall surface Sa2 that is one of two inside wall surfaces Sa1 and Sa2 of the casing which face each other with the solid lubricant 10Y interposed therebetween, among the plural inside wall surfaces in the casing of the lubricant applying device. On the other inside wall surface Sa1, the guide grooves GD are provided at the positions facing the two guide rails GL of the inside wall surface Sa2.

In the solid lubricant 10Y, the two convex portions 111Y to be individually engaged with the two guide grooves GD of the inside wall surface Sa1 of the casing are provided at both ends of the lubricant longitudinal direction. The two concave portions 121Y to be individually engaged with the two guide rails GL of the inside wall surface Sa2 of the casing are provided in both ends of the lubricant longitudinal direction. In the lubricant longitudinal direction, the convex portion 111Y provided on one side in the width direction and the concave portion 121Y provided on the other side correspond, in position, to each other, and the convex portion 111Y and the concave portion 121Y face each other, with the lubricant therebetween, in the width direction.

In the holding member 17Y, the concave portions 18Y to be engaged with the guide rails GL or to receive the guide rails GL therein in a non-contact manner are provided at the positions communicating with the two concave portions 121Y of the solid lubricant 10Y.

As such, in the printer according to the seventh modification, the convex portion 111Y is provided in one of the two sides arranged in the width direction of the solid lubricant 10Y, the concave portion 121Y is provided in the other side, and the convex portion 111Y and the concave portion 121Y are provided at the positions facing each other in the width direction. The reason why the above configuration is adopted is as follows. That is, of the convex portion 111Y and the concave portion 121Y, only the convex portion 111Y is provided. As a result, the dimension of the solid lubricant 10Y in the widthwise direction varies depending on the position in the lubricant longitudinal direction. Specifically, in the lubricant longitudinal direction, in the place where the convex portion 111Y is not provided, the basic width dimension of the solid lubricant 10Y becomes the dimension in the width direction. Meanwhile, in the lubricant longitudinal direction, in the place where the convex portion 111Y is provided, the dimension of the solid lubricant 10Y in the width direction becomes a value of the sum of the basic width dimension and the protrusion amount of the convex portion 111Y from the side of the lubricant. That is, in the place where the convex portion 111Y is provided, the dimension of the width direction is large, as compared with the places where the convex portion 111Y is not provided. The dimension difference leads to the difference in lubricant scraping amount, and the difference in the lubricant scraping amounts results in the difference in lubricant applying amount. This is because the lubricant applying amount in the place corresponding to the convex portion 111Y of the solid lubricant 10Y in the rotation axis direction of the applying brush roller 7Y may be larger than the lubricant applying amount in the place not corresponding to the convex portion 111Y of the solid lubricant 10Y. As such, if the lubricant applying amount is different, irregularities of an image quality may be generated in a formed image.

Further, of the convex portion 111Y and the concave portion 121Y, only the concave portion 121Y is provided. In this case, the lubricant applying amount in the place corresponding to the concave portion 121Y of the solid lubricant 10Y in the rotation axis direction of the applying brush roller 7Y may be smaller than the lubricant applying amount in the place not corresponding to the concave portion 11Y. As such, even when the lubricant applying amount is different, irregularities of an image quality may be generated in a formed image.

Therefore, the convex portion 111Y is provided for any one side of two sides of the solid lubricant 10Y in the width direction, and the concave portion 121Y is provided for the other side at the position corresponding to the convex portion 111Y through the solid lubricant 10Y. In this configuration, as compared with the case where only the convex portion 111Y or the concave portion 121Y is provided, the irregularities of the image quality can be suppressed by decreasing the variation in the lubricant width direction along the lubricant longitudinal direction. In the printer according to the tenth modification, since the protruding amount of the convex portion 111Y and the dent amount of the concave portion 121Y are equally set, in the lubricant longitudinal direction, in the place where the convex portion 111Y and the concave portion 121Y are provided and the place where the convex portion 111Y and the concave portion 121Y are not provided, the lubricant width dimensions become equal to each other. Therefore, generation of the irregularities of the image quality can be avoided.

### Eighth Modification

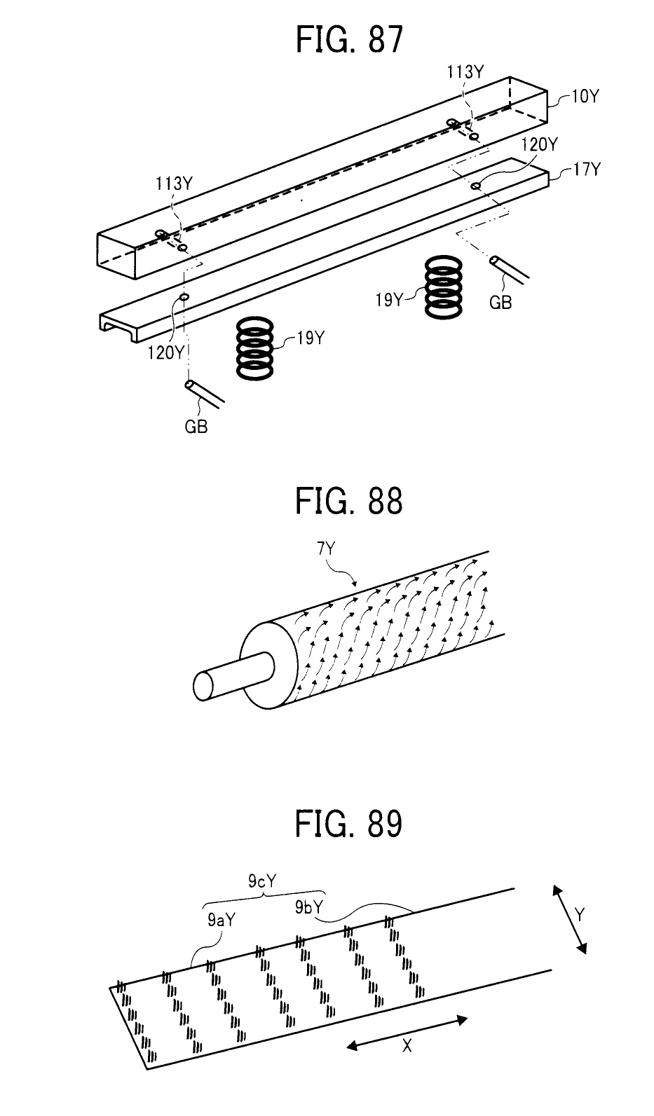

FIG. 87 is an assembly exploded perspective view showing a solid lubricant 10Y for Y and a holding member 17Y in a printer according to an eighth modification. In the printer according to the eighth modification, instead of the guide rail, a guide rod GB is provided as a guide portion to guide the movement of the solid lubricant 10Y. The guide rod GB is provided to protrude in a direction inclined to the solid lubricant on the bottom wall surface (Sb of FIG. 11) of the casing. In this example, the guide rod GB is formed integrally with the bottom wall of the casing. However, the guide rod may be separated from the casing. In this case, the guide rod GB can be formed of a material (for example, metal) different from a material of the casing.

In the solid lubricant 10Y, two holes 113Y to receive the guide rod GB provided on the bottom wall of the casing are provided. The holes 113Y are provided to be individually positioned in both ends of the solid lubricant 10Y in the longitudinal direction. The two guide rods GB described above are provided on the bottom wall of the casing to be individually inserted into the two holes 113Y.

Also, in the holding member 17Y, through-holes 120Y to individually receive the two guide rods GB are provided in both ends of the longitudinal direction, respectively.

When the lubricant applying device is assembled, first, the solid lubricant 10Y is fixed to the holding member 17Y. At this time, in a state where the hole 113Y of the solid lubricant 10Y communicates with the through-hole 120Y of the holding member 17Y, the solid lubricant 10Y is fixed to the holding member 17Y. Next, the solid lubricant 10Y and the holding member 17Y are set in the casing, while the guide rods GB are inserted into the through-hole 120Y of the holding member 17Y and the hole 113Y of the solid lubricant 10Y. Then, the applying brush roller that is not shown in the drawings is set.

The holes 113Y that are provided in both ends of the solid lubricant 10Y, the through-holes 120Y that are provided in both ends of the holding member, and the two guide rods GB that are provided on the bottom wall of the casing are positioned in a region between one end and the other end of the brush roller portion of the applying brush roller (not shown in the drawings) in the rotation axis direction.

As the hole 113Y of the solid lubricant 10Y, instead of the through-hole that passes therethrough from the lower end to the upper end in the thickness direction, the through-hole that makes a dent from the bottom portion by the predetermined depth is provided. However, the through-hole may be provided. In this configuration, similar to the configuration where the guide rail or the guide groove is provided, the solid lubricant 10Y can be moved in the thickness direction and can be moved in the brush rotation axis direction.

### Ninth Modification

FIG. 88 is a partially enlarged perspective view showing one end of an applying brush roller 7Y for Y in a printer according to a ninth modification. In the printer according to the ninth modification, as shown in FIG. 88, a roller where bristles are inclined in a spiral shape is used as the applying brush roller 7. Similar to the roller where the bristled brush sheet is wound in a spiral shape, the applying brush roller 7 can apply the force of the rotation direction and the force of the rotation axis direction to the solid lubricant on the frictional surface.

### Tenth Modification

FIG. 89 is a perspective view showing a bristled brush sheet 9cY that is used in an applying brush roller for Y in a printer according to a tenth modification. In FIG. 89, in the bristled brush sheet 9cY, the bristle density in a sheet longitudinal direction (direction of an arrow X) is lower than the bristle density in a lateral direction of the sheet. Specifically, in the bristled brush sheet 9cY shown in the drawings, a bristle bundle where plural bristles 9aY are bound is bristled without a gap, in the lateral direction of the sheet. Meanwhile, in the sheet longitudinal direction, the sheet bundle is bristled with the predetermined gap.

The bristled brush sheet 9cY is wound spirally around the peripheral surface of the roller portion of the applying brush roller (not shown in the drawings). At this time, different from the embodiment, a gap is not provided between the sheets wound in the spiral shape. Even though the gap is not provided, by the difference of the bristle densities, the force of the rotation direction of the brush and the force of the rotation axis direction can be applied to the solid lubricant on the frictional surface.

### Eleventh Modification

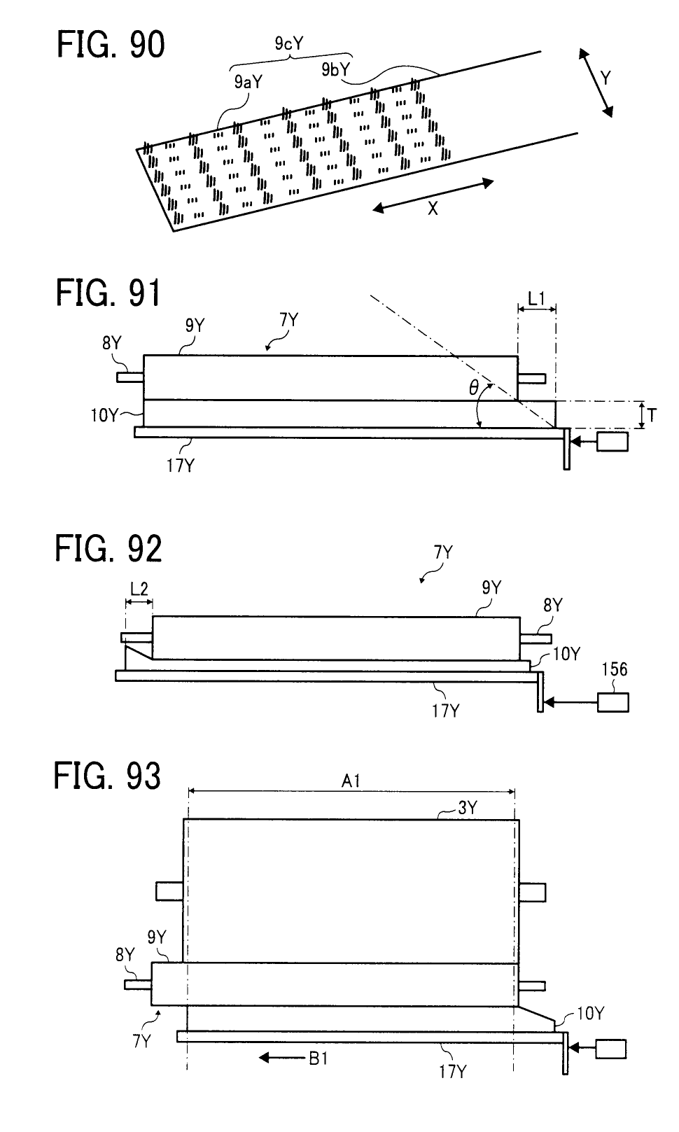

FIG. 90 is a perspective view showing a bristled brush sheet 9cY that is used in an applying brush roller for Y in a printer according to an eleventh modification. In FIG. 90, in the bristled brush sheet 9cY, a bristle bundle where relatively long bristles 9aY are bounded and a bristle bundle where relatively short bristles 9aY are bonded are alternately bristled in a sheet longitudinal direction (direction of an arrow X).

The bristled brush sheet 9cY is wound spirally around the peripheral surface of the roller portion of the applying brush roller (not shown in the drawings). At this time, different from the embodiment, a gap is not provided between the sheets wound in the spiral shape. Even though the gap is not provided, by the difference of the bristle lengths, the force of the rotation direction of the brush and the force of the rotation axis direction can be applied to the solid lubricant on the frictional surface.

### Twelfth Modification

FIG. 91 is a side view showing an applying brush roller 7Y for Y, a solid lubricant 10Y, and a holding member 17Y in a printer according to a twelfth modification. In a photosensitive element (not shown in the drawings), the lubricant needs to be applied on at least an effective image formation region in a rotation axis direction of the photosensitive element. Therefore, with respect to the applying brush roller 7Y, the length of the brush roller portion 9Y in a rotation axis direction is set to be larger than the length of the effective image formation region of the photosensitive element in the rotation axis direction. With respect to the solid lubricant 10Y that is moved in the brush rotation axis direction, the length of the solid lubricant in the rotation axis direction is set to be larger than the length of the brush roller portion 9Y.

The length difference of the solid lubricant 10Y and the brush roller portion 9Y is set to be equal to or more than the moving amount of the solid lubricant 10Y in the brush rotation axis direction, during the period from the initial state and the completely consumed state. Thereby, the solid lubricant 10Y can be continuously in contact with the entire region of the brush roller portion 9Y in the rotation axis direction, until the state of the solid lubricant 10Y becomes the completely consumed state from the initial state.

In FIG. 91, θ indicates an inclination angle of the guide rail (not shown in the drawings). The solid lubricant 10Y is pressed against the applying brush roller 7Y along the inclination. In an initial state, as shown in FIG. 91, in an end of the side opposite to a movement direction of the solid lubricant 10Y in both ends of the brush roller portion 9Y, the solid lubricant 10Y is set to protrude more than the end thereof. If the thickness of the solid lubricant 10Y in the initial state is set to T, the protrusion amount thereof is preferably “T/tan θ” or more. This reason is as follows. That is, in FIG. 91, tan θ is represented as “T/L1” For this reason, L1 is represented as “T/tan θ.” This value shows the total moving amount of the solid lubricant 10Y in the rotation axis direction, when it is assumed that the solid lubricant 10Y is completely consumed. As described above, even though the solid lubricant 10Y is not completely consumed in actuality, it is assumed that the solid lubricant 10Y is completely consumed. Therefore, by setting L1 to “T/tan θ” or more, the solid lubricant 10Y can be continuously in contact with the entire region of the brush roller portion 9Y in the rotation axis direction, until the state of the solid lubricant becomes the completely consumed state from the initial state.

FIG. 92 is a side view showing a completely consumed solid lubricant 10Y and the peripheral configuration thereof. As shown in FIG. 92, when the solid lubricant is completely consumed, the leading edge of the solid lubricant 10Y in the longitudinal direction protrudes to the outside by the distance L2, as compared with the end of the brush roller portion 9Y. In the place of the solid lubricant that protrudes in the above way, as shown in FIG. 92, an “uncut place” that has a portion tapered from the outside to the central side is generated. The “uncut place” needs to bum into the rotation shaft member 8Y of the applying brush roller 7Y.

Therefore, in the twelfth modification, the CPU that is a notifying unit is provided to notify that the solid lubricant 10Y is completely consumed, before the thickness decrease amount of the solid lubricant 10Y from the initial state thereof specified on the basis of the detection result obtained by the distance sensor 156 has the same value as the distance from the outer circumferential surface of the rotation shaft member 8Y of the applying brush roller 7Y to the outer circumferential surface of the brush roller portion 9Y. Thereby, the “uncut place” can be previously avoided from abutting on the rotation shaft member 8Y.

### Thirteenth Modification

FIG. 93 is a side view showing a solid lubricant 10Y for Y in a printer according to a thirteenth modification and the peripheral configuration thereof. In FIG. 93, in the applying brush roller 7Y, the length of the brush rotation axis direction of the brush roller portion 9Y is larger than the length of the rotation axis direction of the photosensitive element 3Y corresponding to the application target. As shown in FIG. 93, a brush roller end in a direction of an arrow B1 that is a movement direction along the brush rotation axis direction of the solid lubricant 10Y is disposed to protrude more than the end of the photosensitive element.

In the solid lubricant 10Y, the length of the brush rotation axis direction is larger than the length of the rotation axis direction of the photosensitive element 3Y. Similar to the printer according to the twelfth modification, in the initial state, the solid lubricant is set in a state where the end of the side opposite to the direction of the arrow B1 to be the movement direction protrudes to the back of the end of the side opposite to the direction of the arrow B1 of the brush roller portion 9Y. In the end that protrudes in the above way, a taper that comes close to the applying brush roller 7Y toward the central side from the end side (rear side) is provided. An inclination surface of the taper is provided along an extension direction of the guide rail (not shown in the drawing), and an inclination angle of the inclination surface becomes equal to an inclination angle of the guide rail.

In FIG. 93, A1 indicates an effective image formation region of the photosensitive element 3Y in the rotation axis direction. As shown in FIG. 93, the brush roller portion 9Y of the applying brush roller 7Y and the solid lubricant 10Y are positioned in the effective image formation region of the photosensitive element 3Y. In the initial state, the solid lubricant 10Y is set in a state where the leading edge of the movement direction (direction of the arrow B1) is positioned at the back of the leading edge of the brush roller portion 9Y.

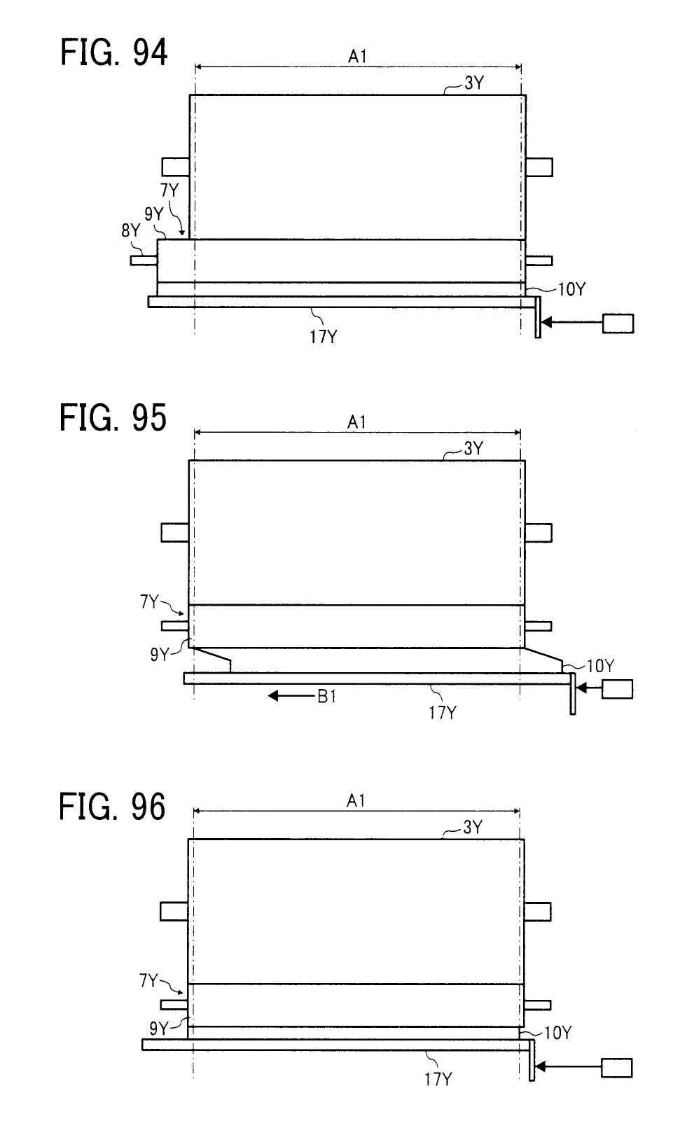

FIG. 94 is a side view showing a completely consumed solid lubricant 10Y and the peripheral configuration. As shown in FIG. 94, when the solid lubricant 10Y is completely consumed, the solid lubricant 10Y forwardly moves the trailing edge that protrudes to the back of the trailing edge of the brush roller portion 9Y in the initial state, to the contact position with the brush roller portion 9Y. As shown in FIG. 93, the taper is provided in the trailing edge. However, if the taper moves to the contact position with the brush roller portion 9Y, the taper disappears, as shown in FIG. 94. By providing the taper to have the same inclination angle as the guide rail, the thickness of the taper place that enters the brush roller portion 9Y becomes equal to the thickness of the lubricant place that is slid and rubbed on the brush roller portion 9Y. Thereby, pressing irregularities of the solid lubricant 10Y with respect to the brush can be avoided from being generated due to entering of the lubricant place thicker than the lubricant place slid and rubbed on the brush roller portion 9Y with respect to the frictional surface of the brush roller portion 9Y.

As shown in FIG. 94, the completely consumed solid lubricant 10Y moves until the leading edge of the movement direction arrives at the position of the leading edge of the brush roller portion 9Y. Since the solid lubricant 10Y is scraped at the position of the leading edge of the brush roller portion 9Y, the leading edge of the solid lubricant 10Y is scraped by the brush roller portion 9Y until the solid lubricant is completely consumed, different from the twelfth modification. Therefore, generation of the “uncut place” in the twelfth modification can be avoided.

### Fourteenth Modification

FIG. 95 is a side view showing a solid lubricant 10Y for Y in a printer according to a fourteenth modification and the peripheral configuration thereof. In FIG. 95, in the applying brush roller 7Y, the length of the brush rotation axis direction of the brush roller portion 9Y is almost equal to the length of the rotation axis direction of the photosensitive element 3Y.

In the solid lubricant 10Y, the length of the brush rotation axis direction is larger than the length of the brush roller portion 9Y of the applying brush roller 7Y. Similar to the printer according to the thirteenth modification, in the initial state, the solid lubricant is set in a state where the end of the side opposite to the direction of the arrow B1 to be the movement direction protrudes to the back of the end of the side opposite to the direction of the arrow B1 of the brush roller portion 9Y. In the end that protrudes in the above way, the same taper as that of the thirteenth modification is provided. The leading edge of the movement direction of the solid lubricant 10Y is disposed at almost the same position as the end of the effective image formation region of the photosensitive element 3Y in the initial state, as shown in FIG. 95. In the leading edge, a taper that is provided in the same direction as the trailing edge and has the same inclination angle is provided.

FIG. 96 is a side view showing a completely consumed solid lubricant 10Y and the peripheral configuration thereof. As shown in FIG. 95, in spite that the solid lubricant 10Y starts to move in the direction of the arrow B1, in a state where the leading edge of the solid lubricant 10Y is disposed at almost the same position as the leading edge of the brush roller portion 9Y, as shown in FIG. 96, the solid lubricant is completely consumed without generating the “uncut place” in the twelfth modification. This is because the same taper as that of the trailing edge is provided in the leading edge of the solid lubricant 10Y in the initial state.

### Fifteenth Modification

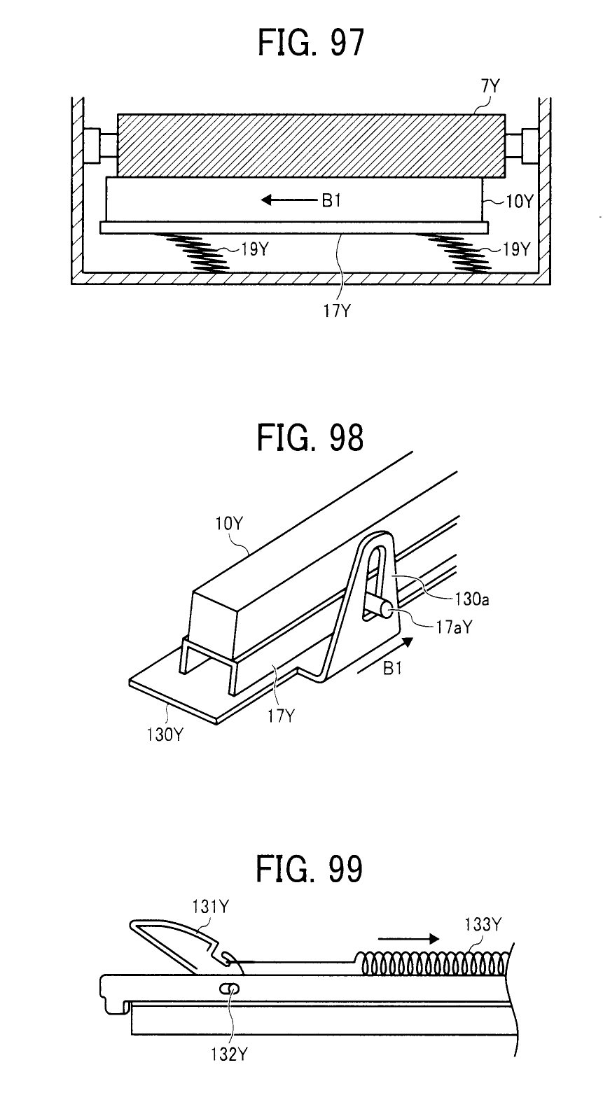

If the solid lubricant 10Y and the holding member 17Y move along the brush rotation axis direction, as shown in FIG. 97, the coil spring 19Y that biases the holding member 17Y from the back side to the side of the applying brush roller 7Y may be greatly curved and superior biasing may be difficult. Therefore, in the printer according to a fifteenth modification, the coil spring 19Y and the holding member 17Y are moved in the direction of the arrow B1 along the brush rotation axis direction.

FIG. 98 is a partially enlarged perspective view showing a holding member 17Y of a printer according to the fifteenth modification and the peripheral configuration thereof. In FIG. 98, the holding member 17Y is fixed to a top surface of a slide plate 130Y to be slid in the direction of the arrow B1. The coil spring (not shown in the drawings) exists between the back surface of the holding member 17Y and the slide plate 130Y and biases the holding member 17Y to the upper side in the drawings.

A pin 17aY protrudes from the side of the holding member 17Y and is engaged with an elongated hole of an engagement portion provided in the slide plate 130Y. By this engagement, the holding member 17Y moves in the direction of the arrow B1 and the slide plate 17Y that functions as a supporting member also moves in the direction of the arrow B1. The coil spring (not shown in the drawings) that is fixed to the slide plate 17Y also moves in the direction of the arrow B1. In this configuration, if the holding member 17Y or the solid lubricant 10Y moves in the direction of the arrow B1, since the coil spring also moves in the direction of the arrow B1 by the same moving amount, the relative positions of the coil spring and the holding member 17Y are not changed. Therefore, the coil spring can be avoided from being curved due to the change in the relative positions of the holding member 17Y and the coil spring by the movement of the holding member 17Y in the direction of the arrow B1.

### Sixteenth Modification

FIG. 99 is an enlarged view showing the configuration of a biasing mechanism for Y in a printer according to a sixteenth modification. In the printer according to the sixteenth modification, as the biasing unit that biases the holding member and the solid lubricant (not shown in the drawings) to the applying brush roller, instead of the coil spring, a biasing mechanism shown in FIG. 99 is used. The biasing mechanism has a cam member 131Y that is configured to rotate around a rotation shaft 132Y and pulls the cam member 131Y by a coil spring 133Y for a cam. Thereby, the force that rotates the cam member 131Y in a clockwise direction around the rotation shaft 132Y is applied to the cam member 131Y.

The leading edge of the cam member 131Y abuts on the back surface of the holding member (not shown in the drawings). The leading edge of the cam member 131Y that rotates in the clockwise direction bums into the holding member and the cam member biases the holding member to the applying brush roller (not shown in the drawings). In this configuration, even though the holding member is moved along the brush rotation axis direction, a biasing direction of the cam member 131Y with respect to the holding member is not changed. Therefore, different from the case where the holding member is biased by the coil spring biased to the body, regardless of the position of the holding member in the brush rotation axis direction, the holding member can be stably biased to the applying brush roller.

### Seventeenth Modification

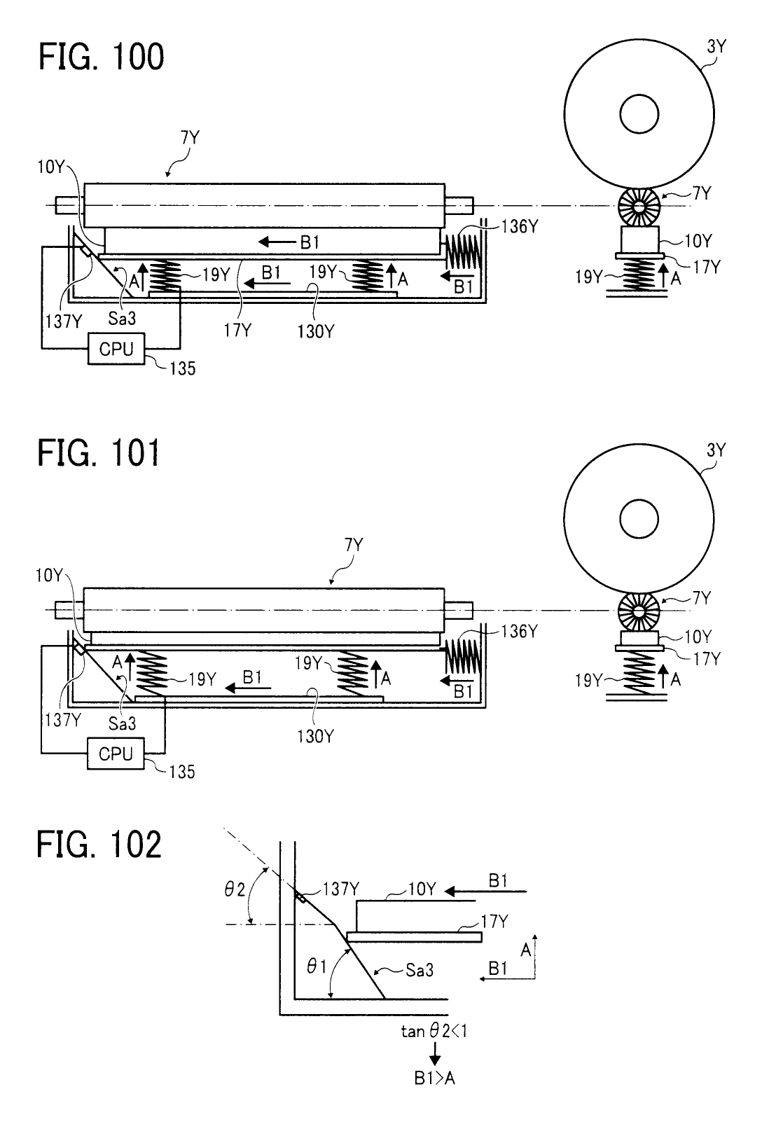

FIG. 100 is a side view and a front view showing an applying brush roller 7Y for Y in a printer according to a seventeenth modification and the peripheral configuration thereof. In FIG. 100, the holding member 17Y is supported to the rail (not shown in the drawings) that extends in the brush rotation axis direction, to be slid in the brush rotation axis direction. The two coil springs 136Y that bias the holding member 17Y to the applying brush roller 7Y are fixed to the slide plate 130Y described in the fifteenth modification, and move in the direction of the arrow B1 in linkage with the holding member 17Y.

The coil spring 136 of the axial direction contacts the trailing edge of the holding member 17Y in the movement direction. Thereby, the force of the direction of the arrow B1 is applied to the holding member 17Y. That is, in the seventeenth modification, the coil spring 136 of the axial direction functions as a moving force applying unit that biases the moving force of the brush rotation axis direction to the solid lubricant 10Y. Instead of the coil spring 136 of the axial direction or in addition to the coil spring 136 of the axial direction, the force that is applied in the direction of the arrow B1 by the applying brush roller 7Y may be applied to the holding member 17Y. This is equally applied to various modifications to be described below.

An inclination surface Sa3 of the taper that is provided in the casing abuts on the leading edge of the holding member 17Y in the movement direction. The inclination surface Sa3 functions as a portion of the lubricant moving unit, and is inclined to the brush rotation axis direction (direction of the arrow B1) and the thickness direction (direction of the arrow A) of the solid lubricant 10Y. If the thickness of the solid lubricant 10Y decreases from a state shown in the drawing and the solid lubricant 10Y moves to the applying brush roller 7Y, the holding member 17Y moves along the inclination surface Sa3, such that the leading edge of the holding member 17Y rises on the inclination surface Sa3 along the inclination. That is, in the printer according to the seventeenth medication, the holding member 17Y and the solid lubricant 10Y moves in a direction along the inclination surface Sa3 that includes components of both the thickness direction (direction of the arrow A) and the rotation axis direction (direction of the arrow B1), according to the thickness decrease of the solid lubricant 10Y. Thereby, the solid lubricant 10Y can be moved in the direction of the arrow B1, according to the thickness decrease.

FIG. 101 is a side view and a front view showing a completely consumed solid lubricant 10Y and the peripheral configuration thereof. The leading edge of the holding member 17Y in the direction of the arrow B1 moves to rise on the inclination surface Sa3 along the inclination. A life duration detecting electrode 137Y is fixed to a portion near the upper end of the inclination surface Sa3. If the solid lubricant 10Y is completely consumed and the thickness thereof is minimized, the leading edge of the holding member 17Y arrives at the position of the electrode 137Y. In this case, the electrode 137Y and the metallic coil spring 19Y are electrically connected to each other through the metallic holding member 17Y. If a CPU 135 detects the electric connection, the CPU 135 displays a message to notify that the solid lubricant 10Y is completely consumed on a display.

In this configuration, the inclination surface Sa3 can be used as a fixing member to fix the life duration detecting electrode 137.

### Eighteenth Modification

A printer according to an eighteenth modification is different from the printer according to the seventeenth modification in the following point. FIG. 102 is an enlarged view showing the configuration of a taper provided in a casing of a lubricant applying device for Y in a printer according to the eighteenth modification and an end of a solid lubricant 10Y. In FIG. 102, an inclination surface Sa3 of the taper is provided such that an inclination angle is changed in two steps of a first inclination angle θ1 and a second inclination angle θ2. The second inclination angle θ2 is an inclination angle of the upper side of the inclination surface, as compared with the inclination angle θ1, and is smaller than the inclination angle θ1. In the inclination surface Sa3 shown in FIG. 102, if the inclination angle θ decreases, the moving amount of the solid lubricant in the direction of the arrow B1 increases when the thickness of the solid lubricant decreases by 1 mm. When the solid lubricant 10Y is used in an initial state during a predetermined period, the leading edge of the holding member 17Y moves along the inclination surface place of the inclination angle θ1. Then, if the solid lubricant 10Y is almost completely consumed, the leading edge of the holding member 17Y moves along the inclination surface place of the inclination angle θ2. Therefore, when the solid lubricant 10Y is almost completely consumed, the moving amount in the direction of the arrow B1 with respect to the thickness decrease increases, as compared with the case of the initial state. That is, when the solid lubricant is almost completely consumed, the thickness decrease of the solid lubricant can be detected with high sensitivity, as compared with the case of the initial state.

In the printer according to the eighteenth modification, the second inclination angle θ2 is set to a value satisfying the condition of “tan θ2<1.” By setting the second inclination angle θ2, the moving amount of the solid lubricant 10Y in the direction of the arrow B1 when the thickness of the solid lubricant 10Y decreases by 1 mm becomes larger than the moving amount in the direction of the arrow A. In this configuration, the moving amount of the solid lubricant in the direction of the arrow B1 becomes larger than the thickness decrease amount of the solid lubricant. By detecting the moving amount of the latter, the thickness decrease is amplified and detected. Therefore, the thickness decrease can be detected with high sensitivity.

The solid lubricant 10Y moves in the direction of the arrow B1 according to the consumption. However, when the total moving amount of the solid lubricant in the direction of the arrow B1 until the solid lubricant in the initial state is completely consumed is set to a large value, the size of the device in the brush rotation axis direction may increase. For this reason, the total moving amount needs to be maintained to the predetermined amount. Meanwhile, the moving amount of the direction of the arrow B1 with respect to the thickness decrease amount is preferably increased to detect the thickness decrease of the solid lubricant 10Y with high sensitivity. However, in this case, the total moving amount may not be within a desired range.

Therefore, in the printer according to the eighteenth modification, when the solid lubricant 10Y in the initial state is used during the predetermined period, the leading edge of the holding member 17Y is moved along the inclination surface place of the relatively large inclination angle θ1 in the guide groove GD, and the moving amount of the solid lubricant 10Y in the direction of the arrow B1 with respect to the thickness decrease amount of the solid lubricant 10Y is set to be relatively small. When the remaining amount of the solid lubricant is large, suppressing of the device size based on setting of the relatively large moving amount of the solid lubricant 10Y in the direction of the arrow B1 per unit thickness decrease amount is preferred in comparison to the detection of the thickness decrease of the solid lubricant 10Y with high sensitivity. Meanwhile, when the solid lubricant 10Y is almost completely consumed, the leading edge of the holding member 17Y is moved along the inclination surface place of the relatively small inclination angle θ2, and the moving amount of the solid lubricant 10Y in the direction of the arrow B1 with respect to the thickness decrease amount of the solid lubricant 10Y is set to be relatively large. When the solid lubricant is almost completely consumed, the thickness decrease of the solid lubricant 10Y is detected with high sensitivity and timing of when the solid lubricant 10Y is completely consumed is detected with high precision. Therefore, in this printer, the size increase of the solid applying device can be suppressed while the timing of when the solid lubricant is completely consumed is detected with high precision.

### Nineteenth Modification

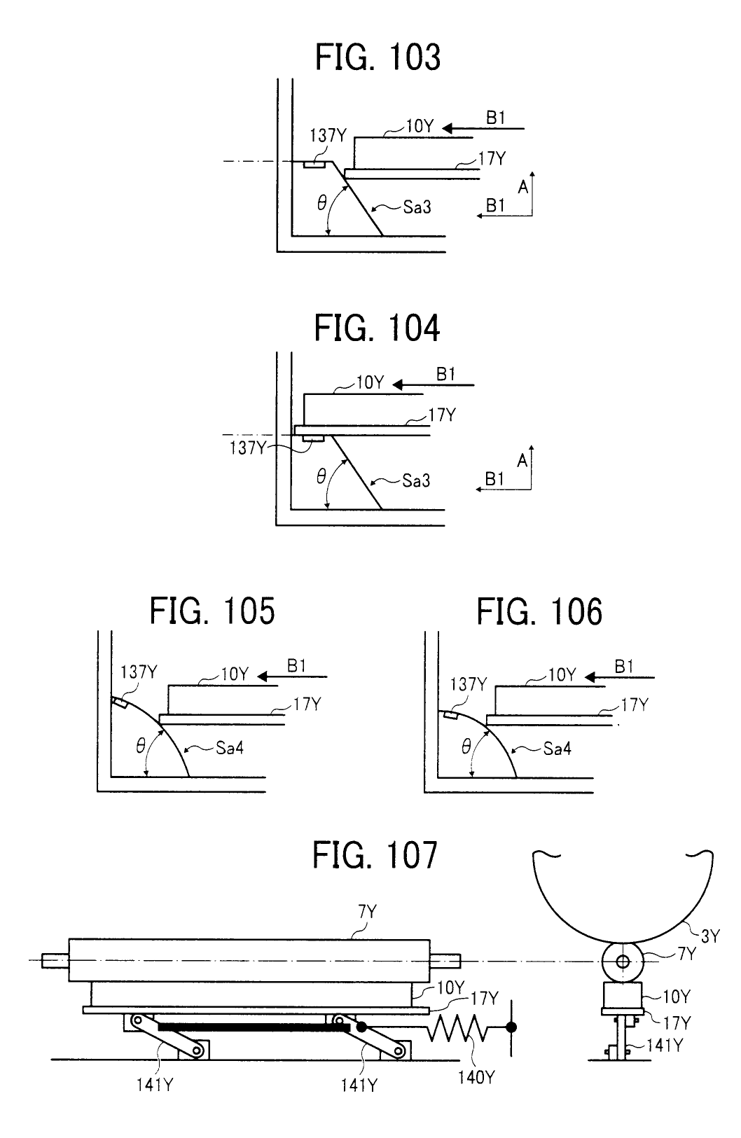

A printer according to a nineteenth modification is different from the printer according to the eighteenth modification in the following point. FIG. 103 is an enlarged view showing the configuration of a taper provided in a casing of a lubricant applying device for Y in a printer according to the nineteenth modification and an end of a solid lubricant 10Y. As shown in FIG. 103, in the printer according to the nineteenth modification, an inclination angle of a peripheral portion of the upper end of the inclination surface Sa3 is not smaller than an inclination angle of the lower end side, and the inclination angle becomes zero, that is, the inclination is removed. A surface that extends in the direction of the arrow B1 is connected to the upper end of the inclination surface Sa3. As such, the life duration detecting electrode 137Y is fixed to the surface that extends in the direction of the arrow B1.

In FIG. 103, when the solid lubricant 10Y is used in an initial state during a predetermined period, the leading edge of the holding member 17Y moves along the inclination surface Sa3. If the solid lubricant 10Y is completely consumed, as shown in FIG. 104, the solid lubricant 10Y reaches the upper end of the inclination surface Sa3. In this case, the holding member 17Y and the solid lubricant 10Y move to the end of the casing at once, along the surface of the direction of the arrow B1. This reason is as follows. That is, when the leading edge of the holding member 17Y moves along the inclination surface Sa3, the holding member 17Y moves in the direction of the arrow B1 and the lubricant thickness direction (direction of the arrow A). Since the applying brush roller exists in the lubricant thickness direction, the solid lubricant 10Y abuts on the brush. The solid lubricant 10Y can move in the thickness direction by the thickness decrease amount. For this reason, the solid lubricant 10Y can move little by little in the direction of the arrow B1 by the amount corresponding to the thickness decrease amount. Meanwhile, on the surface along the direction of the arrow B1, even though the solid lubricant 10Y is not moved in the direction of the arrow A, the solid lubricant 10Y can be moved in only the direction of the arrow B1. For this reason, the holding member 17Y moves at once to the end of the casing along the direction of the arrow B1, by the biasing force of the coil spring of the axial direction. As such, the complete consumption of the solid lubricant can be detected with high sensitivity, by greatly moving the holding member 17Y, when the solid lubricant is completely consumed.

### Twentieth Modification

A printer according to a twentieth modification is different from the printer according to the seventeenth modification in the following point. FIG. 105 is an enlarged view showing the configuration a curve member provided in a casing of a lubricant applying device for Y in a printer according to the twentieth modification and an end of a solid lubricant 10Y. As shown in FIG. 105, instead of the inclination surface, a curve surface Sa4 that is formed by the curve member is provided in the casing. The curve surface Sa4 moves the holding member 17Y abutting the leading edge in a direction that includes components of both the lubricant thickness direction and the rotation axis direction (direction of the arrow B1), according to the thickness decrease of the solid lubricant 10Y. Thereby, similar to the seventeenth modification, the solid lubricant 10Y can be moved in the direction of the arrow B1, according to the thickness decrease. The curve surface Sa4 functions as a part of the lubricant moving unit.

### Twenty-First Modification

A printer according to a twenty-first modification is different from the printer according to the twentieth modification in the following point. That is, as shown in FIG. 106, with respect to the curve surface Sa4, the curvature change to be described below is generated. The curvature change is the curvature change that makes the moving amount of the solid lubricant 10Y in the direction of the arrow B1 when the solid lubricant 10Y to be almost completely consumed is consumed by the predetermined thickness larger than the moving amount of the solid lubricant 10Y in the direction of the arrow B1 when the non-consumed solid lubricant 10Y in the initial state is consumed by the predetermined thickness. Thereby, similar to the printer according to the eighteenth modification, the size increase of the solid applying device can be suppressed while the timing of when the solid lubricant is completely consumed is detected with high precision.

### Twenty-Second Modification

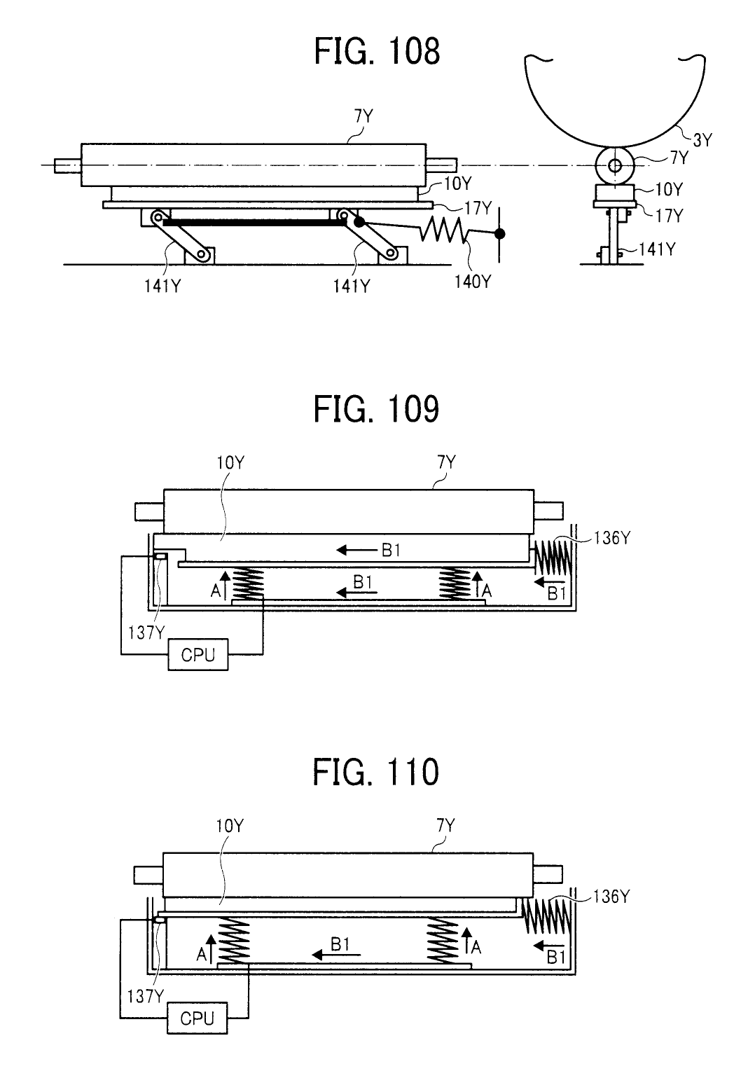

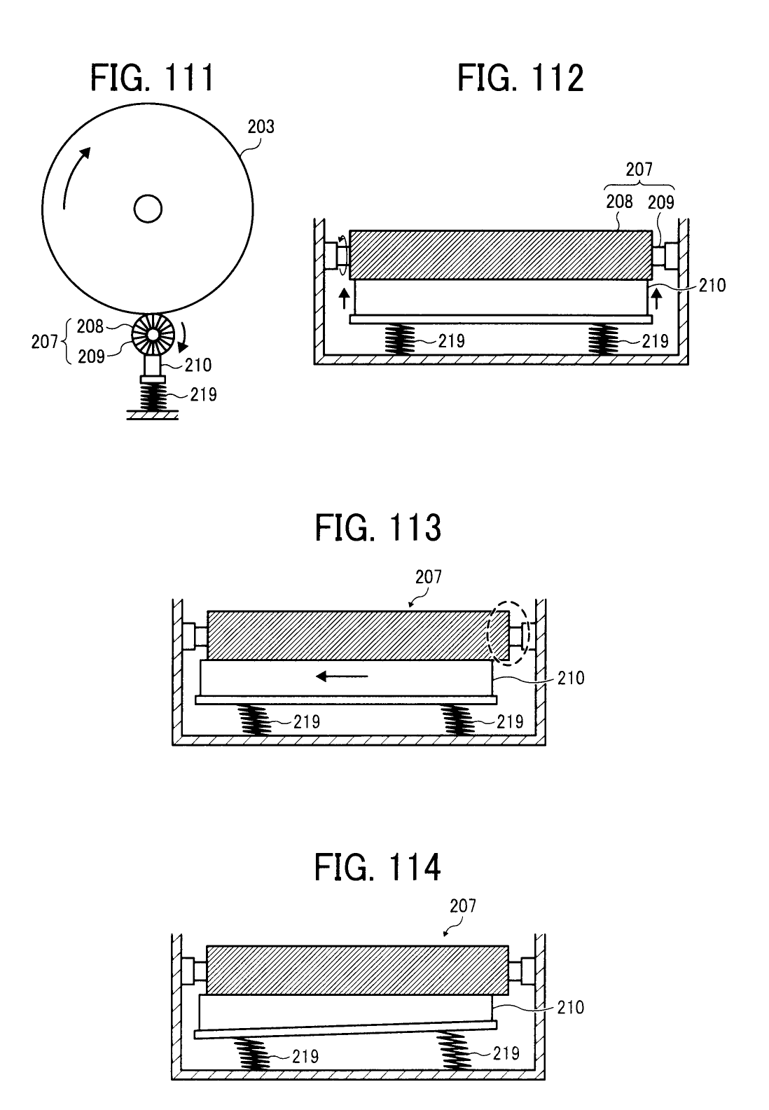

FIG. 107 is a side view and a front view showing a solid lubricant 10Y in an initial state in a printer according to a twenty-second modification and the peripheral configuration thereof. FIG. 108 is a side view and a front view showing a completely consumed solid lubricant 10Y in the printer according to the twenty-second modification and the peripheral configuration thereof. As shown in FIGS. 107 and 108, rocking arms 141Y that can rock are connected to both ends of the holding member 17Y in the brush rotation axis direction. By the two rocking arms 141Y constituting a part of the lubricant moving unit or the moving force applying unit, the holding member 17Y and the solid lubricant 10Y are supported in the casing. The rocking arm 141Y is biased by a tension coil spring 140Y, from one end side to the other end side on a rocking orbit. Thereby, the holding member 17Y and the solid lubricant 10Y move in a direction that includes components of the lubricant thickness direction and the brush rotation axis direction.

In this configuration, a lubricant moving unit that moves the solid lubricant 10Y in the brush rotation axis direction can be used as a biasing unit that biases the solid lubricant 10Y to the applying brush roller.

### Twenty-Third Modification

A printer according to a twenty-third modification is different from the printer according to the seventeenth modification in the following point. FIG. 109 is a side view showing a solid lubricant 10Y in an initial state and the peripheral configuration thereof. In the solid lubricant 10Y in the initial state, a step that makes the central side thicker than the leading edge side is provided in a leading edge of the movement direction. The leading edge protrudes forward more than the leading edge of the holding member 17Y, the holding member 17Y is biased by a coil spring 136Y of the axial direction, and the leading edge of the solid lubricant 10Y as an abutting member abuts on the inside wall of the casing. Thereby, movement of the solid lubricant 10Y in the direction of the arrow B1 is suppressed.

If the solid lubricant 10Y is completely consumed and the thickness thereof is minimized, the thickness decrease amount from the initial state of the solid lubricant 10Y reaches the thickness of the leading edge of the solid lubricant 10Y. Thereby, the thin leading edge of the solid lubricant 10Y is lost. In this case, the movement of the direction of the arrow B1 of the solid lubricant 10Y that is suppressed by abutting of the leading edge of the solid lubricant 10Y into the casing is allowed. As shown in FIG. 110, the holding member 17Y and the solid lubricant 10Y move at once in the direction of the arrow B1 and the leading edge of the holding member 17Y abuts on the inside wall of the casing. As a result, the electrode 137 contacts the holding member 17Y and the complete consumption of the solid lubricant is detected by the CPU.

In this configuration, the complete consumption of the solid lubricant 10Y can be detected by the simple configuration where the thin leading edge of the solid lubricant 10Y abuts on the inside wall of the casing and the movement of the solid lubricant in the direction of the arrow B1 is suppressed, until the solid lubricant 10Y is completely consumed.

Until now, the example of the printer that forms the color image by the tandem system is described. However, the present invention can be applied to a printer that forms a monochromatic image.

In the printers according to the embodiments and the modifications, the moving amount detecting sensor that detects the moving amount of the holding member 17Y in the brush rotation axis direction and is composed of the electrode or the distance sensor, and the CPU that is the consumption amount grasping unit to grasp the consumption amount of the solid lubricant 10Y on the basis of the detection result obtained by the moving amount detecting unit are provided. Therefore, the consumption amount of the solid lubricant 10Y in the thickness direction can be grasped on the basis of the moving amount of the holding member 17Y in the brush rotation axis direction.

In the printers according to the embodiments and the modifications, the lubricant moving unit is configured to move the solid lubricant 10Y in the brush rotation axis direction by the moving amount larger than the thickness decrease amount. In this configuration, as described above, by amplifying and detecting the thickness decrease amount of the solid lubricant 10Y, the thickness decrease can be detected with high sensitivity.

In the printers according to the embodiments and the modifications, the applying brush roller 7Y that includes the rotation shaft member 8Y to be rotatably supported and the brush roller portion 9Y with the plural bristles standing upright on the peripheral surface thereof is used as the applying member. The solid lubricant 10Y is moved in the brush rotation axis direction according to the thickness decrease. In this configuration, the thickness decrease amount of the solid lubricant 10Y can be grasped on the basis of the moving amount of the holding member 17Y in the brush rotation axis direction.

In the printers according to the embodiments, the first to seventh modifications, and the ninth to sixteenth modifications, provided is the guide rail GL or the guide groove GD that includes the inclined portion inclined with respect to the brush rotation axis direction and the lubricant thickness direction, and the solid lubricant 10Y or the holding member 17Y that are engaged with the guide rail GL or the guide groove GD are moved in the direction along the guide rail GL or the guide groove GD that includes the components of both the lubricant thickness direction and the brush rotation axis direction, according to the thickness decrease of the solid lubricant 10Y. In this configuration, the solid lubricant 10Y can be moved in the brush rotation axis direction according to the thickness decrease, while movement of the solid lubricant 10Y or the holding member 17Y is guided by the guide rail GL or the guide groove GD.

In the printers according to the first to seventh modifications and the ninth to sixteenth modifications, the concave portion to be engaged with the guide rail GL or the convex portion to be engaged with the guide groove GD is provided in the solid lubricant 10Y or the holding member 17Y. Therefore, by the engagement, the solid lubricant 10Y or the holding member 17Y can be moved along the guide rail GL or the guide groove GD.

In the printer according to the eighth modification, the guide rod GB that includes the inclined portion inclined with respect to the brush rotation axis direction and the lubricant thickness direction is provided on the bottom surface of the casing, and the solid lubricant 10Y or the holding member 17Y to be engaged with the guide rod GB is moved in the direction along the guide rod GB that includes the components of both the lubricant thickness direction and the brush rotation axis direction, according to the thickness decrease of the solid lubricant 10Y. In this configuration, the solid lubricant 10Y can be moved in the brush rotation axis direction according to the thickness decrease, while the movement of the solid lubricant 10Y or the holding member 17Y is guided by the guide rod GB.

In the printer according to the eighth modification, since the hole to receive the guide rod GB is provided in the solid lubricant 10Y or the holding member 17Y, the solid lubricant 10Y or the holding member 17Y can be moved along the guide rod GB.

In the printers according to the seventeenth to nineteenth modifications, the inclination surface Sa3 that is inclined with respect to the brush rotation axis direction and the lubricant thickness direction is provided, and the holding member 17Y and the solid lubricant 10Y are moved in the direction along the inclination surface Sa3 that includes the components of both the lubricant thickness direction and the brush rotation axis direction according to the thickness decrease of the solid lubricant 10Y, while the leading edge of the holding member 17Y abuts on the inclination surface Sa3. In this configuration, as described above, the solid lubricant 10Y can be moved in the brush rotation axis direction, according to the thickness decrease, while the movement of the holding member 17Y is guided by the inclination surface Sa3. The inclination surface Sa3 can be used as the fixing unit to fix the life duration detecting electrode 137Y.

In the printer according to the eighteenth modification, the moving amount of the solid lubricant 10Y in the brush rotation axis direction when the solid lubricant 10Y to be almost completely consumed is consumed by the predetermined thickness is larger than the moving amount of the solid lubricant 10Y in the brush rotation axis direction when the non-consumed solid lubricant 10Y in the initial state is consumed by the predetermined thickness. In this configuration, as described above, the size increase of the solid applying device can be suppressed while the timing of when the solid lubricant is completely consumed is detected with high precision. In the printers according to the first to seventh modifications and the ninth to sixteenth modifications, the inclination angles of the guide rail GL and the guide groove GD may be equally set and may be changed in at least two steps.

In the printers according to the twentieth and twenty-first modifications, the curve surface Sa4 is provided, and the holding member 17Y and the solid lubricant 10Y are moved in the direction along the curve surface Sa4 including the components of both the lubricant thickness direction an the brush rotation axis direction according to the thickness decrease of the solid lubricant 10Y, while the leading edge of the holding member 17Y abuts on the curve surface Sa4. In this configuration, the solid lubricant 10Y can be moved in the brush rotation axis direction according to the thickness decrease, while the movement of the holding member 17Y is guided by the curve surface Sa4. The curve surface Sa4 can be used as the fixing unit that fixes the life duration detecting electrode 137Y.

In the printer according to the twenty-first modification, the curvature of the curve surface Sa4 is changed in at least two steps, such that the moving amount of the solid lubricant 10Y in the brush rotation axis direction when the solid lubricant 10Y to be almost completely consumed is consumed by the predetermined thickness is larger than the moving amount of the solid lubricant 10Y in the brush rotation axis direction when the non-consumed solid lubricant 10Y in the initial state is consumed by the predetermined thickness. In this configuration, as described above, the size increase of the solid applying device can be suppressed while the timing of when the solid lubricant is completely consumed is detected with high precision.

In the printer according to the twenty-third modification, the thickness difference where the thickness increases from the leading edge side to the central side is set to the leading edge of the solid lubricant 10Y in the brush rotation axis direction. In a state where the leading edge of the solid lubricant 10Y as an abutting member abuts on the inside wall of the casing, the solid lubricant 10Y is biased to the inside wall of the casing. In this configuration, as described above, the complete consumption of the solid lubricant 10Y can be detected by the simple configuration where the thin leading edge of the solid lubricant 10Y abuts on the inside wall of the casing and the movement of the solid lubricant in the direction of the arrow B1 is suppressed, until the solid lubricant 10Y is completely consumed.

In the printers according to the embodiments and the modifications, the moving force applying unit that applies the moving force of the brush rotation axis direction to the solid lubricant 10Y is provided. Therefore, the solid lubricant 10Y can be moved in the brush rotation axis direction.

In the printers according to the embodiments and the first to sixteenth modifications, the applying brush roller 7Y is configured to function as the moving force applying unit, by applying the force of the brush rotation direction and the force of the brush rotation axis direction to the solid lubricant 10Y on the frictional surface of the solid lubricant 10Y, by the arrangement difference, the rigidity difference, the bristle density difference or the bristle inclination of the bristles 9aY. In this configuration, the moving force of the brush rotation axis direction can be applied to the solid lubricant 10Y, using the rotation force of the applying brush roller 7Y.

In the printer according to the twelfth modification, a solid lubricant where the length of the brush rotation axis direction is larger than the length of the brush roller portion 9Y of the applying brush roller 7Y and the length difference is equal to or more than the moving amount of the solid lubricant 10Y in the brush rotation axis direction, from the initial state to the completely consumed state, is used as the solid lubricant 10Y. In this configuration, as described above, the solid lubricant 10Y can be continuously in contact with the entire region of the brush roller portion 9Y in the rotation axis direction, until the state of the solid lubricant 10Y becomes the completely consumed state from the initial state.

In the printer according to the twelfth modification, the CPU that is a notifying unit is configured to notify that the solid lubricant 10Y is completely consumed, before the thickness decrease amount of the solid lubricant 10Y from the initial state of the solid lubricant 10Y grasped by the CPU corresponding to the consumption amount graphing unit has the same value as the distance from the outer circumferential surface of the rotation shaft member 8Y of the applying brush roller 7Y to the outer circumferential surface of the brush roller portion 9Y. In this configuration, as described above, the “uncut place” of the solid lubricant 10Y can be avoided from abutting on the rotation shaft member 8Y.

In the printer according to thirteenth modification, the solid lubricant where the end (trailing edge) of the side opposite to the movement direction along the brush rotation axis direction is provided with the taper coming close to the applying brush roller 7Y toward the central side from the end side (rear side) is used as the solid lubricant 10Y. In this configuration, as described above, pressing irregularities of the solid lubricant 10Y with respect to the brush can be avoided from being generated due to entering of the lubricant place thicker than the lubricant place slid and rubbed on the brush roller portion 9Y with respect to the frictional surface of the brush roller portion 9Y.

In the printer according to the fourteenth modification, the applying brush roller where the length of the rotation axis direction of the brush roller portion 9Y is larger than the length of the brush rotation axis direction in the photosensitive element 3Y is used as the applying brush roller 7Y. The solid lubricant where the length of the brush rotation axis direction is larger than the length of the photosensitive element 3Y is used as the solid lubricant 10Y. In this configuration, as described above, the leading edge of the solid lubricant 10Y can be continuously cut until the solid lubricant 10Y is completely consumed, without generating the “uncut place” in the leading edge of the solid lubricant 10Y.

In the printer according to the fifteenth modification, the slide plate 130Y that is the holding member supporting the coil spring 19Y corresponding to the biasing unit to be movable along the brush rotation axis direction is provided, and the slide plate 130Y is moved in the brush rotation axis direction in linkage with the movement of the solid lubricant 10Y and the holding member 17Y in the brush rotation axis direction. In this configuration, as described above, the coil spring can be avoided from being curved due to the change of the relative positions of the holding member 17Y and the coil spring according to the movement of the holding member 17Y in the direction of the arrow B1.

In the printer according to the sixteenth modification, the biasing unit that presses the rotating cam member 131 into the holding member 17Y and biases the holding member 17Y and the solid lubricant 10Y to the applying brush roller 7Y is used as the biasing unit. In this configuration, as described above, different from the case where the holding member is biased by the coil spring biased to the body, regardless of the position of the holding member in the brush rotation axis direction, the holding member can be stably biased to the applying brush roller.

In the printer according to the twenty-second modification, the rocking arms 141Y are biased from one end side to the other end side on the rocking orbit, while both ends of the holding member 17Y in the brush rotation axis direction are supported by the rocking arms 141Y to be rocked, and the holding member 17Y and the solid lubricant 10Y are moved in the direction that includes the components of both the lubricant thickness direction and the brush rotation axis direction. In this configuration, as described above, the lubricant moving unit that moves the solid lubricant 10Y in the brush rotation axis direction can be functioned as the biasing unit that biases the solid lubricant 10Y to the applying brush roller.

In the printers according to the embodiments and the modifications, the electrode or the distance sensor that is the moving amount detecting unit is disposed on the side of the solid lubricant 10Y or the holding member 17Y in the brush rotation axis direction. Therefore, even when a space to dispose the electrode or the distance sensor in the thickness direction of the solid lubricant 10Y does not exist, movement of the solid lubricant 10Y in the brush rotation axis direction can be detected.

According to the present invention, if the force of the direction orthogonal to the endless movement direction of the applying member is applied from the applying member to the solid lubricant on the frictional surface between the solid lubricant and the applying member, and the solid lubricant and the holding member are horizontally moved in the same direction, the guide portion that is engaged with the engagement portion of the solid lubricant or the holding member regulates the horizontal movement. Thereby, the generation of the horizontal movement of the solid lubricant may be avoided.

According to the present invention, while the solid lubricant is consumed and the thickness thereof decreases, the solid lubricant moves by the amount according to the thickness decrease amount in the direction orthogonal to the surface movement direction of the applying member on the frictional surface of the applying member. Therefore, by grasping the consumption amount of the solid lubricant on the basis of the moving amount, the complete consumption of the solid lubricant can be detected without depending on the moving amount of the solid lubricant in the thickness direction.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A lubricant applying device, comprising:
a solid lubricant;
an applying member that applies lubricant powder scraped off from the solid lubricant to an application target;
a holding member that holds the solid lubricant;
a biasing unit that biases the holding member to bring the solid lubricant on the holding member into contact with the applying member; and
a regulating unit that regulates, when a force of a direction orthogonal to an endless movement direction of the applying member is applied from the applying member to the solid lubricant at a frictional surface therebetween, movement of the solid lubricant and the holding member in the orthogonal direction.

2. The lubricant applying device according to claim 1,
wherein the regulating unit has a regulating portion that regulates movement of the solid lubricant toward the applying member to be in a predetermined direction, and
wherein an engagement portion to be engaged with the regulating portion is provided in at least one of the solid lubricant and the holding member.

3. The lubricant applying device according to claim 1,
wherein the regulating unit has a groove that regulates movement of the solid lubricant toward the applying member to be in a predetermined direction and is provided in a facing member disposed to face the holding member, and
wherein the holding member has a convex portion to be engaged with the groove.

4. The lubricant applying device according to claim 2,
wherein the applying member applies the lubricant powder scraped off from the solid lubricant to the application target in accordance with endless movement of a surface of the applying member contacting the solid lubricant and the application target,
wherein the regulating portion is a guide portion that regulates movement, in the orthogonal direction, of the solid lubricant having the frictional surface, which is in contact with the applying member endlessly moving and to which the force of the endless movement direction and the force of the direction orthogonal to the endless movement direction are applied, while allowing movement, in a direction toward the applying member, of the solid lubricant biased toward the applying member by the biasing unit, in order to guide movement of the solid lubricant toward the applying member, and
wherein the engagement portion is engaged with the guide portion to regulate the movement of the solid lubricant in the orthogonal direction, while the movement of the solid lubricant in the direction toward the applying member is allowed by the guide portion.

5. The lubricant applying device according to claim 4,
wherein the applying member is an applying brush roller that includes a rotation shaft member supported rotatably and a brush roller portion with a plurality of bristles standing on a peripheral surface of the rotation shaft member, and
wherein the guide portion is provided in a region, between one end and the other end of the brush roller portion in a rotation axis direction, of the entire region inside a casing of a device body.

6. The lubricant applying device according to claim 4,
wherein the guide portion is a guide rail that is provided on an inside wall of a casing and extending along an wall surface of the casing, or a guide groove that is provided in the inside wall of the casing and extending along the inside wall surface, and
wherein the engagement portion is a concave portion engaged with the guide rail, or a convex portion engaged with the guide groove.

7. The lubricant applying device according to claim 5,
wherein a concave portion that functions as the engagement portion engaged with the guide rail, or a convex portion that functions as the engagement portion engaged with the guide groove, are provided in both of the solid lubricant and the holding member.

8. The lubricant applying device according to claim 7,
wherein, of the concave portion and the convex portion, at least the concave portion is provided in each of the solid lubricant and the holding member,
wherein the width of the concave portion of the holding member is set to be smaller than the width of the concave portion of the solid lubricant, and
wherein, of the concave portions, only the concave portion of the holding member is engaged with the guide rail, and the guide rail is received in the concave portion of the solid lubricant in a non-contact manner.

9. The lubricant applying device according to claim 7,
wherein, of the concave portion and the convex portion, at least the concave portion is provided in each of the solid lubricant and the holding member,
wherein the width of the concave portion of the holding member is set to be larger than the width of the concave portion of the solid lubricant, and
wherein, of the concave portions, only the concave portion of the solid lubricant is engaged with the guide rail, and the guide rail is received in the concave portion of the holding member in a non-contact manner.

10. The lubricant applying device according to claim 6,
wherein the guide rail is provided on one of two inside wall surfaces of the casing which face each other interposing the solid lubricant therebetween, among a plurality of inside wall surfaces of the casing,
wherein the guide groove is provided in the other inside wall surface of the casing at the position facing the guide rail, and
wherein the concave portion of the solid lubricant which corresponds to the guide rail is provided on a surface facing one inside wall surface, and the convex portion of the solid lubricant which corresponds to the guide groove is provided on a surface facing the other inside wall surface in the solid lubricant.

11. The lubricant applying device according to claim 2,
further comprising a life duration notifying unit that notifies of expiration of life duration of the solid lubricant on the basis of an ON/OFF state of electric connection between an electrode member and a conductive portion,
wherein the electrode member, which is brought into contact with or separated from the conductive portion provided in the solid lubricant or the holding member when the holding member biased toward the applying member together with the solid lubricant by the biasing unit is caused to approach the applying member up to a predetermined position in accordance with consumption of the solid lubricant, is fixed to the guide portion.

12. The lubricant applying device according to claim 3,
wherein the applying member applies the lubricant powder scraped off from the solid lubricant to the application target in accordance with endless movement of a surface of the applying member that is in contact with the solid lubricant and the application target, and
wherein the groove is a guide groove that regulates movement, in the orthogonal direction, of the solid lubricant having the frictional surface which is in contact with the applying member moving endlessly and to which the force of the endless movement direction and the force of the direction orthogonal to the endless movement direction are applied, while allowing movement, in a direction toward the applying member, of the solid lubricant biased toward the applying member by the biasing unit, in order to guide movement of the solid lubricant toward the applying member, and
wherein the convex portion is an engagement portion engaged with the guide groove such that the movement of the solid lubricant in the orthogonal direction is regulated, while the movement of the solid lubricant in a direction toward the applying member is allowed by the guide groove.

13. The lubricant applying device according to claim 12,
wherein the guide groove is provided with an inclined portion configured to convert the force of a biasing direction in which the holding member is biased by the biasing unit into the force of the biasing direction and the orthogonal direction, and
the lubricant applying device further comprises:
a moving amount detecting unit that detects the moving amount of the solid lubricant or the holding member in the orthogonal direction; and
a consumption amount grasping unit that grasps the consumption amount of the solid lubricant on the basis of the detection result obtained by the moving amount detecting unit.

14. The lubricant applying device according to claim 13,
wherein the applying member is an applying brush roller that includes a rotation shaft member rotatably supported and a brush roller portion with a plurality of bristles standing on a peripheral surface of the rotation shaft member, and
wherein the guide groove is provided in a region between one end and the other end of the brush roller portion in a rotation axis direction, of the entire region inside a casing of a device body.

15. A lubricant applying device, comprising:
a solid lubricant;
an applying member that applies lubricant powder scraped off from the solid lubricant to an application target;
a holding member that holds the solid lubricant;
a biasing unit that biases the holding member and brings the solid lubricant on the holding member into contact with the applying member; and
a lubricant moving unit that moves the solid lubricant in a direction orthogonal to an applying member surface movement direction, by moving a frictional surface of the solid lubricant which is in contact with the applying member.

16. The lubricant applying device according to claim 15,
wherein the applying member applies the lubricant powder scraped off from the solid lubricant to the application target in accordance with endless movement of a surface of the applying member that is in contact with the solid lubricant and the application target, and
wherein the lubricant moving unit moves the solid lubricant in the direction orthogonal to the applying member surface movement direction, by moving the frictional surface of the solid lubricant that is in contact with the applying member, on the basis of the moving amount according to a decrease in the thickness of the solid lubricant.

17. The lubricant applying device according to claim 15,
further comprising:
a moving amount detecting unit that detects a moving amount of the solid lubricant in the orthogonal direction; and
a consumption amount grasping unit that grasps a consumption amount of the solid lubricant on the basis of the detection result obtained by the moving amount detecting unit.

18. An image forming apparatus that includes an image carrier carrying a toner image, a toner image forming unit forming the toner image on a surface of the image carrier, and a lubricant applying unit applying a lubricant to the surface of the image carrier,
wherein the lubricant applying device of claim 1 is used as the lubricant applying unit.

19. A process unit that is used in an image forming apparatus including an image carrier carrying a toner image, a lubricant applying device applying a lubricant to the surface of the image carrier, and a toner image forming unit forming the toner image on a surface of the image carrier, the process unit comprising:
a common holder that holds at least the image carrier and the lubricant applying device such that the image carrier and the lubricant are integrally attached to and detached from a body of an image forming apparatus,
wherein as the lubricant applying device, the lubricant applying device according to claim 1 is used.

20. A solid lubricant that is mounted in a lubricant applying device including an applying member that rotates while contacting a solid lubricant and an application target to apply lubricant powder scraped off from the solid lubricant to the application target, a holding member that holds the solid lubricant, and a biasing unit that biases the holding member and brings the solid lubricant on the holding member into contact with the applying member, the solid lubricant comprising:
the concave portion that corresponds to the guide rail in the lubricant applying device of claim 6; and
the convex portion that corresponds to the guide groove in the lubricant applying device of claim 6.
